(19) United States
(12) Patent Application Publication
(10) Pub. No.: US 2025/0233170 A1
(43) Pub. Date: Jul. 17, 2025

(54) THERMAL MANAGEMENT SYSTEM FOR A FUEL CELL STACK

(71) Applicant: Girish Mandakolathur Krishnamurthi, Bengaluru (IN)

(72) Inventor: Girish Mandakolathur Krishnamurthi, Bengaluru (IN)

(21) Appl. No.: 18/412,630

(22) Filed: Jan. 15, 2024

(51) Int. Cl. H01M 8/04029; H01M 8/04014; H01M 8/04119; H01M 8/0432; H01M 8/04701; H01M 8/04746

(52) U.S. Cl. CPC H01M 8/04029; H01M 8/04014; H01M 8/04164; H01M 8/04373; H01M 8/04723; H01M 8/04768

(57) ABSTRACT

A thermal management system for a fuel cell stack is disclosed. The thermal management system comprises at least one cooling channel defined in the fuel cell stack and receives a refrigerant therein, wherein the refrigerant flows through the at least one cooling channel to cool the fuel cell stack. A compressor is in flow communication with an outlet of the at least one cooling channel and compresses the refrigerant received from the at least one cooling channel. A condenser is in flow communication with an outlet of the compressor and discharges heat from the refrigerant received therein. An expansion valve is in flow communication with an outlet of the condenser at its inlet and in flow communication with an inlet of the at least one cooling channel at its outlet and controls a flow of refrigerant from the condenser to the at least one cooling channel is also disclosed.

### FIELD OF THE INVENTION

This invention relates generally to a thermal management system for a fuel cell stack, and more particularly to the thermal management system for regulating a temperature of the fuel cell stack by indirect and direct refrigerant cooling/heating methodologies.

### BACKGROUND OF THE INVENTION

In a current thermal design of a fuel cell stack, liquid coolant such as G48 coolant from a radiator is allowed to flow through a thermal management system for the fuel cell stack. The liquid coolant from the radiator that flows through the thermal management system for the fuel cell stack is channeled to the fuel cell stack. A transfer of heat from the fuel cell stack that is at high temperature to liquid coolant at low temperature cools the fuel cell stack from a higher operating temperature to a lower operating temperature that is within its acceptable operating design temperature limits. The liquid coolant that flows through the fuel cell stack is at high temperature when it emerges from the fuel cell stack. The liquid coolant at high temperature that emerges from the fuel cell stack is channeled to the radiator of the fuel cell stack and stored therein. The liquid coolant that is channeled from the fuel cell stack at high temperature to the radiator is cooled in the radiator by means of high-speed cooling air that is directed towards the radiator by means of a cooling fan. Once excess heat from the liquid coolant is dissipated in the radiator due to transfer of heat from the high temperature liquid coolant to the high-speed cooling air that is directed towards the radiator by means of the cooling fan, the liquid coolant at low temperature that emerges from the radiator is channeled to an electric coolant pump. The liquid coolant that is channeled from the radiator to the electric coolant pump at low temperature is circulated by means of the electric coolant pump through a plurality of cooling channels that are defined in the fuel cell stack for cooling at least one fuel cell that is positioned against each of the plurality of cooling channels defined in the fuel cell stack. An electronic control unit regulates a speed of the electric coolant pump. More specifically, the speed of the electric coolant pump is regulated by the electronic control unit based on a speed of an electrically powered motor that is powered by the fuel cell stack. Therefore, an operating speed of the electric coolant pump is directly proportional to an operating speed of the electrically powered motor and is controlled by the electronic control unit accordingly.

However, as the liquid coolant is in a liquid state and has a high specific heat absorption capacity/unit mass of the liquid coolant, absorption rate of heat from the at least one fuel cell that is positioned against each of the plurality of cooling channels defined in the fuel cell stack is low/unit mass of liquid coolant that flows through each of the plurality of cooling channels that are defined in the fuel cell stack. Moreover, as the liquid coolant in the liquid state from the electric coolant pump is channeled through each of the plurality of cooling channels that are defined in the fuel cell stack and channeled back to the electric coolant pump via the radiator, a number of iterations in which a unit mass of liquid coolant is required to be circulated through each of the plurality of cooling channels that are defined in the fuel cell stack until the at least one fuel cell that is positioned within the fuel cell stack is cooled by a required temperature differential is high. Therefore, energy expended by the electric coolant pump to circulate the liquid coolant through the thermal management system for the fuel cell stack multiple times iteratively until the at least one fuel cell that is positioned within the fuel cell stack is cooled by the required temperature differential is correspondingly high. In addition, as the liquid coolant is in the liquid state, energy expended by the electric coolant pump to circulate the liquid coolant from the radiator through each of the plurality of cooling channels that surround the at least one fuel cell that is positioned within the fuel cell stack and back to the electric coolant pump via the radiator is high. This is because a pressure exerted by the electric coolant pump to cause liquid coolant to flow from the radiator through each of the plurality of cooling channels that surround the at least one fuel cell that is positioned within the fuel cell stack and back to the electric coolant pump via the radiator is high due to a high viscosity and a corresponding high inertia of the liquid coolant. A solution is hereby proposed in this manuscript to circulate a refrigerant through each of the plurality of cooling/heating channels that surround the at least one fuel cell that is positioned within the fuel cell stack and in mechanical contact with the plurality of cooling/heating channels to cool/heat the at least one fuel cell that is positioned within the fuel cell stack by the required temperature differential in accordance with a operating design temperature requirements of the fuel cell stack. Thereby, an overall increase in an operating efficiency of the fuel cell stack may be achieved. In addition, the thermal management system for the fuel cell stack may be deployed in a cooling mode or in a heating mode for cooling or heating the at least one fuel cell that is positioned within the fuel cell stack in accordance with the operating design temperature requirements of the fuel cell stack. Moreover, as the refrigerant is in a gaseous state after absorbing heat from the at least one fuel cell that is positioned within the fuel cell stack, energy required to circulate gaseous refrigerant through the thermal management system for the fuel cell stack is much lower than energy required to circulate liquid coolant through the thermal management system for the fuel cell stack. In addition, the specific heat absorption capacity/unit mass of the refrigerant is much lower than the specific heat absorption capacity/unit mass of the liquid coolant. Therefore, a heat absorption rate of the refrigerant flowing through the thermal management system for the fuel cell stack is much higher than a heat absorption rate of the liquid coolant. Consequently, an efficiency of heat absorption by the refrigerant that is channeled through the thermal management system for the fuel cell stack is higher than the efficiency of heat absorption by the liquid coolant that is channeled through the thermal management system for the fuel cell stack. In an exemplary example, the liquid coolant may be but is not limited to Inorganic Additive Technology, Organic Acid Technology, and Hybrid Organic Acid Technology. In recent times, liquid glycol such as G48 is a preferred choice of liquid coolant for cooling the fuel cell stack and therefore cooling the at least one fuel cell that is positioned within the fuel cell stack.

A traditional thermal management system for the fuel cell stack comprises the fuel cell stack that contains at least one cooling channel that includes an inlet port and an outlet port. The inlet port of the at least one cooling channel defined in the fuel cell stack is in flow communication with an outlet port of the radiator and receives liquid coolant at low temperature that flows from the outlet port of the radiator. The liquid coolant at low temperature that is channeled to the inlet port of the at least one cooling channel that is defined in the fuel cell stack flows through the at least one cooling channel that surrounds at least one fuel cell that is positioned within the fuel cell stack. More specifically, the at least one cooling channel that surrounds the at least one fuel cell that is positioned within the fuel cell stack is in flow communication with the inlet port of the at least one cooling channel that is defined in the fuel cell stack at its first end. In addition, the at least one cooling channel that surrounds the at least one fuel cell that is positioned within the fuel cell stack is in flow communication with the outlet port of the at least one cooling channel that is defined in the fuel cell stack at its opposite second end. The liquid coolant at low temperature that is channeled from the outlet port of the radiator is channeled through the at least one cooling channel that is defined in the fuel cell stack via the inlet port of the at least one cooling channel that is defined in the fuel cell stack. After absorbing heat from the at least one fuel cell that is positioned against the at least one cooling channel that is defined in the fuel cell stack while flowing through the at least one cooling channel that is defined in the fuel cell stack, liquid coolant at high temperature is channeled through the outlet port of the at least one cooling channel that is defined in the fuel cell stack. Consequently, a temperature of the at least one fuel cell that is positioned against the at least one cooling channel that is defined in the fuel cell stack is decreased by pre-determined temperature differences for various operating speeds of the electrically powered motor. However, a mass flow rate of liquid coolant that is required to be channeled through the at least one cooling channel that is defined in the fuel cell stack to achieve the required temperature decrease in the at least one fuel cell that is positioned within the fuel cell stack is high due to the low heat absorption rate and high specific heat absorption capacity/unit mass of the liquid coolant. Moreover, due to the high mass flow rate of liquid coolant that flows through the at least one cooling channel and also because the coolant is in the liquid state with no change in the phase of the coolant with a corresponding high viscosity and high inertia, energy expended by the electric coolant pump that is received from the electric battery to circulate the liquid coolant through the at least one cooling channel that is defined in the fuel cell stack in order to achieve the required temperature decrease in the at least one fuel cell that is positioned within the fuel cell stack is high. Owing to the low heat absorption rate, the high specific heat absorption capacity, the high mass flow rate, the high viscosity, and the high inertia of the liquid coolant that is in the constant liquid state with no phase change, a thermal efficiency of the thermal management system for the fuel cell stack deploying the liquid coolant is low. Consequently, there exists a need for an improved thermal management system for the fuel cell stack that would enable a low mass flow rate, a low viscosity, and a low inertia of refrigerant in contrast to the same parameters of the liquid coolant to be channeled through each of the plurality of cooling channels that are defined in the fuel cell stack in order to achieve the required temperature reduction in the at least one fuel cell that is positioned against the at least one cooling channel defined in the fuel cell stack due to the lower specific heat absorption capacity and higher heat absorption rate/unit mass of the refrigerant in contrast to the same parameters of the liquid coolant. Due to the change in the phase of the refrigerant from the liquid phase to the gaseous phase as refrigerant flows through each of the plurality of cooling channels that are defined in the fuel cell stack with a corresponding higher heat absorption rate, lower specific heat absorption capacity, lower viscosity, lower inertia, and lower mass flow rate, energy expended by the compressor to compress and circulate gaseous refrigerant through the at least one cooling channel that is defined in the fuel cell stack in order to achieve the required temperature reduction in the at least one fuel cell that is positioned against the at least one cooling channel that is defined in the fuel cell stack is lower than energy expended by the electric coolant pump to circulate liquid coolant through the at least one cooling channel that is defined in the fuel cell stack.

The need has existed for many years, yet there is no fully satisfactory system to meet the need. In accordance with a long-recognized need, there has been developed a thermal management system for the fuel cell stack that would enable refrigerant to be channeled through at least one cooling/heating channel that is defined in the fuel cell stack. The refrigerant that is channeled through at least one cooling channel that is defined in the fuel cell stack changes the phase of the refrigerant from the liquid phase to the gaseous phase as refrigerant flows from the inlet port that is in flow communication with the at least one cooling channel that is defined in the fuel cell stack to the outlet port that is in flow communication with the at least one cooling channel that is defined in the fuel cell stack. The refrigerant that is channeled through at least one cooling channel that is defined in the fuel cell stack is designed to increase a thermal efficiency of cooling as well as an operating efficiency of the fuel cell stack. More specifically, as the specific heat absorption capacity/unit mass of the refrigerant is lower in contrast to the specific heat absorption capacity/unit mass of the liquid coolant, the mass flow rate of the refrigerant that is required to be channeled through the at least one cooling channel that is defined in the fuel cell stack can be substantially decreased in contrast to the mass flow rate of the liquid coolant that is required to be channeled through the at least one cooling channel that is defined in the fuel cell stack in order to achieve a substantially same temperature reduction in the at least one fuel cell that is positioned against the at least one cooling channel defined in the fuel cell stack. In addition, the heat absorption rate of refrigerant is much higher than the heat absorption rate of liquid coolant. Moreover, as the refrigerant changes from the liquid state to the gaseous state as refrigerant flows from the inlet port that is in flow communication with the at least one cooling channel that is defined in the fuel cell stack to the outlet port that is in flow communication with the at least one cooling channel that is defined in the fuel cell stack, energy required to circulate the gaseous refrigerant through the thermal management system for the fuel cell stack by means of the compressor may be substantially lower than energy required to circulate the liquid coolant through the thermal management system for the fuel cell stack by means of the electric coolant pump.

### BRIEF DESCRIPTION OF THE INVENTION

In one aspect of the invention, a thermal management system for a fuel cell stack is described. The thermal management system comprises at least one cooling channel defined in the fuel cell stack and receives a refrigerant therein. The refrigerant that is received within the at least one cooling channel flows through the at least one cooling channel that is defined in the fuel cell stack to cool the fuel cell stack. A compressor is in flow communication with an outlet of the at least one cooling channel defined in the fuel cell stack at its inlet. The compressor receives the refrigerant that flows through the outlet of the at least one cooling channel that is defined in the fuel cell stack. The compressor compresses the refrigerant that is received in the compressor. A condenser is in flow communication with an outlet of the compressor at its inlet and receives the refrigerant that flows through the outlet of the compressor. The condenser discharges heat from the refrigerant that is received in the condenser. An expansion valve is in flow communication with an outlet of the condenser at its inlet and receives the refrigerant that flows through the outlet of the condenser. The expansion valve is in flow communication with an inlet of the at least one cooling channel defined in the fuel cell stack at its outlet. The expansion valve controls a flow of refrigerant that flows through the outlet of the condenser to the inlet of the at least one cooling channel that is defined in the fuel cell stack to cool the fuel cell stack.

In another aspect of the invention, a thermal management system for a fuel cell stack is described. The thermal management system comprises a cooling chamber defined in the fuel cell stack and receives a refrigerant therein. The refrigerant substantially fills the cooling chamber and is in direct contact with at least one inner wall of the cooling chamber. The refrigerant that is received within the cooling chamber and that substantially fills the cooling chamber and in direct contact with at least one inner wall of the cooling chamber flows through the cooling chamber that is defined in the fuel cell stack to directly cool the at least one inner wall of the cooling chamber defined in the fuel cell stack. A compressor is in flow communication with an outlet of the cooling chamber defined in the fuel cell stack at its inlet. The compressor receives the refrigerant that flows through the outlet of the cooling chamber that is defined in the fuel cell stack. The compressor compresses the refrigerant that is received in the compressor. A condenser is in flow communication with an outlet of the compressor at its inlet and receives the refrigerant that flows through the outlet of the compressor. The condenser discharges heat from the refrigerant that is received in the condenser. An expansion valve is in flow communication with an outlet of the condenser at its inlet and receives the refrigerant that flows through the outlet of the condenser. The expansion valve is in flow communication with an inlet of the cooling chamber defined in the fuel cell stack at its outlet. The expansion valve controls a flow of refrigerant that flows through the outlet of the condenser to the inlet of the cooling chamber that is defined in the fuel cell stack to directly cool the at least one inner wall of the cooling chamber that is defined in the fuel cell stack.

In another aspect of the invention, a thermal management system for a fuel cell stack is described. The thermal management system comprises at least one heating channel defined in the fuel cell stack and receives a refrigerant therein. The refrigerant that is received within the at least one heating channel flows through the at least one heating channel that is defined in the fuel cell stack to heat the fuel cell stack. A compressor is in flow communication with an outlet of the at least one heating channel defined in the fuel cell stack at its inlet. The compressor receives the refrigerant that flows through the outlet of the at least one heating channel that is defined in the fuel cell stack. The compressor compresses the refrigerant that is received in the compressor. An expansion valve is in flow communication with an outlet of the compressor at its inlet and receives the refrigerant that flows through the outlet of the compressor. The expansion valve is in flow communication with an inlet of the at least one heating channel defined in the fuel cell stack at its outlet. The expansion valve controls a flow of refrigerant that flows through the outlet of the compressor to the inlet of the at least one heating channel that is defined in the fuel cell stack to heat the fuel cell stack.

In yet another aspect of the invention, a thermal management system for a fuel cell stack is described. The thermal management system comprises a heating chamber defined in the fuel cell stack and receives a refrigerant therein. The refrigerant substantially fills the heating chamber and is in direct contact with at least one inner wall of the heating chamber. The refrigerant that is received within the heating chamber and that substantially fills the heating chamber and in direct contact with at least one inner wall of the heating chamber flows through the heating chamber that is defined in the fuel cell stack to directly heat the at least one inner wall of the heating chamber defined in the fuel cell stack. A compressor is in flow communication with an outlet of the heating chamber defined in the fuel cell stack at its inlet. The compressor receives the refrigerant that flows through the outlet of the heating chamber that is defined in the fuel cell stack. The compressor compresses the refrigerant that is received in the compressor. An expansion valve is in flow communication with an outlet of the compressor at its inlet and receives the refrigerant that flows through the outlet of the compressor. The expansion valve is in flow communication with an inlet of the heating chamber defined in the fuel cell stack at its outlet. The expansion valve controls a flow of refrigerant that flows through the outlet of the compressor to the inlet of the heating chamber that is defined in the fuel cell stack to directly heat the at least one inner wall of the heating chamber defined in the fuel cell stack.

In a further aspect of the invention, a fuel cell stack is described. The fuel cell stack comprises a housing, and at least one fuel cell positioned within the housing. At least one temperature regulating channel is defined in the housing of the fuel cell stack and receives a refrigerant therein. The refrigerant that is received within the at least one temperature regulating channel flows through the at least one temperature regulating channel that is defined in the housing of the fuel cell stack to regulate a temperature of the at least one fuel cell that is positioned within the housing of the fuel cell stack.

### BRIEF DESCRIPTION OF THE DRAWINGS

FIG. 1 is a schematic representation of a thermal management system for a fuel cell stack in one embodiment of the invention.

FIG. 2 is a schematic representation of the thermal management system for indirectly cooling the fuel cell stack that is in flow communication with a compressor, a condenser, and an expansion valve in one embodiment of the invention.

FIG. 3 is a schematic representation of the thermal management system for directly cooling the fuel cell stack that is in flow communication with the compressor, the condenser, and the expansion valve in another embodiment of the invention.

FIG. 4 is a schematic representation of the thermal management system for indirectly heating the fuel cell stack that is in flow communication with the compressor, the condenser/bypass flow path, and the expansion valve in another embodiment of the invention.

FIG. 5 is a schematic representation of the thermal management system for directly heating the fuel cell stack that is in flow communication with the compressor, the condenser/bypass flow path, and the expansion valve in another embodiment of the invention.

### DETAILED DESCRIPTION OF THE INVENTION

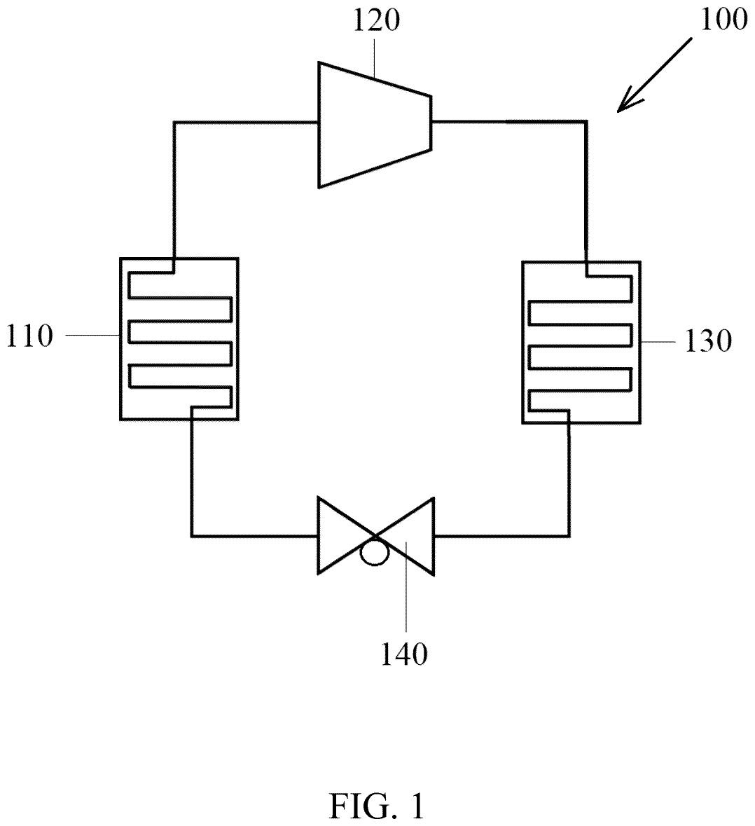

FIG. 1 is a schematic representation of a thermal management system 100 for a fuel cell stack 110 in one embodiment of the invention. The thermal management system 100 for the fuel cell stack 110 comprises at least one temperature regulating channel/temperature regulating chamber that is defined in the fuel cell stack 110 that receives a liquid refrigerant from an expansion valve 140 via an inlet port of the at least one temperature regulating channel/temperature regulating chamber, wherein the refrigerant that is received in the at least one temperature regulating channel/temperature regulating chamber flows through the at least one temperature regulating channel/temperature regulating chamber that is defined in the fuel cell stack 110 and past the fuel cell stack 110 for regulating a temperature of the fuel cell stack 110. The refrigerant from the at least one temperature regulating channel/temperature regulating chamber that is defined in the fuel cell stack 110 flows to a compressor 120 via an outlet port of the at least one temperature regulating channel/temperature regulating chamber that is defined in the fuel cell stack 110.

More specifically, the at least one temperature regulating channel/temperature regulating chamber that is defined in the fuel cell stack 110 receives refrigerant that is in a liquid state via the inlet port of the at least one temperature regulating channel/temperature regulating chamber. When the refrigerant flows past the fuel cell stack 110 for regulating the temperature of the fuel cell stack 110, heat is absorbed by at least one fuel cell from the refrigerant thereby heating the at least one fuel cell or dissipated by the at least one fuel cell to the refrigerant thereby cooling the at least one fuel cell. The refrigerant is channeled from the at least one temperature regulating channel/temperature regulating chamber to the compressor 120 via the outlet port that is defined in the at least one temperature regulating channel/temperature regulating chamber. In an exemplary embodiment, the fuel cell stack 110 may be any fuel cell stack known in the art whose temperature is required to be regulated by the refrigerant. More specifically, the fuel cell stack 110 may be any fuel cell stack known in the art that requires to be thermally regulated as a consequence of heating up or cooling down due to the heating up or cooling down of the at least one fuel cell that is positioned against and in mechanical contact with the at least one temperature regulating channel/inner wall of the temperature regulating chamber defined in the fuel cell stack 110 beyond its acceptable operating design temperature limits respectively. In an exemplary embodiment, the fuel cell stack 110 may be a fuel cell stack 110 that is deployed in two-wheeler automobiles and higher load carrying capacity automobiles such as but not limited to electrically powered cars, electrically powered trucks, electrically powered buses, electrically powered trains, electrically powered ships, electrically powered aircraft, industrial power plants, and domestic power plants. In an exemplary embodiment, the acceptable operating design temperature range of the fuel cell stack 110 may be between 400 centigrade and 150° centigrade. In an exemplary embodiment, the at least one fuel cell may be a low temperature proton-exchange membrane fuel cell (LT-PEMFC) or a high temperature proton-exchange membrane fuel cell (HT-PEMFC).

Once the refrigerant regulates the temperature of the fuel cell stack 110, the refrigerant from the at least one temperature regulating channel/temperature regulating chamber defined in the fuel cell stack 110 is channeled to the compressor 120 for compressing the refrigerant that flows from the outlet port of the at least one temperature regulating channel/temperature regulating chamber that is defined in the fuel cell stack 110. In an exemplary embodiment, the compressor 120 for compressing the refrigerant that flows from the outlet port of the at least one temperature regulating channel/temperature regulating chamber that is defined in the fuel cell stack 110 may be a single stage compressor for compressing the refrigerant that is received in the compressor 120 from the at least one temperature regulating channel/temperature regulating chamber that is defined in the fuel cell stack 110. In an alternate exemplary embodiment, the compressor 120 for compressing the refrigerant that flows from the outlet port of the at least one temperature regulating channel/temperature regulating chamber that is defined in the fuel cell stack 110 may be a multi-stage compressor comprising of two or more compressor stages for compressing the refrigerant that is received in the compressor 120 from the at least one temperature regulating channel/temperature regulating chamber that is defined in the fuel cell stack 110 to the required delivery pressure. Once refrigerant is compressed in the compressor 120 to the required delivery pressure, the compressed refrigerant is channeled to a condenser 130 for discharging heat from the compressed refrigerant in the condenser 130. Therein, the refrigerant at a lower temperature than refrigerant at an inlet port of the condenser 130 is channeled to the expansion valve 140 for throttling the refrigerant, and thereby regulating a flow of refrigerant to the fuel cell stack 110. The refrigerant from the expansion valve 140 is channeled back to the fuel cell stack 110 and recirculated through the thermal management system 100 for regulating the temperature of the fuel cell stack 110.

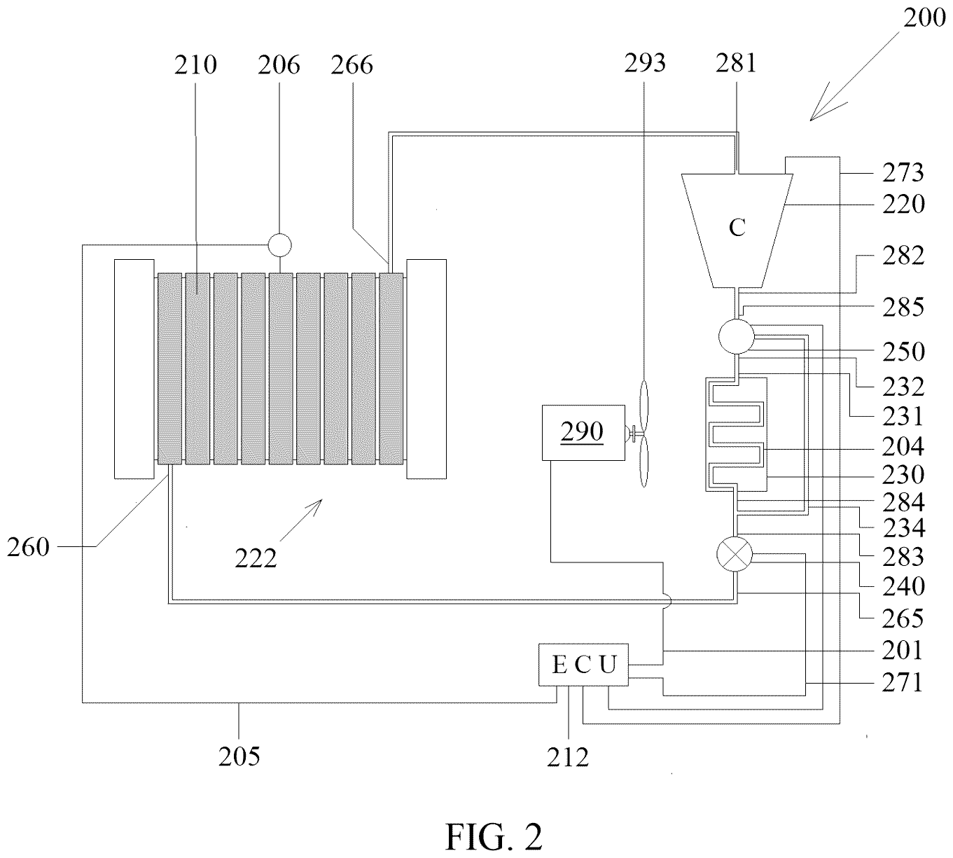

FIG. 2 is a schematic representation of a thermal management system 200 for decreasing a temperature of the fuel cell stack 222 comprising at least one cooling channel/cooling chamber 210 defined in the fuel cell stack 222 that is in flow communication with the compressor 220, the condenser 230, and the expansion valve 240 in one embodiment of the invention. While the at least one cooling channel/cooling chamber 210 is not explicitly depicted in the FIG. 2, it must be construed by the reader that the at least one cooling channel/cooling chamber 210 defined in the fuel cell stack 222 is contained in the housing of the fuel cell stack 222 and receives the refrigerant therein. In an exemplary embodiment, the thermal management system 200 comprises the at least one cooling channel/cooling chamber 210 that is defined in the fuel cell stack 222 and receives a refrigerant therein. In an exemplary embodiment, the refrigerant that is deployed in the thermal management system 200 for the fuel cell stack 222 may be one of Formaldehyde, R-11, R-12, R-13, R-22, R-32, R-113, R-114, R-115, R-123, R-134A, R-152A, R-290, R-407C, R-410A, R-438A, R-454B, R-502, R-600A, R-717, R-744, and R-1234yf. In an alternate exemplary embodiment, the refrigerant that is deployed in the thermal management system 200 for the fuel cell stack 222 may be any refrigerant known in the art that cools the at least one fuel cell that is positioned within the fuel cell stack 222 and that is heated due to a reverse electrolysis reaction of hydrogen atoms and oxygen atoms that occurs within the at least one fuel cell and that generates electric power. The at least one fuel cell that is positioned within the fuel cell stack 222 may be temporarily or permanently positioned and secured within the fuel cell stack 222.

More specifically, the at least one cooling channel/cooling chamber 210 that is defined in the fuel cell stack 222 comprises the at least one cooling channel/cooling chamber 210 that encompasses a maximum possible surface area of the fuel cell stack 222 to facilitate absorbing a maximum amount of heat from the fuel cell stack 222 that houses the at least one fuel cell therein. Therefore, the at least one cooling channel/cooling chamber 210 covers the maximum possible surface area of the fuel cell stack 222 to facilitate absorbing the maximum amount of heat from the fuel cell stack 222 by the refrigerant, thereby cooling the entire surface area of the fuel cell stack 222 effectively. In an alternate exemplary embodiment, the at least one cooling channel/cooling chamber 210 covers only a user defined surface area of the fuel cell stack 222 to facilitate absorbing the maximum amount of heat from the user defined surface area of the fuel cell stack 222. In an exemplary embodiment, the at least one cooling channel/cooling chamber 210 may extend either along a longitudinal axis of the fuel cell stack 222 or perpendicular to the longitudinal axis of the fuel cell stack 222, or both along the longitudinal axis of the fuel cell stack 222 and perpendicular to the longitudinal axis of the fuel cell stack 222 such as in a transverse direction so as to encompass the maximum possible surface area of the fuel cell stack 222. Therefore, the refrigerant may absorb the maximum amount of heat from the entire surface area of the fuel cell stack 222. In a further exemplary embodiment, at least one cooling channel/cooling chamber (not shown) branches out from the at least one cooling channel/cooling chamber 210 that is defined in the fuel cell stack 222 and is directed to a specific portion of the fuel cell stack 222 where there exists concentrated high temperature zones in the fuel cell stack 222 and that requires to be locally cooled. In an exemplary embodiment, the at least one cooling channel/cooling chamber 210 that branches out from the at least one cooling channel/cooling chamber 210 that is defined in the fuel cell stack 222 may be integrally formed in the fuel cell stack 222 such that the at least one cooling channel/cooling chamber 210 that branches out from the at least one cooling channel/cooling chamber 210 that is defined in the fuel cell stack 222 constitutes a unitary assembly with the fuel cell stack 222. In addition, the at least one cooling channel/cooling chamber 210 may be integrally formed in the fuel cell stack 222. In an alternate exemplary embodiment, the at least one cooling channel/cooling chamber 210 may be an independent at least one cooling channel/cooling chamber 210 that may be modularly secured within a cavity defined in the fuel cell stack 222. More specifically, the at least one cooling channel 210 extends around an outer surface area of the fuel cell stack 222 located outside a housing of the fuel cell stack 222 and cools at least one fuel cell (not shown) that is positioned within the fuel cell stack 222 by conduction. Alternatively, the at least one cooling channel 210 extends within the fuel cell stack 222 and surrounds the at least one fuel cell that is positioned within the fuel cell stack by being located inside the fuel cell stack 222 and cools the at least one fuel cell that is positioned within the fuel cell stack 222 by conduction.

In the exemplary embodiment, the refrigerant that is received within the at least one cooling channel/cooling chamber 210 is received in a substantially liquid state. Once the refrigerant is received within the at least one cooling channel/cooling chamber 210 in the substantially liquid state, the refrigerant is allowed to flow through the at least one cooling channel/cooling chamber 210 that is defined in the fuel cell stack 222 to facilitate cooling the fuel cell stack 222. More specifically, the refrigerant is allowed to flow through the at least one cooling channel/cooling chamber 210 that is defined in the fuel cell stack 222 to facilitate cooling the fuel cell stack 222. Therefore, the refrigerant that flows through the at least one cooling channel/cooling chamber 210 absorbs heat from the fuel cell stack 222. The absorption of heat by the refrigerant from the fuel cell stack 222 cools the fuel cell stack 222 and consequently the at least one fuel cell that is positioned within the fuel cell stack 222 from a higher operating temperature to a lower operating temperature respectively that is within the acceptable operating design temperature limits of the fuel cell stack 222. The decrease in the temperature of the fuel cell stack 222 and consequently the at least one fuel cell that is positioned within the fuel cell stack 222 to a lower operating temperature that is within its acceptable operating design temperature limits increases an operating efficiency and useful life of the at least one fuel cell that is positioned within the fuel cell stack 222.

In an exemplary embodiment, the compressor 220 is in flow communication with an outlet port 266 of the at least one cooling channel/cooling chamber 210 defined in the fuel cell stack 222 and receives gaseous refrigerant at high temperature that flows from the outlet port 266 of the at least one cooling channel/cooling chamber 210. More specifically, the refrigerant that is received in the compressor 220 from the at least one cooling channel/cooling chamber 210 that is defined in the fuel cell stack 222 is in the gaseous state at high temperature and is received via an inlet port 281 of the compressor 220. Once the refrigerant is received in the compressor 220 in the substantially gaseous state, the gaseous refrigerant is compressed in the compressor 220 from a pressure that is equal to the pressure of the refrigerant at the outlet port 266 of the at least one cooling channel/cooling chamber 210 that is defined in the fuel cell stack 222 to a higher pressure that is required for the refrigerant to be circulated through the thermal management system 200 for the fuel cell stack 222. More specifically, the compressor 220 may be an electric compressor driven by electric power that is supplied from an electric battery (not shown) to increase the pressure of refrigerant from low pressure at the outlet port 266 of the at least one cooling channel/cooling chamber 210 that is defined in the fuel cell stack 222 to the higher pressure that is delivered from the compressor 220. In an exemplary embodiment, the compressor 220 may be any compressor 220 known in the art that increases the pressure of refrigerant from the low pressure at the outlet port 266 of the at least one cooling channel/cooling chamber 210 that is defined in the fuel cell stack 222 to the higher pressure. Therefore, as the refrigerant is received in the compressor 220, the pressure of the refrigerant is increased in the compressor 220 from the low pressure to a higher pressure with a corresponding large increase in temperature of the refrigerant. More specifically, owing to the large increase in the pressure of the gaseous refrigerant in the compressor 220, the temperature of the gaseous refrigerant is substantially increased to a high temperature correspondingly. In an exemplary embodiment, a bypass valve 250 is in flow communication with an outlet port 282 of the compressor 220. More specifically, the bypass valve 250 is in flow communication with the outlet port 282 that is in flow communication with a pressure regulator (not shown) of the compressor 220 and receives refrigerant therein.

In an exemplary embodiment, the bypass valve 250 is in flow communication with the outlet port 282 of the compressor 220 at its inlet port 285 and receives gaseous refrigerant that flows from the outlet port 282 of the compressor 220. More specifically, the refrigerant that is received in the bypass valve 250 via its inlet port 285 is received from the compressor 220 in a substantially gaseous state at high temperature. Once the refrigerant is received in the bypass valve 250 in the substantially gaseous state, the bypass valve 250 channels the gaseous refrigerant to an inlet port 231 of the condenser 230 via an outlet port 232 of the bypass valve 250. Therefore, at the outlet port 232 of the bypass valve 250, gaseous refrigerant at high pressure and at high temperature is channeled to the next stage of the thermal management system 200 for the fuel cell stack 222. In an exemplary embodiment, the condenser 230 is in flow communication with the outlet port 232 of the bypass valve 250 and receives high temperature refrigerant that flows through the outlet port 232 of the bypass valve 250.

In an exemplary embodiment, the condenser 230 is in flow communication with the outlet port 232 of the bypass valve 250 at its inlet port 231 and receives refrigerant that flows from the outlet port 232 of the bypass valve 250. More specifically, the refrigerant that is received in the condenser 230 via its inlet port 231 is received from the outlet port 232 of the bypass valve 250 in a substantially gaseous state at high temperature and at high pressure. Once the refrigerant is received in the condenser 230 in the substantially gaseous state, heat that is present in the gaseous refrigerant that was absorbed by the refrigerant from the fuel cell stack 222 while the refrigerant was flowing through the at least one cooling channel/cooling chamber 210 that is defined in the fuel cell stack 222 as well as while the refrigerant was compressed in the compressor 220 is substantially discharged in the condenser 230. The heat from the gaseous refrigerant is substantially discharged in the condenser 230, thereby decreasing the temperature of the gaseous refrigerant that is channeled from the outlet port 282 of the compressor 220 substantially to a lower temperature that is required for the refrigerant to be circulated through the thermal management system 200 for the fuel cell stack 222. More specifically, the condenser 230 may be a mechanical heat exchanger for discharging heat from the gaseous refrigerant that is channeled through the condenser 230. More specifically, the condenser 230 may be one of a liquid cooled and an air-cooled condenser 230 that facilitates decreasing the temperature of the gaseous refrigerant that flows from the outlet port 282 of the compressor 220 to a substantially lower temperature that is required for the refrigerant to be circulated through the thermal management system 200 for the fuel cell stack 222. In an alternate exemplary embodiment, the condenser 230 may be any condenser 230 known in the art that facilitates decreasing the higher temperature of the gaseous refrigerant that is received in the condenser 230 via its inlet port 231 to the substantially lower temperature that is required for the gaseous refrigerant to be circulated through the thermal management system 200 for the fuel cell stack 222. As the temperature of the gaseous refrigerant decreases from the higher temperature at the outlet port 282 of the compressor 220 to the lower temperature in the condenser 230 that is required for the refrigerant to be circulated through the thermal management system 200 for the fuel cell stack 222, the pressure of the gaseous refrigerant that flows through the condenser 230 remains largely unaffected. More specifically, while the temperature of the gaseous refrigerant decreases as the gaseous refrigerant flows through the condenser 230 due to discharge of heat in the condenser 230, the pressure of the gaseous refrigerant remains steady or decreases to a slightly lower pressure from the higher-pressure gaseous refrigerant that is channeled from the outlet port 282 of the compressor 220 to the condenser 230 via the inlet port 231 of the condenser 230. Therefore, at an outlet port 284 of the condenser 230, gaseous refrigerant at high pressure and at low temperature is channeled to the next stage of the thermal management system 200 for the fuel cell stack 222. In an exemplary embodiment, the expansion valve 240 is in flow communication with the outlet port 284 of the condenser 230.

In an exemplary embodiment, the expansion valve 240 is in flow communication with the outlet port 284 of the condenser 230 at its inlet port 283 and receives cooled refrigerant that flows through the outlet port 284 of the condenser 230. More specifically, the refrigerant that is received at the inlet port 283 of the expansion valve 240 is received from the outlet port 284 of the condenser 230 in a substantially gaseous state at low temperature. Once the refrigerant is received at the inlet port 283 of the expansion valve 240 in the substantially gaseous state, the expansion valve 240 throttles the gaseous refrigerant, thereby decreasing the pressure of the gaseous refrigerant from the higher pressure at the outlet port 284 of the condenser 230 to a lower pressure, and correspondingly decreasing the temperature of the gaseous refrigerant from the higher temperature at the outlet port 284 of the condenser 230 to a lower temperature. More specifically, the decrease in the pressure of gaseous refrigerant from the higher pressure at the outlet port 284 of the condenser 230 to the lower pressure in the expansion valve 240 due to the throttling action of the expansion valve 240 causes a substantial reduction in the temperature of refrigerant from the higher temperature at the outlet port 284 of the condenser 230 to the lower temperature as refrigerant flows through the expansion valve 240. An outlet port 265 of the expansion valve 240 is in flow communication with an inlet port 260 of the at least one cooling channel/cooling chamber 210 defined in the fuel cell stack 222. The expansion valve 240 throttles the flow of refrigerant that flows through the outlet port 284 of the condenser 230 to the inlet port 260 of the at least one cooling channel/cooling chamber 210 that is defined in the fuel cell stack 222. More specifically, an electronic control unit 212 is in electronic communication with the expansion valve 240 via a control flow path 271. The electronic control unit 212 controls an opening percentage/opening of the expansion valve 240 via the control flow path 271 to regulate a required mass flow rate of the gaseous refrigerant that flows from the outlet port 284 of the condenser 230 to the inlet port 260 of the at least one cooling channel/cooling chamber 210 that is defined in the fuel cell stack 222 for the refrigerant to be circulated through the thermal management system 200 for the fuel cell stack 222. In addition, the electronic control unit 212 is in electronic communication with the pressure regulator (not shown) of the compressor 220 via a control flow path 273. More specifically, the electronic control unit 212 controls an outlet valve (not shown) that is provided in the pressure regulator of the compressor 220 to regulate a required mass flow rate of the refrigerant at a required pressure that is to flow from the outlet port 282 of the compressor 220 to the inlet port 231 of the condenser 230 via the bypass valve 250 for the refrigerant to be circulated through the thermal management system 200 for the fuel cell stack 222. More specifically, the expansion valve 240 may be a mechanical control valve for throttling a flow of refrigerant that flows from the outlet port 284 of the condenser 230 to the inlet port 260 of the at least one cooling channel/cooling chamber 210 that is defined in the fuel cell stack 222. In an alternate exemplary embodiment, the expansion valve 240 may be an electronically actuated control valve for throttling the flow of refrigerant from the outlet port 284 of the condenser 230 to the inlet port 260 of the at least one cooling channel/cooling chamber 210 that is defined in the fuel cell stack 222. In an alternate exemplary embodiment, the expansion valve 240 may be any kind of expansion valve known in the art that controls the flow of refrigerant that flows from the outlet port 284 of the condenser 230 to the inlet port 260 of the at least one cooling channel/cooling chamber 210 that is defined in the fuel cell stack 222.

As the pressure and the temperature of the refrigerant decreases from the high pressure and the low temperature at the outlet port 284 of the condenser 230 to the low pressure and the much lower temperature at the outlet port 265 of the expansion valve 240, the gaseous refrigerant changes its state from the gaseous state to a substantially liquid state due to a large reduction in the temperature of the refrigerant to a temperature that is below its phase transition temperature. The refrigerant that is in the substantially liquid state is allowed to flow through the inlet port 260 of the at least one cooling channel/cooling chamber 210 that is defined in the fuel cell stack 222 via the outlet port 265 of the expansion valve 240. The expansion valve 240 throttles the refrigerant that flows from the outlet port 284 of the condenser 230. The throttling of the gaseous refrigerant that flows through the outlet port 284 of the condenser 230 to the inlet port 260 of the at least one cooling channel/cooling chamber 210 via the outlet port 265 of the expansion valve 240 is controlled by the electronic control unit 212 via the control flow path 271 and permits only a required mass flow rate of substantially liquid refrigerant to be channeled at low pressure through the inlet port 260 of the at least one cooling channel/cooling chamber 210 that is defined in the fuel cell stack 222. Therefore, at the outlet port 265 of the expansion valve 240, substantially liquid refrigerant at a lower pressure and at a lower temperature than the higher pressure and the higher temperature refrigerant at the outlet port 284 of the condenser 230 is channeled to the next stage of the thermal management system 200 for the fuel cell stack 222. In an exemplary embodiment, the at least one cooling channel/cooling chamber 210 defined in the fuel cell stack 222 is in flow communication with the outlet port 265 of the expansion valve 240 and receives substantially liquid refrigerant at low pressure and at low temperature therein. The expansion valve 240 described above may be a unidirectional flow control expansion valve that permits only the required mass flow rate of substantially liquid refrigerant to be channeled at high-speed, low pressure, and at low temperature through the inlet port 260 of the at least one cooling channel/cooling chamber 210 that is defined in the fuel cell stack 222.

In an exemplary embodiment, the fuel cell stack 222 may be for but is not limited to a fuel cell powered automobile, a fuel cell powered motorbike, a fuel cell powered locomotive, a fuel cell powered industrial power plant, and a fuel cell powered domestic power supply. At least one fuel cell (not shown) is positioned within and in thermal communication with the at least one cooling channel/cooling chamber 210 defined in the fuel cell stack 222. Therefore, once the refrigerant flows through the at least one cooling channel/cooling chamber 210 defined in the fuel cell stack 222, the refrigerant cools the at least one fuel cell at high temperature that is positioned against the at least one cooling channel/cooling chamber 210 that is defined in the fuel cell stack 222. More specifically, as the substantially liquid refrigerant that is at high-speed, low pressure, and at low temperature that is received at the inlet port 260 of the at least one cooling channel/cooling chamber 210 flows through the at least one cooling channel/cooling chamber 210 that is defined in the fuel cell stack 222, heat from the at least one fuel cell that is positioned against the at least one cooling channel/cooling chamber 210 that is defined in the fuel cell stack 222 is transferred to the substantially liquid refrigerant. More specifically, the at least one fuel cell is one of in indirect contact via an outer wall of the at least one cooling channel 210/submerged and in direct physical contact with the refrigerant that flows through the cooling chamber 210 and that flows from the inlet port 260 of the at least one cooling channel/cooling chamber 210 to the outlet port 266 of the at least one cooling channel/cooling chamber 210. The refrigerant transfers the heat away from the at least one fuel cell that is positioned within the fuel cell stack 222. The transfer of heat from the at least one fuel cell that is positioned against the at least one cooling channel/cooling chamber 210 defined in the fuel cell stack 222 to the refrigerant converts the refrigerant that is in the substantially liquid state to the refrigerant that is in the substantially gaseous state. The refrigerant that is in the substantially gaseous state is therein channeled to the outlet port 266 of the at least one cooling channel/cooling chamber 210 at a higher temperature than that of the substantially liquid refrigerant at the low pressure and at the lower temperature that is received at the inlet port 260 of the at least one cooling channel/cooling chamber 210 that is defined in the fuel cell stack 222.

In an exemplary embodiment, the at least one cooling channel 210 defined in the fuel cell stack 222 that receives the refrigerant therein has a diameter that may be in the range of 1 millimeter to 100 millimeters to channel the flow of refrigerant through the at least one cooling channel 210. Alternatively, the diameter of the at least one cooling channel 210 that receives the refrigerant therein may be in the order of any diametrical range known in the art that channels the refrigerant from the inlet port 260 of the at least one cooling channel 210 to the outlet port 266 of the at least one cooling channel 210.

In an exemplary embodiment, the at least one fuel cell that is positioned against the at least one cooling channel/cooling chamber 210 defined in the fuel cell stack 222 generates heat due to reverse electrolysis reaction of hydrogen atoms with oxygen atoms to produce water molecules. The heat that is generated due to the reverse electrolysis reaction of hydrogen atoms with oxygen atoms to produce water molecules is discharged to the fuel cell stack 222 itself by conduction and consequently heats the fuel cell stack 222 that includes at least one inner wall and/or the thermal insulation material secured to at least one inner wall of the fuel cell stack 222. In addition, the heat that is generated by the at least one fuel cell that is positioned within the fuel cell stack 222 is discharged to the liquid refrigerant that submerges and is in direct contact/indirect contact via an outer wall of the at least one cooling channel 210 by convection and consequently heats the liquid refrigerant that flows through the cooling chamber/at least one cooling channel 210. In an exemplary embodiment, the refrigerant that flows through the at least one cooling channel 210 and in indirect contact/cooling chamber 210 and that submerges and is in direct contact with the at least one fuel cell is completely filled within the at least one cooling channel/cooling chamber 210. In an alternate exemplary embodiment, the refrigerant that flows through the at least one cooling channel 210 and is in indirect contact/cooling chamber 210 and that submerges and is in direct contact with the at least one fuel cell is partially filled within the at least one cooling channel/cooling chamber 210. Therefore, the refrigerant that flows through the at least one cooling channel/cooling chamber 210 that is defined in the fuel cell stack 222 cools the at least one fuel cell that is positioned against the at least one cooling channel/cooling chamber 210 defined in the fuel cell stack 222. More specifically, as the refrigerant flows through the at least one cooling channel/cooling chamber 210 that is defined in the fuel cell stack 222, the heat that is discharged from the at least one fuel cell that is positioned against the at least one cooling channel/cooling chamber 210 defined in the fuel cell stack 222 is absorbed by the refrigerant by convection as refrigerant flows from the inlet port 260 of the at least one cooling channel/cooling chamber 210 to the outlet port 266 of the at least one cooling channel/cooling chamber 210. The absorption of heat by the refrigerant from the fuel cell stack 222 cools the heated at least one fuel cell that is positioned within the fuel cell stack 222 substantially. Therefore, once the refrigerant flows through the at least one cooling channel/cooling chamber 210 that is defined in the fuel cell stack 222, the refrigerant cools the at least one fuel cell that is positioned within the fuel cell stack 222 substantially. More specifically, as the substantially liquid refrigerant that is at high-speed, low pressure, and at low temperature is received at the inlet port 260 of the at least one cooling channel/cooling chamber 210 that is defined in the fuel cell stack 222, heat from the at least one fuel cell that is positioned within the fuel cell stack 222 is transferred to the substantially liquid refrigerant that is in indirect contact via the outer wall of the at least one cooling channel that is in contact with the at least one fuel cell/submerges and is in direct contact with the at least one fuel cell. The transfer of heat from the at least one fuel cell that is positioned against the at least one cooling channel/cooling chamber 210 that is defined in the fuel cell stack 222 to the refrigerant converts the refrigerant that is in the substantially liquid state to the refrigerant that is in the substantially gaseous state. The refrigerant that is in the substantially gaseous state is therein channeled to the outlet port 266 of the at least one cooling channel/cooling chamber 210 at a higher temperature than that of the substantially liquid refrigerant at the low pressure and at the lower temperature that is received at the inlet port 260 of the at least one cooling channel/cooling chamber 210 that is defined in the fuel cell stack 222.

More specifically, as the substantially liquid refrigerant that is at high-speed and at low temperature is received at the inlet port 260 of the at least one cooling channel/cooling chamber 210 flows through the at least one cooling channel/cooling chamber 210 that is defined in the fuel cell stack 222, heat from the at least one fuel cell that is positioned against the at least one cooling channel 210 defined in the fuel cell stack 222 and is in indirect contact/cooling chamber 210 defined in the fuel cell stack 222 and is submerged and in direct contact with the refrigerant is transferred to the refrigerant by convection. The transfer of heat from the at least one fuel cell that is positioned against the at least one cooling channel 210 defined in the fuel cell stack 222 to the refrigerant that is in indirect contact with the at least one fuel cell/cooling chamber 210 defined in the fuel cell stack 222 to the refrigerant that submerges and is in direct contact with the at least one fuel cell converts the liquid refrigerant that is at lower temperature to the refrigerant that is at a relatively higher temperature and at a relatively lower speed. The speed of the refrigerant decreases due to frictional losses that occur between the liquid refrigerant and inner wall of the at least one cooling channel/cooling chamber 210 as refrigerant flows through the at least one cooling channel/cooling chamber 210. The refrigerant is subsequently channeled to the outlet port 266 of the at least one cooling channel/cooling chamber 210 and is at a relatively higher temperature and at a relatively lower speed than the liquid refrigerant at the lower temperature and higher speed that is received at the inlet port 260 of the at least one cooling channel/cooling chamber 210 that is defined in the fuel cell stack 222.

In an exemplary embodiment, the inner wall of the at least one cooling channel/cooling chamber 210 that is defined in the fuel cell stack 222 may be manufactured from a material that can withstand pressurized corrosive liquid refrigerant at low temperature and at high-speed. In an exemplary embodiment, the inner wall of the at least one cooling channel/cooling chamber 210 defined in the fuel cell stack 222 may be manufactured from but is not limited to a mild steel material, an aluminum material, a pressure resistant glass material, a pressure resistant plastic material, a pressure resistant ceramic material, an acrylic material, PVC, PTFE, and a pressure resistant polymer material. In an alternate exemplary embodiment, the inner wall of the at least one cooling channel/cooling chamber 210 defined in the fuel cell stack 222 may be manufactured from a high thermal conductivity material that facilitates efficient heat transfer from at least one cooling channel/the inner wall of the cooling chamber 210 to the refrigerant that flows through the at least one cooling channel and in indirect contact with the at least one fuel cell/cooling chamber 210 that is defined in the fuel cell stack 222 and submerges and is in direct contact with the at least one fuel cell. Moreover, the inner wall of the at least one cooling channel/the inner wall of the cooling chamber 210 defined in the fuel cell stack 222 may be coated with a leak resistant material to ensure containment of refrigerant within the at least one cooling channel/cooling chamber 210 that is defined in the fuel cell stack 222 itself without being discharged to an external environment.

In an exemplary embodiment, a cooling fan 290 is positioned proximate to the condenser 230. More specifically, the cooling fan 290 that is positioned proximate to the condenser 230 receives rotational power from one of the fuel cell stack 222 and an external power source such as but not limited to an electric battery (not shown). The cooling fan 290 delivers a stream of high-speed cooling air to the condenser 230 to cool the refrigerant that is received in the condenser 230 from the outlet port 282 of the compressor 220. More specifically, the condenser 230 is positioned in an air flow path of the cooling fan 290 and receives the stream of high-speed cooling air that is discharged from the cooling fan 290 and that impinges on an outer surface of the condenser 230. The stream of high-speed cooling air that is discharged from the cooling fan 290 and that impinges on the outer surface of the condenser 230 cools the refrigerant that flows through the condenser 230 from the outlet port 282 of the compressor 220. Therefore, the cooling fan 290 facilitates discharging heat from the refrigerant that flows through the condenser 230 due to heat from the condenser 230 that is absorbed by the high-speed cooling air. More specifically, the heat that was absorbed by the refrigerant that was channeled through the at least one cooling channel/cooling chamber 210 that is defined in the fuel cell stack 222 and the heat that was absorbed by the refrigerant that was channeled through the compressor 220 due to compression of the gaseous refrigerant in the compressor 220 is substantially discharged in the condenser 230 due to the stream of high-speed cooling air that is discharged from the cooling fan 290 and that impinges on the outer surface of the condenser 230 and that absorbs heat from the refrigerant that flows through the condenser 230. Therefore, at the outlet port 284 of the condenser 230, substantially gaseous refrigerant at high pressure and at a lower temperature than the higher temperature of the gaseous refrigerant at the inlet port 231 of the condenser 230 is channeled to the next stage of the thermal management system 200 for the fuel cell stack 222. In an exemplary embodiment, the condenser 230 is in flow communication with the outlet port 282 of the compressor 220 and receives gaseous refrigerant at high pressure and at high temperature that flows from the pressure regulator that is positioned in the compressor 220.

The refrigerant that flows through the at least one cooling channel/cooling chamber 210 that is defined in the fuel cell stack 222 to cool the at least one fuel cell that is positioned within the fuel cell stack 222 is of a specific heat absorption capacity/unit mass of the refrigerant that is lesser in contrast to a liquid coolant that is of a greater specific heat absorption capacity/unit mass of the liquid coolant. Therefore, since the specific heat absorption capacity/unit mass of the refrigerant that flows through the at least one cooling channel/cooling chamber 210 that is defined in the fuel cell stack 222 is lesser in contrast to the greater specific heat absorption capacity/unit mass of liquid coolant, a lower mass flow rate of refrigerant is required to be channeled through the at least one cooling channel/cooling chamber 210 that is defined in the fuel cell stack 222. More specifically, the lower mass flow rate of refrigerant is required to be channeled through the at least one cooling channel/cooling chamber 210 that is defined in the fuel cell stack 222 to decrease the first temperature of the fuel cell stack 222 and consequently the at least one fuel cell to the second temperature in contrast to the higher mass flow rate of liquid coolant that is required to be channeled through the at least one cooling channel/cooling chamber 210 that is defined in the fuel cell stack 222 to decrease the first temperature of the fuel cell stack 222 and consequently the at least one fuel cell to the second temperature. In addition, due to the lower specific heat absorption capacity of the refrigerant, the heat absorption rate of the refrigerant is much higher in contrast to the heat absorption rate of the liquid coolant. Therefore, in order to decrease the temperature of the fuel cell stack 222 and consequently the at least one fuel cell from the first temperature to the second temperature, the lower mass flow rate of refrigerant that is capable of absorbing heat at the higher rate is required to be channeled through the at least one cooling channel/cooling chamber 210 that is defined in the fuel cell stack 222 in contrast to the higher mass flow rate of liquid coolant that is capable of absorbing heat at the lower rate. The low specific heat absorption capacity/unit mass of the refrigerant implies that the refrigerant that is channeled through the at least one cooling channel/cooling chamber 210 absorbs heat from the fuel cell stack 222 at a higher rate in contrast to the lower heat absorption rate of the liquid coolant that has a comparatively high specific heat absorption capacity/unit mass of the liquid coolant to decrease the first temperature of the fuel cell stack 222 and consequently the at least one fuel cell to the second temperature that is within its acceptable operating design temperature limits.

In an exemplary embodiment, a total amount of energy that is required for operating the compressor 220 to compress refrigerant flowing from the outlet port 266 of the at least one cooling channel/cooling chamber 210 that is defined in the fuel cell stack 222 and delivering the compressed refrigerant to the inlet port 231 of the condenser 230, for channeling the refrigerant through the condenser 230, for channeling the refrigerant through the expansion valve 240, and finally for channeling the refrigerant through the at least one cooling channel/cooling chamber 210 that is defined in the fuel cell stack 222 via its inlet port 260 is lesser than a total amount of energy that is required for operating the electric coolant pump for circulating liquid coolant, for channeling liquid coolant from the electric coolant pump through the radiator via its inlet port, for channeling liquid coolant from an outlet port of the radiator through the at least one cooling channel/cooling chamber 210 that is defined in the fuel cell stack 222, for channeling liquid coolant from the outlet port 266 of the at least one cooling channel/cooling chamber 210 that is defined in the fuel cell stack 222 through a coolant tank, and channeling liquid coolant from an outlet port of the coolant tank back to the electric coolant pump. The total amount of energy that is required for channeling the refrigerant through the at least one cooling channel/cooling chamber 210 that is defined in the fuel cell stack 222 is lesser because the low mass flow rate of refrigerant is required to be channeled through the at least one cooling channel/cooling chamber 210 that is defined in the fuel cell stack 222 to decrease the first temperature of the fuel cell stack 222 and consequently the at least one fuel cell to the second temperature in contrast to the high mass flow rate of liquid coolant that is required to be channeled through the at least one cooling channel/cooling chamber 210 that is defined in the fuel cell stack 222 to decrease the first temperature of the fuel cell stack 222 and consequently the at least one fuel cell to the second temperature. The lower mass flow rate of the refrigerant that is required to be channeled through the at least one cooling channel/cooling chamber 210 that is defined in the fuel cell stack 222 to cool the fuel cell stack 222 and consequently the at least one fuel cell from the first temperature to the second temperature requires a comparatively lower total amount of energy to be supplied to the compressor 220 for compressing and channeling the refrigerant through the thermal management system 200 for the fuel cell stack 222.

Moreover, the total amount of energy that is required for channeling the refrigerant through the thermal management system 200 for the fuel cell stack 222 is lesser than the total amount of energy that is required for channeling the liquid coolant through the thermal management system 200 for the fuel cell stack 222 because a low viscosity and consequently low inertia gaseous refrigerant is channeled through the at least one cooling channel/cooling chamber 210 that is defined in the fuel cell stack 222 to decrease the first temperature of the fuel cell stack 222 and consequently the at least one fuel cell to the second temperature in contrast to a high viscosity and consequently high inertia liquid coolant that is to be channeled through the at least one cooling channel/cooling chamber 210 that is defined in the fuel cell stack 222 to decrease the first temperature of the fuel cell stack 222 and consequently the at least one fuel cell to the second temperature. The lower viscosity of the refrigerant channeled through the at least one cooling channel/cooling chamber 210 that is defined in the fuel cell stack 222 to cool the fuel cell stack 222 and consequently the at least one fuel cell from the first temperature to the second temperature requires a lower total amount of energy to be supplied to the compressor 220 for compressing and circulating the refrigerant through the thermal management system 200 for the fuel cell stack 222. The lower viscosity of the refrigerant implies that a lower inertia and consequently a lesser amount of energy is required to cause the less viscous refrigerant to flow through the thermal management system 200 of the fuel cell stack 222 in contrast to a greater inertia and consequently a greater amount of energy that is required to cause the comparatively more viscous liquid coolant to flow through the thermal management system 200 for the fuel cell stack 222.

In an exemplary embodiment, the fuel cell stack 222 comprises the at least one fuel cell that is positioned against the at least one cooling channel/cooling chamber 210 that is defined in the fuel cell stack 222. The at least one fuel cell comprises at least one high temperature fuel cell that is at a temperature that is beyond its acceptable operating design temperature limits to be positioned within the fuel cell stack 222.

In an exemplary embodiment, the fuel cell stack 222 comprises a housing, and at least one fuel cell that is positioned within the housing of the fuel cell stack 222. More specifically, the at least one fuel cell that is positioned within the fuel cell stack 222 converts one form of energy to another (i.e. chemical energy to electrical energy) via reverse electrolysis, and becomes heated up due to the process of conversion of one form of energy to another form of energy. Therefore, the at least one fuel cell that is positioned within the fuel cell stack 222 is required to be cooled by means of the thermal management system 200 for the fuel cell stack 222 to ensure that the temperature of the at least one fuel cell is maintained within its acceptable operating design temperature limits, and consequently the temperature of the fuel cell stack 222 is maintained within its acceptable operating design temperature limits. In an exemplary embodiment, the outer wall (not shown) of the at least one cooling channel/at least one inner wall of the cooling chamber 210 that is defined in the housing of the fuel cell stack 222 is positioned against and in mechanical contact with the at least one fuel cell. Thereby, the outer wall of the at least one cooling channel/at least one inner wall of the cooling chamber 210 and the at least one fuel cell each transfers heat to the refrigerant that flows through the at least one cooling channel/cooling chamber 210 and that submerges the at least one fuel cell. The refrigerant that flows through the at least one cooling channel 210 is in indirect contact with the at least one fuel cell via the outer wall of the at least one cooling channel 210, while the refrigerant that flows through the cooling chamber 210 submerges and is in direct contact with the at least one fuel cell that is positioned within the cooling chamber 210 of the fuel cell stack.

The expansion valve 240 throttles the flow of refrigerant that flows through the outlet port 284 of the condenser 230 to the at least one cooling channel 210 that is defined in the fuel cell stack 222 via the inlet port 260 of the at least one cooling channel 210. The flow of refrigerant from the expansion valve 240 through the at least one cooling channel 210 that is defined in the fuel cell stack 222 in one embodiment of the invention is described below.

In an exemplary embodiment, a first cooling channel (not shown) of the at least one cooling channel 210 defined in the fuel cell stack 222 comprises the inlet port 260. More specifically, the inlet port 260 of the first cooling channel of the at least one cooling channel 210 defined in the fuel cell stack 222 is in flow communication with the outlet port 265 of the expansion valve 240 and receives refrigerant that is in the substantially liquid state. The refrigerant that is received in the substantially liquid state via the inlet port 260 of the first cooling channel of the at least one cooling channel 210 flows past at least one fuel cell that is positioned against the first cooling channel of the fuel cell stack 222, and that requires to be cooled. On flowing past the at least one fuel cell that is positioned against the at least one cooling channel 210 that is defined in the fuel cell stack 222 and cooling the at least one fuel cell, the refrigerant is channeled through a second cooling channel that is in flow communication with the first cooling channel to cool the at least one fuel cell that is positioned against the second cooling channel. In a similar manner, a third cooling channel is in flow communication with the first cooling channel and the second cooling channel to ensure a smooth flow of the liquid refrigerant that is channeled through the inlet port 260 of the first cooling channel to the second cooling channel and to the third cooling channel that are each in flow communication with one another. In an exemplary embodiment, from the first cooling channel, the second cooling channel, and the third cooling channel, the refrigerant is channeled out of the fuel cell stack 222 via the outlet port 266 of the at least one cooling channel 210 that is defined in the fuel cell stack 222. In an exemplary embodiment, more than three cooling channels may be in flow communication with one another and positioned in the fuel cell stack 222 to cool the fuel cell stack 222 and consequently the at least one fuel cell that is positioned within the fuel cell stack 222.

The first cooling channel, the second cooling channel, and the third cooling channel each have at least one fuel cell that is positioned against the first cooling channel, against the second cooling channel, and against the third cooling channel, and that is required to be cooled by liquid refrigerant that is channeled through the inlet port 260 of the first cooling channel, the second cooling channel, and the third cooling channel that is defined in the fuel cell stack 222. In an exemplary embodiment, the at least one cooling channel 210 is in flow communication with the outlet port 266 that receives the refrigerant that flows through the first cooling channel, through the second cooling channel, and through the third cooling channel respectively. As the liquid refrigerant that is in the substantially liquid state flows from the inlet port 260 through the first cooling channel, through the second cooling channel, and through the third cooling channel, the liquid refrigerant changes in its state to a substantially gaseous state as a consequence of absorbing heat from the at least one fuel cell that is positioned against the first cooling channel, against the second cooling channel, and against the third cooling channel respectively. Thereafter, the refrigerant in the substantially gaseous state at the greater temperature than at its inlet port 260 is channeled through the outlet port 266 that is in flow communication with the first cooling channel, the second cooling channel, and the third cooling channel that are defined in the fuel cell stack 222 to the next stage of the thermal management system 200 for the fuel cell stack 222. During the process of refrigerant flow through the first cooling channel, through the second cooling channel, and through the third cooling channel of the fuel cell stack 222, each of the at least one fuel cell that is positioned against the first cooling channel, against the second cooling channel, and against the third cooling channel defined in the fuel cell stack 222 is cooled to a temperature that is within its acceptable operating design temperature limits. Therefore, the flow of refrigerant that is channeled through the inlet port 260 of the at least one cooling channel 210 and is channeled through the outlet port 266 of the at least one cooling channel 210 via the at least one cooling channel 210 decreases the temperature of the at least one fuel cell that is positioned against the first cooling channel, against the second cooling channel, and against the third cooling channel that is defined in the fuel cell stack 222 to the temperature that is within its acceptable operating design temperature limits.

In an exemplary embodiment, more than three cooling channels or less than three cooling channels may be deployed in the fuel cell stack 222 to cool the at least one fuel cell that is positioned within the fuel cell stack 222 depending on a size of the fuel cell stack 222 and an amount of heat that is dissipated by the at least one fuel cell that is positioned against the at least one cooling channel 210 that is defined in the fuel cell stack 222. The at least one fuel cell that is positioned against the at least one cooling channel 210 that is defined in the fuel cell stack 222 and that requires to be cooled may be but is not limited to at least one fuel cell that comprises at least one bipolar plate, at least one gas diffusion membrane, and at least one proton exchange membrane that constitutes the at least one fuel cell. In an alternate exemplary embodiment, the at least one fuel cell that is positioned against the at least one cooling channel 210 that is defined in the fuel cell stack 222 may be any kind of fuel cell that requires to be cooled from the higher temperature to the lower temperature by means of the liquid refrigerant that is channeled from the inlet port 260 of the first cooling channel of the at least one cooling channel 210 and finally to the outlet port 266 of the third cooling channel/last cooling channel of the at least one cooling channel 210 via the first cooling channel, via the second cooling channel, and via the third cooling channel respectively.

The refrigerant that flows past the at least one fuel cell that is positioned within the fuel cell stack 222 cools the at least one fuel cell that is positioned against the at least one cooling channel 210 defined in the fuel cell stack 222. The cooling of the at least one fuel cell that is positioned against the at least one cooling channel 210 decreases the temperature of the at least one fuel cell that is positioned within the fuel cell stack 222 from the higher temperature to the lower temperature respectively and attain a temperature that is within its acceptable operating design temperature limits. Thereby, a longevity of the at least one fuel cell that is positioned against the at least one cooling channel 210 that is defined in the fuel cell stack 222 as well as the fuel cell stack 222 may be substantially enhanced.

In an exemplary embodiment, the at least one fuel cell that is positioned within the fuel cell stack 222 is at high temperature. The heat from the high temperature at least one fuel cell that is positioned within the fuel cell stack 222 is discharged to the refrigerant that flows through the at least one cooling channel 210 that is defined in the fuel cell stack 222. Therefore, the refrigerant that flows through the at least one cooling channel 210 that is defined in the fuel cell stack 222 cools the at least one fuel cell that is positioned against the at least one cooling channel 210 that is defined in the fuel cell stack 222. More specifically, as the refrigerant flows through the at least one cooling channel 210 that is defined in the fuel cell stack 222, the heat that is discharged from the at least one fuel cell (the at least one fuel cell that comprises at least one bipolar plate, at least one gas diffusion layer, and at least one proton exchange membrane) that is positioned against the at least one cooling channel 210 that is defined in the fuel cell stack 222 is absorbed by the refrigerant that flows through the at least one cooling channel 210 that is defined in the fuel cell stack 222 by convection as refrigerant flows from the inlet port 260 of the at least one cooling channel 210 to the outlet port 266 of the at least one cooling channel 210 that is defined in the fuel cell stack 222. The absorption of heat by the liquid refrigerant from the at least one fuel cell that is positioned against the at least one cooling channel 210 that is defined in the fuel cell stack 222 cools the heated at least one fuel cell that is positioned against the at least one cooling channel 210 that is defined in the fuel cell stack 222. Therefore, once the refrigerant flows through the at least one cooling channel 210 that is defined in the fuel cell stack 222, the refrigerant cools the at least one fuel cell that is positioned against the at least one cooling channel 210 that is defined in the fuel cell stack 222 to a temperature that is within its acceptable operating design temperature limits. More specifically, as the substantially liquid refrigerant that is at high-speed, low pressure, and at low temperature that is received at the inlet port 260 of the first cooling channel of the at least one cooling channel 210 flows through the first cooling channel, through the second cooling channel, and through the third cooling channel that is defined in the fuel cell stack 222, heat from the at least one fuel cell that is positioned against the first cooling channel, against the second cooling channel, and against the third cooling channel is transferred to the liquid refrigerant via the outer wall of the first cooling channel, via the outer wall of the second cooling channel, and via the outer wall of the third cooling channel respectively. The transfer of heat from the at least one fuel cell that is positioned against the first cooling channel, against the second cooling channel, and against the third cooling channel that is defined in the fuel cell stack 222 to the liquid refrigerant that flows through the first cooling channel, through the second cooling channel, and through the third cooling channel increases a temperature of the refrigerant from a lower temperature to a higher temperature. The refrigerant is therein channeled to the outlet port 266 of the third cooling channel at the higher temperature than that of the liquid refrigerant at the low pressure and at the lower temperature that is received at the inlet port 260 of the first cooling channel of the at least one cooling channel 210 that is defined in the fuel cell stack 222.

In an exemplary embodiment, at least one inner wall of the at least one cooling channel 210 that is defined in the fuel cell stack 222 may be manufactured from a material that can withstand pressurized corrosive liquid refrigerant at low temperature. More specifically, as the liquid refrigerant flows along the at least one inner wall of the at least one cooling channel 210 that is defined in the fuel cell stack 222, the at least one inner wall of the at least one cooling channel 210 is susceptible to contraction due to the pressurized liquid refrigerant at low temperature, thereby causing deformations to occur on the at least one inner wall of the at least one cooling channel 210. Therefore, the at least one inner wall of the at least one cooling channel 210 defined in the fuel cell stack 222 is required to be manufactured from the material that can withstand pressurized corrosive liquid refrigerant at low temperature to ensure that the at least one cooling channel 210 does not contract and break down, thereby causing leakage of the pressurized refrigerant from the at least one cooling channel 210 that is defined in the fuel cell stack 222 to an external environment. In an exemplary embodiment, the inner wall of the at least one cooling channel 210 that is defined in the fuel cell stack 222 may be manufactured from but is not limited to a steel material, an aluminum material, a pressure resistant thermally conductive glass material, a pressure resistant thermally conductive plastic material, a pressure resistant thermally conductive polymer material, a thermally conductive acrylic material, thermally conductive PVC, thermally conductive PTFE, and a pressure resistant thermally conductive ceramic material. In an alternate exemplary embodiment, the at least one inner wall and at least one outer wall of the at least one cooling channel 210 that is defined in the fuel cell stack 222 may be manufactured from a high thermal conductivity material that facilitates efficient heat transfer from the at least one fuel cell that is positioned against the at least one cooling channel 210 that is defined in the fuel cell stack 222 to the refrigerant that flows through the at least one cooling channel 210 that is defined in the fuel cell stack 222. Moreover, the at least one inner wall of the at least one cooling channel 210 defined in the fuel cell stack 222 may be coated with a leak resistant material to ensure containment of liquid/gaseous refrigerant within the at least one cooling channel 210 that is defined in the fuel cell stack 222 itself without being discharged to the external environment.

In an exemplary embodiment, the outlet port 266 of the at least one cooling channel 210 defined in the fuel cell stack 222 is in flow communication with the inlet port 281 of the compressor 220 such that the refrigerant at high temperature that flows from the outlet port 266 of the at least one cooling channel 210 that is defined in the fuel cell stack 222 is supplied to the inlet port 281 of the compressor 220.

Therefore, in this embodiment of the invention, the refrigerant is channeled through the inlet port 281 of the compressor 220 where refrigerant is compressed from a low pressure to a high pressure with a corresponding large increase in temperature of the refrigerant. Refrigerant is channeled from the outlet port 282 of the compressor 220 via the pressure regulator to the inlet port 285 of the bypass valve 250. Refrigerant is channeled from the outlet port 232 of the bypass valve 250 to the inlet port 231 of the condenser 230 where heat is dissipated from the refrigerant in the condenser 230, thereby decreasing the temperature of the refrigerant from higher temperature to lower temperature and bypassing a bypass flow path 234. Refrigerant is channeled from the outlet port 284 of the condenser 230 to the inlet port 283 of the expansion valve 240 where the pressure of the refrigerant is substantially decreased from high pressure to low pressure and a speed of the refrigerant is substantially increased from low speed to high speed. Refrigerant in the substantially liquid state at low temperature is channeled from the outlet port 265 of the expansion valve 240 through the fuel cell stack 222 and consequently past the at least one fuel cell that is positioned within the fuel cell stack 222 via its inlet port 260 towards its outlet port 266. From the outlet port 266 of the fuel cell stack 222, refrigerant at high temperature after absorbing heat from the at least one fuel cell that is positioned within the fuel cell stack 222 is channeled back to the inlet port 281 of the compressor 220 and the cycle is repeated. It may be noted that in this embodiment of the invention, refrigerant may not be channeled through the bypass flow path 234 from the bypass valve 250. Rather, the refrigerant is channeled directly from the pressure regulator of the compressor 220 to the condenser 230 via the outlet port 232 of the bypass valve 250 for cooling the refrigerant in the condenser 230, and subsequently delivered at high pressure and at low temperature to the expansion valve 240 via the outlet port 284 of the condenser.

In an exemplary embodiment, the cooling fan 290 is positioned proximate to the condenser 230. More specifically, the cooling fan 290 that is positioned proximate to the condenser 230 receives electric power from but is not limited to the fuel cell stack 222 and an electric battery (not shown) that is in electronic communication with the fuel cell stack 222. In an alternate exemplary embodiment, the cooling fan 290 that is positioned proximate to the condenser 230 receives electric power from an external power source such as but not limited to a wall mounted electric socket. The functioning of the cooling fan 290 causes a rotation of a plurality of fan blades 293 that are coupled to the cooling fan 290 that is positioned proximate to the condenser 230 and delivers a stream of high-speed cooling air to the condenser 230 to cool the gaseous refrigerant that is received in the condenser 230 from the bypass valve 250 via the outlet port 232 of the bypass valve 250. More specifically, the condenser 230 is positioned in an air flow path of the cooling fan 290 that is positioned proximate to the condenser 230 and receives the stream of high-speed cooling air that is discharged from the cooling fan 290 and that impinges on the outer surface of the condenser 230. The stream of high-speed cooling air that is discharged from the cooling fan 290 that is positioned proximate to the condenser 230 and that impinges on the outer surface of the condenser 230 withdraws heat away from the condenser 230 by convection, thereby cooling the gaseous refrigerant that is channeled to the condenser 230 via its inlet port 231 from the bypass valve 250. More specifically, the gaseous refrigerant is channeled to the condenser 230 via the outlet port 232 of the bypass valve 250 and flows through the condenser 230. Therefore, the cooling fan 290 facilitates discharging heat from the gaseous refrigerant that flows through the condenser 230. More specifically, the heat that was absorbed by the refrigerant in the fuel cell stack 222 while flowing through the fuel cell stack 222 and the heat that was absorbed by the refrigerant in the compressor 220 due to compression of the gaseous refrigerant in the compressor 220 is substantially discharged in the condenser 230 due to the stream of high-speed cooling air that is discharged from the cooling fan 290 and that impinges on the outer surface of the condenser 230, thereby withdrawing the heat away from the refrigerant and decreasing the temperature of the gaseous refrigerant that flows through the condenser 230 via the inlet port 231 of the condenser 230 substantially. Therefore, at the outlet port 284 of the condenser 230, substantially gaseous refrigerant at high pressure and at a lower temperature than the higher temperature gaseous refrigerant that was channeled to the inlet port 231 of the condenser 230 is channeled to the next stage (i.e. to the inlet port 283 of the expansion valve 240) of the thermal management system 200 for the fuel cell stack 222.

The cooling fan 290 may be mechanically secured to any substrate and positioned in a manner such that the cooling fan 290 is positioned proximate to the condenser 230 and delivers the stream of high-speed cooling air to the outer surface of the condenser 230. In an alternate exemplary embodiment, a plurality of fins may be secured to the outer surface of the condenser 230 and receives heat from the outer surface of the condenser 230. The heat that is received by the plurality of fins from the outer surface of the condenser 230 decreases a temperature of the refrigerant that flows through the condenser 230, thereby causing heat from the gaseous refrigerant that flows through the condenser 230 to be discharged to the external environment and substantially cooling the gaseous refrigerant that flows through the condenser 230. In an exemplary embodiment, the condenser 230 is in flow communication with the outlet port 232 of the bypass valve 250 and receives gaseous refrigerant at high pressure and at high temperature within the condenser 230 via the inlet port 231 of the condenser 230.

The refrigerant that flows through the thermal management system 200 for the fuel cell stack 222 to cool the fuel cell stack 222 that houses the at least one fuel cell therein is of a specific heat absorption capacity/unit mass of the refrigerant that is lesser than the specific heat absorption capacity/unit mass of liquid coolant. In addition, due to the lower specific heat absorption capacity/unit mass of the refrigerant than the specific heat absorption capacity/unit mass of the liquid coolant, the heat absorption rate/unit mass of the refrigerant is much greater than the heat absorption rate/unit mass of the liquid coolant. Therefore, since the specific heat absorption capacity/unit mass of the refrigerant that flows through the fuel cell stack 222 is lesser than the specific heat absorption capacity/unit mass of liquid coolant, and that the heat absorption rate/unit mass of the refrigerant is much greater than the heat absorption rate/unit mass of the liquid coolant, a lower mass flow rate of liquid refrigerant is required to be channeled through the at least one cooling channel 210 that is defined in the fuel cell stack 222 than the mass flow rate of liquid coolant. More specifically, the lower mass flow rate of liquid refrigerant is required to be channeled through the at least one cooling channel 210 that is defined in the fuel cell stack 222 to decrease the first temperature of the fuel cell stack 222 and consequently the at least one fuel cell to the second temperature in contrast to the higher mass flow rate of liquid coolant that is required to be channeled through the at least one cooling channel 210 that is defined in the fuel cell stack 222 to decrease the first temperature of the fuel cell stack 222 and consequently the at least one fuel cell that is positioned within the fuel cell stack to the second temperature. Therefore, in order to decrease the temperature of the fuel cell stack 222 that houses the at least one fuel cell therein, and that is positioned against the at least one cooling channel 210 from the first temperature to the second temperature, a lower mass flow rate of liquid refrigerant is required to be channeled through the at least one cooling channel 210 that is defined in the fuel cell stack 222 to decrease the first temperature of the fuel cell stack 222 and consequently the at least one fuel cell to the second temperature in contrast to the higher mass flow rate of liquid coolant that is required to be channeled through the at least one cooling channel 210 that is defined in the fuel cell stack 222 and consequently the at least one fuel cell to decrease its first temperature to the second temperature. The low specific heat absorption capacity/unit mass of the liquid refrigerant and its high heat absorption rate implies that a low mass flow rate of liquid refrigerant that is channeled through the at least one cooling channel 210 is sufficient to absorb a substantially same amount of heat from the fuel cell stack 222 that houses the at least one fuel cell therein as that of a high mass flow rate of liquid coolant that has a comparatively high specific heat absorption capacity/unit mass of the liquid coolant as well as a low heat absorption rate of the liquid coolant to decrease the first temperature of the fuel cell stack 222 and consequently the at least one fuel cell that is positioned within the fuel cell stack 222 to the second temperature. In addition, owing to the lower specific heat absorption capacity/unit mass of the refrigerant in contrast to the higher specific heat absorption capacity/unit mass of the liquid coolant, the heat absorption rate/unit mass of the refrigerant is much greater than the heat absorption rate/unit mass of the liquid coolant. In addition, the phase change of the refrigerant from the substantially liquid phase to the gaseous phase enables the refrigerant to absorb a greater amount of heat (latent heat) from the fuel cell stack 222/unit mass of the refrigerant than that of the liquid coolant where there is no phase change occurring in the liquid coolant during the process of heat absorption from the fuel cell stack 222. More specifically, the refrigerant absorbs heat in the form of latent heat from the fuel cell stack 222 during its process of conversion from the liquid state to the gaseous state, thereby enabling the refrigerant to absorb a much higher quantity of heat from the fuel cell stack 222/unit mass of refrigerant than liquid coolant that does not undergo any phase change during the process of heat absorption from the fuel cell stack 222. Therefore, indirect refrigerant based cooling by means of the refrigerant for cooling the fuel cell stack 222 and consequently the at least one fuel cell that is positioned within the fuel cell stack 222 is a much better alternative than the liquid coolant-based cooling methodology.

In another exemplary embodiment, the electronic control unit 212 is adapted to control the cooling fan 290 that delivers the stream of high-speed cooling air to the outer surface of the condenser 230 to cool the refrigerant that is received in the condenser 230 from the outlet port 232 of the bypass valve 250 via a control flow path 201 that is in electronic communication between the cooling fan 290 and the electronic control unit 212. More specifically, the electronic control unit 212 is adapted to control an operating speed of the cooling fan 290 to control a mass flow rate of high-speed cooling air that is delivered from the cooling fan 290 to the condenser 230 to cool the refrigerant that is received in the condenser 230 to its acceptable operating design temperature limits. In a further exemplary embodiment, the electronic control unit 212 is adapted to control the flow of refrigerant from the expansion valve 240 to the inlet port 260 of the at least one cooling channel 210 that is defined in the fuel cell stack 222 via the control flow path 271 that is in electronic communication between the expansion valve 240 and the electronic control unit 212. More specifically, the electronic control unit 212 controls a mass flow rate of refrigerant that is channeled through the outlet port 265 of the expansion valve 240 to the inlet port 260 of the at least one cooling channel 210 that is defined in the fuel cell stack 222. In yet another exemplary embodiment, the electronic control unit 212 is adapted to control a delivery pressure of the refrigerant that flows from the pressure regulator of the compressor 220 for delivering pressurized refrigerant at high temperature to the bypass valve 250 via the control flow path 273 that is in electronic communication between the pressure regulator (not shown) of the compressor 220 and the electronic control unit 212. More specifically, the electronic control unit 212 controls a delivery pressure of the refrigerant that is channeled from the outlet port 282 of the compressor 220 to the bypass valve 250 based on a pressure requirement of refrigerant in the fuel cell stack 222 during each cycle of operation by controlling an opening percentage of the pressure regulator of the compressor 220. The pressure requirement of refrigerant during each cycle of operation of the thermal management system 200 is determined by the electronic control unit 212 from at least one pressure sensor (not shown) that is in electronic communication between the electronic control unit 212 and at least one fuel cell that is positioned within the fuel cell stack 222/fuel cell stack 222 via a control flow path.

In another exemplary embodiment, the electronic control unit 212 is adapted to receive a temperature signal that comprises an operating temperature of the at least one fuel cell that is positioned within the fuel cell stack 222 from a temperature sensor 206 that is in thermal communication with the at least one fuel cell via a control flow path 205 that is in electronic communication between the temperature sensor 206 and the electronic control unit 212. More specifically, the electronic control unit 212 controls the quantity of refrigerant that is channeled through the outlet port 265 of the expansion valve 240 to the inlet port 260 of the at least one cooling channel 210 that is defined in the fuel cell stack 222 by controlling an opening percentage/opening of the outlet port 265 of the expansion valve 240 based on the temperature signal that is received by the electronic control unit 212 from the temperature sensor 206 via the control flow path 205. If the temperature of the at least one fuel cell that is positioned within the fuel cell stack 222 is greater than a pre-determined threshold temperature that is defined by a user, the electronic control unit 212 controls the opening percentage/opening of the outlet port 265 of the expansion valve 240 to channel refrigerant at low temperature from the outlet port 265 of the expansion valve 240 to the inlet port 260 of the at least one cooling channel 210 that is defined in the fuel cell stack 222.

The refrigerant that flows past the at least one fuel cell that is positioned against the at least one cooling channel 210 defined in the fuel cell stack 222 cools the fuel cell stack 222, and consequently the at least one fuel cell that is positioned against the at least one cooling channel 210 defined in the fuel cell stack 222. The cooling of the fuel cell stack 222, and consequently the at least one fuel cell that is positioned against the at least one cooling channel 210 defined in the fuel cell stack 222 decreases the temperature of the fuel cell stack 222 and the at least one fuel cell that is positioned against the at least one cooling channel 210 defined in the fuel cell stack 222 respectively. Therefore, the fuel cell stack 222 and the at least one fuel cell that is positioned against the at least one cooling channel 210 defined in the fuel cell stack 222 are maintained within their respective acceptable operating design temperature limits, thereby enhancing a longevity and useful life of the at least one fuel cell that is positioned against the at least one cooling channel 210 defined in the fuel cell stack 222. After liquid refrigerant is channeled through the at least one cooling channel 210, the fuel cell stack 222 and the at least one fuel cell that is positioned against the at least one cooling channel 210 defined in the fuel cell stack 222 may be cooled to different operating temperatures, but still be within the acceptable operating design temperature limits of the fuel cell stack 222 as well as the acceptable operating design temperature limits of the at least one fuel cell that is positioned against the at least one cooling channel 210 defined in the fuel cell stack 222 respectively. In an exemplary embodiment, the at least one fuel cell may be positioned directly against the at least one cooling channel 210 via the outer wall of the at least one cooling channel 210 and discharges heat to the refrigerant via the outer wall of the at least one cooling channel 210 by conduction. In an alternate exemplary embodiment, the at least one fuel cell may be positioned indirectly against the at least one cooling channel 210 via the housing of the fuel cell stack 222 that is in thermal communication with the at least one cooling channel 210 and discharges heat to the refrigerant flowing through the at least one cooling channel 210 via the housing of the fuel cell stack 222 by conduction.

A working of the thermal management system 200 for the fuel cell stack 222 is described as an example. In an exemplary embodiment, the refrigerant in the substantially liquid state is received within the at least one cooling channel 210 that is defined in the fuel cell stack 222 via the inlet port 260 that is in flow communication with the at least one cooling channel 210 that is defined in the fuel cell stack 222 from the outlet port 265 of the expansion valve 240. More specifically, the refrigerant in the substantially liquid state is received within the at least one cooling channel 210 that is defined in the fuel cell stack 222. When the electronic control unit 212 determines that the temperature of the at least one fuel cell that is positioned against the at least one cooling channel 210 defined in the fuel cell stack 222 is required to be decreased by means of the temperature sensor 206 that is in thermal communication with the fuel cell stack 222, the electronic control unit 212 controls the expansion valve 240 to an open position. Liquid refrigerant at low temperature is therein channeled to the fuel cell stack 222 via the outlet port 265 of the expansion valve 240 to cool the at least one fuel cell that is positioned within the fuel cell stack 222. Once the liquid refrigerant is channeled within the at least one cooling channel 210 that is defined in the fuel cell stack 222, the liquid refrigerant is allowed to flow through the at least one cooling channel 210 that is defined in the fuel cell stack 222 to cool the at least one fuel cell that is positioned against the at least one cooling channel 210 defined in the fuel cell stack 222. More specifically, once the liquid refrigerant flows through the inlet port 260 of the at least one cooling channel 210 that is defined in the fuel cell stack 222, the liquid refrigerant is channeled through the first cooling channel, through the second cooling channel, and through the third cooling channel until the refrigerant is channeled through the outlet port 266 of the at least one cooling channel 210 that is in flow communication with the third cooling channel. The flow of liquid refrigerant through the first cooling channel, through the second cooling channel, and through the third cooling channel of the at least one cooling channel 210 that is defined in the fuel cell stack 222 cools the at least one fuel cell that is positioned against the at least one cooling channel 210 defined in the fuel cell stack 222.

More specifically, as the liquid refrigerant flows through the first cooling channel, through the second cooling channel, through the third cooling channel and finally through the outlet port 266 of the third cooling channel of the at least one cooling channel 210 respectively, the liquid refrigerant absorbs heat indirectly from the at least one fuel cell that is positioned against the outer wall of the at least one cooling channel 210 of the fuel cell stack 222 and gets heated due to transfer of heat from the at least one fuel cell that is positioned against the at least one cooling channel 210 defined in the fuel cell stack 222 to the liquid refrigerant. More specifically, the liquid refrigerant gets heated due to the transfer of heat from the at least one fuel cell that is positioned against the at least one cooling channel 210 defined in the fuel cell stack 222 to the liquid refrigerant flowing through the at least one cooling channel 210 by convection. The rapid absorption of heat by the liquid refrigerant from the at least one fuel cell that is positioned against the at least one cooling channel 210 defined in the fuel cell stack 222 changes the phase of the refrigerant from the liquid phase to the gaseous phase as refrigerant flows through the first cooling channel, through the second cooling channel, and through the third cooling channel of the at least one cooling channel 210 respectively. Therefore, when the liquid refrigerant enters the inlet port 260 of the first cooling channel of the at least one cooling channel 210, the liquid refrigerant is at low temperature and at low pressure. However, as the liquid refrigerant changes its phase to the substantially gaseous phase during the process of heat absorption from the at least one fuel cell that is positioned against the first cooling channel, against the second cooling channel, and against the third cooling channel of the at least one cooling channel 210 that is defined in the fuel cell stack 222 as refrigerant flows through the first cooling channel, through the second cooling channel, and through the third cooling channel of the at least one cooling channel 210 respectively, the refrigerant that flows from the outlet port 266 of the third cooling channel of the at least one cooling channel 210 is at higher temperature and at low pressure than the refrigerant that flows through the inlet port 260. In an exemplary embodiment, more than three cooling channels may be deployed in the fuel cell stack to cool the at least one fuel cell that is positioned within the fuel cell stack depending on a cooling requirement of the fuel cell stack and consequently the at least one fuel cell that is positioned within the fuel cell stack 222.

As heat flows from the at least one fuel cell that is positioned against the at least one cooling channel 210 defined in the fuel cell stack 222 to the refrigerant that flows through the inlet port 260 of the at least one cooling channel 210, through the first cooling channel, through the second cooling channel, through the third cooling channel, and through the outlet port 266 of the at least one cooling channel 210, the at least one fuel cell that is positioned against the at least one cooling channel 210 defined in the fuel cell stack 222 is substantially cooled from the higher temperature to the lower temperature that is within its acceptable operating design temperature limits. The refrigerant that flows from the outlet port 266 of the third cooling channel of the at least one cooling channel 210 that is defined in the fuel cell stack 222 at high temperature after absorbing heat from the at least one fuel cell that is positioned within the fuel cell stack 222 and in mechanical contact with the at least one cooling channel 210 is subsequently channeled to the inlet port 281 of the compressor 220.

When the electronic control unit 212 determines that the temperature of the at least one fuel cell that is positioned against the at least one cooling channel 210 that is defined in the fuel cell stack 222 is not required to be decreased by means of the temperature sensor 206 that is positioned within the fuel cell stack 222 and in thermal communication with the at least one fuel cell, the electronic control unit 212 controls the expansion valve 240 to a closed position. Therefore, in the closed position of the expansion valve 240, liquid refrigerant from the outlet port 265 of the expansion valve 240 does not flow through the at least one cooling channel 210 that is defined in the fuel cell stack 222 to cool the at least one fuel cell that is positioned against the at least one cooling channel 210 that is defined in the fuel cell stack 222.

The refrigerant that flows from the outlet port 266 of the at least one cooling channel 210 that is defined in the fuel cell stack 222 that is in the gaseous state at high temperature and at low pressure is channeled to the inlet port 281 of the compressor 220 via a connecting pipe. Once the gaseous refrigerant is received in the compressor 220 via its inlet port 281, the gaseous refrigerant is compressed in the compressor 220 from a pressure of the refrigerant at the outlet port 266 of the at least one cooling channel 210 that is defined in the fuel cell stack 222 to a much higher pressure that is required for the refrigerant to be circulated through the thermal management system 200 for the fuel cell stack 222. Therefore, as the gaseous refrigerant at high temperature and at low pressure flows through the compressor 220 via its inlet port 281, the compressor 220 increases the pressure of the refrigerant from the lower pressure to the higher pressure with a corresponding large increase in temperature of the refrigerant. Therefore, at the outlet port 282 of the compressor 220, the gaseous refrigerant is at higher temperature than the temperature of the gaseous refrigerant that is channeled to the inlet port 281 of the compressor 220 from the outlet port 266 of the at least one cooling channel 210 that is defined in the fuel cell stack 222, and at a higher pressure than the pressure of gaseous refrigerant that is channeled to the inlet port 281 of the compressor 220 from the outlet port 266 of the at least one cooling channel 210 that is defined in the fuel cell stack 222.

The refrigerant at the outlet port 282 of the compressor 220 that is in the gaseous state at high temperature and at high pressure is channeled through the pressure regulator of the compressor 220 to the inlet port 231 of the condenser 230 via the outlet port 232 of the bypass valve 250. Once the gaseous refrigerant is received in the condenser 230 via its inlet port 231, heat that is present within the gaseous refrigerant that was absorbed by the refrigerant that was channeled through the at least one cooling channel 210 that is defined in the fuel cell stack 222 from the at least one fuel cell that is positioned against the at least one cooling channel 210 that is defined in the fuel cell stack 222, and the heat that was absorbed by the refrigerant in the compressor 220 while the gaseous refrigerant was compressed in the compressor 220 is substantially discharged in the condenser 230. More specifically, the cooling fan 290 that is positioned proximate to the condenser 230 receives electric energy from the electric power source such as but not limited to the fuel cell stack 222 and the electric battery (not shown). Therein, the cooling fan 290 that is positioned proximate to the condenser 230 rotates, thereby channeling high-speed cooling air to the outer surface of the condenser 230. The high-speed cooling air from the cooling fan 290 that impinges on the outer surface of the condenser 230 withdraws heat away from the gaseous refrigerant that flows through a plurality of coiled channels 204 that are each defined within the condenser 230. More specifically, the plurality of coiled channels 204 are in flow communication with the inlet port 231 of the condenser 230 at its one end and in flow communication with the outlet port 284 of the condenser 230 at its opposite second end and channels gaseous refrigerant therethrough in order to discharge heat from the gaseous refrigerant that flows through the condenser 230. The coiled nature of the plurality of coiled channels 204 increases a length of travel of the gaseous refrigerant as refrigerant flows through a longitudinal length of the condenser 230, thereby facilitating discharging heat from the gaseous refrigerant in the condenser 230 effectively. Due to heat from the gaseous refrigerant that is channeled away from the condenser 230 by the high-speed cooling air that is discharged by the cooling fan 290 and that impinges on the outer surface of the condenser 230, the temperature of the gaseous refrigerant that flows through the plurality of coiled channels 204 defined within the condenser 230 from the inlet port 231 of the condenser 230 to the outlet port 284 of the condenser 230 is decreased substantially from the higher temperature of the refrigerant at the inlet port 231 of the condenser 230 to the lower temperature of the refrigerant at the outlet port 284 of the condenser 230. While the temperature of the refrigerant decreases substantially from the higher temperature at the outlet port 282 of the compressor 220 to the lower temperature as the refrigerant flows through the plurality of coiled channels 204 that are defined within the condenser 230, the pressure of the refrigerant as refrigerant flows through the plurality of coiled channels 204 that are defined within the condenser 230 remains steady or decreases to a slightly lower pressure from the high pressure gaseous refrigerant that is channeled from the outlet port 282 of the compressor 220 to the inlet port 231 of the condenser 230 via the outlet port 232 of the bypass valve 250. Therefore, at the outlet port 284 of the condenser 230, the gaseous refrigerant is at a relatively much lower temperature than that of the gaseous refrigerant that is channeled to the inlet port 231 of the condenser 230 from the outlet port 282 of the compressor 220, and at a substantially same pressure or slightly lower pressure as that of the gaseous refrigerant that is channeled to the inlet port 231 of the condenser 230 from the outlet port 282 of the compressor 220 via the outlet port 232 of the bypass valve 250.

The refrigerant at the outlet port 284 of the condenser 230 that is in the gaseous state at low temperature and at high pressure is channeled to the inlet port 283 of the expansion valve 240. The expansion valve 240 is in flow communication with the outlet port 284 of the condenser 230 at its inlet port 283 and receives refrigerant that flows from the condenser 230 via the outlet port 284 of the condenser 230. Once the refrigerant is received at the inlet port 283 of the expansion valve 240 in the substantially gaseous state, the expansion valve 240 throttles the gaseous refrigerant, thereby decreasing the pressure of the refrigerant that flows from the outlet port 284 of the condenser 230 to a relatively much lower pressure that flows from the outlet port 265 of the expansion valve 240. Due to the substantial decrease in the pressure of the refrigerant due to the throttling action of the expansion valve 240, the temperature of the refrigerant is decreased from the low temperature at the inlet port 283 of the expansion valve 240 to a relatively much lower temperature that flows from the outlet port 265 of the expansion valve 240. The expansion valve 240 is in flow communication with the inlet port 260 of the at least one cooling channel 210 defined in the fuel cell stack 222 at its outlet port 265. The expansion valve 240 controls a flow of refrigerant that flows through the outlet port 284 of the condenser 230 to the inlet port 260 of the at least one cooling channel 210 that is defined in the fuel cell stack 222, wherein the expansion valve 240 is electronically controlled by means of the electronic control unit 212 that is in electronic communication with the expansion valve 240 via the control flow path 271. More specifically, the electronic control unit 212 controls the opening percentage/opening of the expansion valve 240 to facilitate regulating a required mass flow rate of the refrigerant that is required to flow from the outlet port 284 of the condenser 230 to the inlet port 260 of the at least one cooling channel 210 that is defined in the fuel cell stack 222 for the refrigerant to be circulated through the thermal management system 200 for the fuel cell stack 222 via the outlet port 265 of the expansion valve 240.

As the pressure and the temperature of the refrigerant decreases from higher pressure and lower temperature at the outlet port 284 of the condenser 230 to lower pressure and much lower temperature that is required for the refrigerant to be circulated through the thermal management system 200 for the fuel cell stack 222, the refrigerant changes its phase to the substantially liquid phase due to the decrease in the temperature of the refrigerant below the phase transition temperature of the refrigerant that flows through the outlet port 265 of the expansion valve 240 to the inlet port 260 of the at least one cooling channel 210 that is defined in the fuel cell stack 222. Moreover, the throttling of the refrigerant that flows through the outlet port 284 of the condenser 230 to the inlet port 260 of the at least one cooling channel 210 that is defined in the fuel cell stack 222 by means of the expansion valve 240 that is controlled by the electronic control unit 212 via the control flow path 271 permits only the required mass flow rate of refrigerant to be channeled at high-speed through the inlet port 260 of the at least one cooling channel 210 that is defined in the fuel cell stack 222. Therefore, at the outlet port 265 of the expansion valve 240, substantially liquid refrigerant is at lower pressure than that of the refrigerant that is channeled to the inlet port 283 of the expansion valve 240 from the outlet port 284 of the condenser 230 and is at lower temperature than that of the refrigerant that is channeled to the inlet port 283 of the expansion valve 240 from the outlet port 284 of the condenser 230.

In an exemplary embodiment, the inlet port 260 of the at least one cooling channel 210 defined in the fuel cell stack 222 is in flow communication with the outlet port 265 of the expansion valve 240, and receives high-speed liquid refrigerant at low pressure and at low temperature therein. The outlet port 265 of the expansion valve 240 may be opened by different opening percentages by the electronic control unit 212 via the control flow path 271 to channel liquid refrigerant at different operating temperatures and different operating pressures through the at least one cooling channel 210 that is defined in the fuel cell stack 222. After the refrigerant in the substantially liquid state at low pressure and at low temperature is channeled to the inlet port 260 of the at least one cooling channel 210 that is defined in the fuel cell stack 222, the cycle is repeated subsequently with the flow of liquid refrigerant through the at least one cooling channel 210 defined in the fuel cell stack 222 to cool the at least one fuel cell that is positioned against the at least one cooling channel 210 that is defined in the fuel cell stack 222.

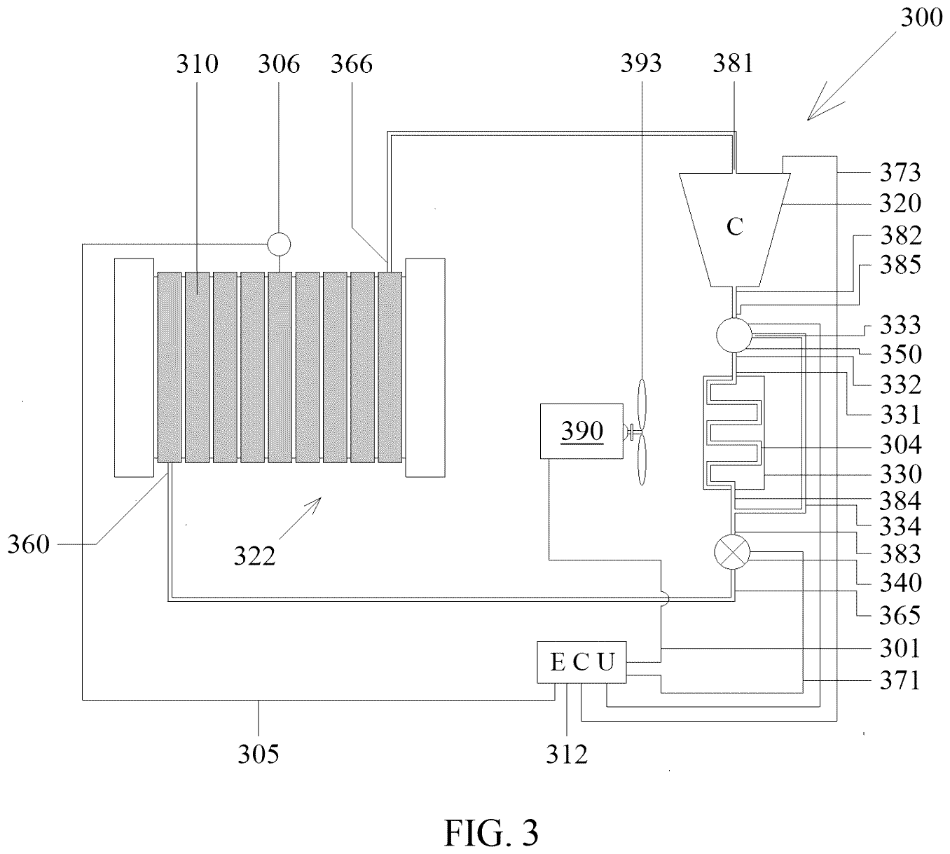

FIG. 3 is a schematic representation of the thermal management system 300 for directly cooling the fuel cell stack 322 and consequently the at least one fuel cell that is in flow communication with the compressor 320, the condenser 330, and the expansion valve 340 in another embodiment of the invention. The expansion valve 340 throttles the flow of refrigerant that flows through the outlet port 384 of the condenser 330 to a cooling chamber 310 that is defined in the fuel cell stack 322. The flow of refrigerant from the expansion valve 340 through the cooling chamber 310 that is defined in the fuel cell stack 322 in one embodiment of the invention is described below.

In an exemplary embodiment, the cooling chamber 310 that is defined in the fuel cell stack 322 comprises the inlet port 360. More specifically, the inlet port 360 of the cooling chamber 310 that is defined in the fuel cell stack 322 is in flow communication with the outlet port 365 of the expansion valve 340 and receives refrigerant in the substantially liquid state. The refrigerant that is received in the substantially liquid state via the inlet port 360 of the cooling chamber 310 that is defined in the fuel cell stack 322 flows past the at least one fuel cell that is positioned within the fuel cell stack 322 and that requires to be cooled. More specifically, the at least one fuel cell is in mechanical contact with at least one inner wall of the cooling chamber 310 and is submerged and in direct contact with the refrigerant that flows through the cooling chamber 310. In an exemplary embodiment, the at least one fuel cell that is positioned within the cooling chamber 310 of the fuel cell stack 322 and that requires to be cooled comprises at least one fuel cell (not shown) of the fuel cell stack 322 that is at high temperature. On flowing past the at least one fuel cell that is positioned within the cooling chamber 310 of the fuel cell stack 322 and cooling the at least one fuel cell, the refrigerant at an elevated temperature is channeled out of the cooling chamber 310 via the outlet port 366 of the cooling chamber 310 that is defined in the fuel cell stack 322.

The cooling chamber 310 contains at least one fuel cell (typically a PEM fuel cell) at high temperature, and that is required to be cooled by the liquid refrigerant at low temperature that is channeled through the inlet port 360 of the cooling chamber 310 that is defined in the fuel cell stack 322. In an exemplary embodiment, the cooling chamber 310 is in flow communication with the outlet port 366 that receives the refrigerant that flows through the cooling chamber 310. As the refrigerant that is at low temperature flows from the inlet port 360 of the cooling chamber 310 to the outlet port 366 of the cooling chamber 310 via the cooling chamber 310, the refrigerant at lower temperature increases in its temperature to a higher temperature as a consequence of absorbing heat from the at least one fuel cell that is positioned within the cooling chamber 310 defined in the fuel cell stack 322 and is submerged and in direct contact with the refrigerant that flows through the cooling chamber 310 defined in the fuel cell stack 322. Thereafter, the refrigerant at the higher temperature is channeled through the outlet port 366 that is in flow communication with the cooling chamber 310 that is defined in the fuel cell stack 322 to the next stage of the thermal management system 300 for the fuel cell stack 322.

During the process of refrigerant flow through the cooling chamber 310 that is defined in the fuel cell stack 322, the at least one fuel cell at high temperature that is positioned within the cooling chamber 310 defined in the fuel cell stack 322 and is submerged and in direct contact with the refrigerant that flows through the cooling chamber 310 of the fuel cell stack 322 is cooled from a higher temperature to a lower temperature that is within its acceptable operating design temperature limits. Therefore, the refrigerant that is channeled from the inlet port 360 of the cooling chamber 310 to the cooling chamber 310 and subsequently channeled through the outlet port 366 of the cooling chamber 310 facilitates decreasing the temperature of the at least one fuel cell at higher temperature that is positioned within the cooling chamber 310 of the fuel cell stack 322 to the lower temperature that is within its acceptable operating design temperature limits. In an exemplary embodiment, the fuel cell stack 322 contains at least one fuel cell at high temperature that requires to be cooled by means of the refrigerant that is channeled through the cooling chamber 310 defined in the fuel cell stack 322 and that submerges and is in direct contact with the at least one fuel cell that is positioned within the cooling chamber 310 defined in the fuel cell stack 322. The fuel cell stack 322 that contains at least one fuel cell at high temperature may be any kind of fuel cell stack 322 such as but not limited to a polymer electrolyte membrane fuel cell stack, a direct methanol fuel cell stack, an alkaline fuel cell stack, a proton-exchange membrane fuel cell stack, a phosphoric acid fuel cell stack, a molten carbonate fuel cell stack, a solid oxide fuel cell stack, and a reversible fuel cell stack. The fuel cell stack 322, and more specifically the at least one fuel cell at higher temperature requires to be cooled to the lower temperature by means of the low temperature refrigerant that is channeled from the inlet port 360 of the cooling chamber 310 that is defined in the fuel cell stack 322 to the outlet port 366 of the cooling chamber 310 that is defined in the fuel cell stack 222, and that submerges and is in direct contact with the at least one fuel cell that is positioned within the cooling chamber 310 that is defined in the fuel cell stack 322.

The refrigerant that flows past the at least one fuel cell at high temperature that is positioned within the cooling chamber 310 defined in the fuel cell stack 322 and that submerges and is in direct contact with the at least one fuel cell cools the at least one fuel cell substantially. The cooling of the at least one fuel cell at high temperature that is positioned within the cooling chamber 310 defined in the fuel cell stack 322 and that is submerged and in direct contact with the refrigerant decreases the temperature of the at least one fuel cell from the higher temperature to the lower temperature respectively and attain a temperature that is within its acceptable operating design temperature limits. Thereby, a longevity and useful life of the at least one fuel cell at high temperature that is positioned within the cooling chamber 310 defined in the fuel cell stack 322 and is submerged and in direct contact with the refrigerant may be substantially increased.

In an exemplary embodiment, the at least one fuel cell at high temperature that is positioned within the cooling chamber 310 defined in the fuel cell stack 322 generates heat during a process of hydrogen-oxygen reverse electrolysis reaction that occurs within the at least one fuel cell. The heat that is generated in the at least one fuel cell that is positioned within the cooling chamber 310 defined in the fuel cell stack 322 is discharged to the refrigerant that flows through the cooling chamber 310 that is defined in the fuel cell stack 322 and that submerges and is in direct contact with the at least one fuel cell. Therefore, the refrigerant that flows through the cooling chamber 310 that is defined in the fuel cell stack 322 cools the at least one fuel cell at high temperature that is positioned within the cooling chamber 310 defined in the fuel cell stack 322 and is submerged and in direct contact with the refrigerant. More specifically, as the refrigerant flows through the cooling chamber 310 that is defined in the fuel cell stack 322, the heat that is discharged from the at least one fuel cell at high temperature that is positioned within the cooling chamber 310 defined in the fuel cell stack 322 and is submerged and in direct contact with the refrigerant is absorbed by the refrigerant at low temperature that flows through the cooling chamber 310 by convection as refrigerant flows from the inlet port 360 of the cooling chamber 310 to the outlet port 366 of the cooling chamber 310 that is defined in the fuel cell stack 322. The absorption of heat by the refrigerant at low temperature from the at least one fuel cell that is positioned within the cooling chamber 310 defined in the fuel cell stack 322 cools the heated fuel cell stack 322, and consequently the heated at least one fuel cell that is positioned within the cooling chamber 310 defined in the fuel cell stack 322 and is submerged and in direct contact with the refrigerant that flows through the cooling chamber 310. Therefore, once the refrigerant flows through the cooling chamber 310 that is defined in the fuel cell stack 322, the refrigerant at low temperature cools the at least one fuel cell at high temperature that is positioned within the cooling chamber 310 defined in the fuel cell stack 322 and is submerged and in direct contact with the refrigerant. More specifically, as the refrigerant at high-speed, low pressure, and at low temperature that is received at the inlet port 360 of the cooling chamber 310 flows through the cooling chamber 310 that is defined in the fuel cell stack 322, heat from the at least one fuel cell at high temperature that is positioned within the cooling chamber 310 defined in the fuel cell stack 322 is transferred to the refrigerant at low temperature that submerges and is in direct contact with the at least one fuel cell. The transfer of heat from the at least one fuel cell at high temperature that is positioned within the cooling chamber 310 defined in the fuel cell stack 322 and is submerged and in direct contact with the refrigerant to the refrigerant at low temperature that flows through the cooling chamber 310 increases a temperature of the refrigerant from lower temperature to refrigerant at higher temperature. The refrigerant at higher temperature is therein channeled to the outlet port 366 of the cooling chamber 310 that is defined in the fuel cell stack 322 at the higher temperature than that of the refrigerant at the low pressure and at the lower temperature that is received at the inlet port 360 of the cooling chamber 310 that is defined in the fuel cell stack 322. The refrigerant at low temperature submerges and is in direct contact with the at least one fuel cell that is positioned within the cooling chamber 310 defined in the fuel cell stack 322.

In an exemplary embodiment, at least one inner wall of the cooling chamber 310 that is defined in the fuel cell stack 322 may be manufactured from a material that can withstand pressurized corrosive refrigerant at low temperature. More specifically, as the refrigerant flows along the at least one inner wall of the cooling chamber 310 that is defined in the fuel cell stack 322, the at least one inner wall of the cooling chamber 310 is susceptible to contraction due to the pressurized refrigerant at low temperature, thereby causing deformations to occur in the at least one inner wall of the cooling chamber 310 that is defined in the fuel cell stack 322. Therefore, the at least one inner wall of the cooling chamber 310 that is defined in the fuel cell stack 322 is required to be manufactured from the material that can withstand pressurized refrigerant at low temperature to ensure that the cooling chamber 310 does not contract and break down, thereby causing leakage of the pressurized refrigerant from the cooling chamber 310 that is defined in the fuel cell stack 322 to the external environment. In an exemplary embodiment, the at least one inner wall of the cooling chamber 310 defined in the fuel cell stack 322 may be manufactured from but is not limited to a steel material, an aluminum material, a pressure resistant glass material, a pressure resistant plastic material, a pressure resistant polymer material, an acrylic material, PVC, PTFE, and a pressure resistant ceramic material. Moreover, the at least one inner wall of the cooling chamber 310 defined in the fuel cell stack 322 may be coated with a leak resistant material to ensure containment of substantially liquid/gaseous refrigerant within the cooling chamber 310 defined in the fuel cell stack 322 itself without being discharged to the external environment. In an exemplary embodiment, the outlet port 366 of the cooling chamber 310 defined in the fuel cell stack 322 is in flow communication with the inlet port 381 of the compressor 320 such that the refrigerant at high temperature that flows from the outlet port 366 of the cooling chamber 310 defined in the fuel cell stack 322 is channeled to the inlet port 381 of the compressor 320.

Therefore, in this embodiment of the invention, the refrigerant is channeled through the inlet port 381 of the compressor 320 where refrigerant is compressed from low pressure to high pressure with a corresponding large increase in temperature of the refrigerant. Refrigerant is channeled from the outlet port 382 of the compressor 320 to the inlet port 385 of the bypass valve 350. Refrigerant is then channeled from the outlet port 332 of the bypass valve 350 to the inlet port 331 of the condenser 330 where heat is discharged from the refrigerant in the condenser 330, thereby decreasing the temperature of the refrigerant from higher temperature to lower temperature and bypassing the bypass flow path 334. Refrigerant is channeled from the outlet port 384 of the condenser 330 to the inlet port 383 of the expansion valve 340 where the pressure of the refrigerant is substantially decreased from high pressure to low pressure, and a speed of the refrigerant is substantially increased from low speed to high speed. In addition, the temperature of the refrigerant is substantially decreased from higher temperature to lower temperature as refrigerant flows through the expansion valve 340. Refrigerant in the substantially liquid state at low temperature and at low pressure is channeled from the outlet port 365 of the expansion valve 340 through the fuel cell stack 322 containing at least one fuel cell that requires to be cooled from higher temperature to lower temperature that is within its acceptable operating design temperature limits. From the outlet port 366 of the cooling chamber 310 defined in the fuel cell stack 322, refrigerant at high temperature after absorbing heat from the at least one fuel cell is channeled back to the inlet port 381 of the compressor 320, and the cycle is repeated. It may be noted that in this embodiment of the invention, refrigerant may not be channeled through the bypass flow path 334 from the bypass valve 350 via an inlet port 333 of the bypass flow path 334. Rather, the refrigerant is channeled directly from the pressure regulator of the compressor 320 to the condenser 330 via the outlet port 332 of the bypass valve 350 for cooling the refrigerant in the condenser 330, and subsequently delivered at high pressure and at lower temperature than the temperature at its inlet port 331 to the expansion valve 340.

In an exemplary embodiment, the cooling fan 390 is positioned proximate to the condenser 330. More specifically, the cooling fan 390 that is positioned proximate to the condenser 330 receives electric power from but is not limited to the fuel cell stack 322 and an electric battery. In an alternate exemplary embodiment, the cooling fan 390 that is positioned proximate to the condenser 330 receives electric power from an external power source such as but not limited to a wall mounted electric socket. The operation of the cooling fan 390 causes a rotation of a plurality of fan blades 393 that are coupled to the cooling fan 390 that is positioned proximate to the condenser 330 and delivers a stream of high-speed cooling air to the condenser 330 to cool the gaseous refrigerant that is received in the condenser 330 from the bypass valve 350 via the first outlet port 332 of the bypass valve 350. More specifically, the condenser 330 is positioned in an air flow path of the cooling fan 390 that is positioned proximate to the condenser 330 and receives the stream of high-speed cooling air that is discharged from the cooling fan 390 and that impinges on the outer surface of the condenser 330. The stream of high-speed cooling air that is discharged from the cooling fan 390 that is positioned proximate to the condenser 330 and that impinges on the outer surface of the condenser 330 facilitates withdrawal of heat away from the condenser 330 to the external environment by convection, thereby cooling the gaseous refrigerant that is channeled to the inlet port 331 of the condenser 330 from the bypass valve 350 via the outlet port 332 of the bypass valve 350, and that flows through the condenser 330. Therefore, the cooling fan 390 facilitates discharging heat from the gaseous refrigerant that flows through the condenser 330. More specifically, the heat that was absorbed by the refrigerant from the fuel cell stack 322 and the heat that was absorbed by the refrigerant from the compressor 320 due to compression of the gaseous refrigerant in the compressor 320 is substantially discharged in the condenser 330 due to the stream of high-speed cooling air that flows from the cooling fan 390 and that impinges on the outer surface of the condenser 330, thereby withdrawing the heat away from the refrigerant and decreasing the temperature of the gaseous refrigerant that flows through the condenser 330 substantially. Therefore, at the outlet port 384 of the condenser 330, substantially gaseous refrigerant at high pressure and at lower temperature than the higher temperature gaseous refrigerant at the inlet port 331 of the condenser 330 is channeled to the next stage (i.e. to the inlet port 383 of the expansion valve 340) of the thermal management system 300 for the fuel cell stack 322.

The cooling fan 390 may be mechanically secured to any substrate and positioned in a manner such that the cooling fan 390 is positioned proximate to the condenser 330 and delivers the stream of high-speed cooling air to the outer surface of the condenser 330. In an alternate exemplary embodiment, a plurality of fins may be secured to the outer surface of the condenser 330 and receives heat from the outer surface of the condenser 330. The heat that is received by the plurality of fins from the outer surface of the condenser 330 decreases a temperature of the refrigerant that flows through the condenser 330, thereby causing heat from the gaseous refrigerant that flows through the condenser 330 to be discharged to the external environment and substantially cooling the gaseous refrigerant that flows through the condenser 330. In an exemplary embodiment, the condenser 330 is in flow communication with the outlet port 332 of the bypass valve 350 and receives gaseous refrigerant at high pressure and at high temperature within the condenser 330 via the inlet port 331 of the condenser 330.

The refrigerant that flows through the thermal management system 300 for the fuel cell stack 322 to cool the fuel cell stack 322 that houses the at least one fuel cell therein is of a specific heat absorption capacity/unit mass of the refrigerant that is lesser in contrast to the greater specific heat absorption capacity/unit mass of liquid coolant. In addition, due to the lower specific heat absorption capacity/unit mass of the refrigerant in contrast to the higher specific heat absorption capacity/unit mass of the liquid coolant, the heat absorption rate/unit mass of the refrigerant is greater than the heat absorption rate/unit mass of the liquid coolant. Therefore, since the specific heat absorption capacity/unit mass of the refrigerant that flows through the cooling chamber 310 defined in the fuel cell stack 322 is lesser in contrast to the greater specific heat absorption capacity/unit mass of liquid coolant, and that the heat absorption rate/unit mass of the refrigerant is greater than the heat absorption rate/unit mass of the liquid coolant, a lower mass flow rate of liquid refrigerant is required to be channeled through the cooling chamber 310 that is defined in the fuel cell stack 322 than that of liquid coolant. More specifically, the lower mass flow rate of liquid refrigerant is required to be channeled through the cooling chamber 310 that is defined in the fuel cell stack 322 to decrease the first temperature of the fuel cell stack 322 and consequently the at least one fuel cell that is positioned within the fuel cell stack 322 to the second temperature in contrast to the higher mass flow rate of liquid coolant that is required to be channeled through the cooling chamber 310 that is defined in the fuel cell stack 322 to decrease the first temperature of the fuel cell stack 322 and consequently the at least one fuel cell that is positioned within the fuel cell stack 322 to the second temperature. Therefore, in order to decrease the temperature of the fuel cell stack 322 and therefore the at least one fuel cell that is submerged and in direct contact with the refrigerant from the first temperature to the second temperature, a lower mass flow rate of substantially liquid refrigerant is required to be channeled through the cooling chamber 310 that is defined in the fuel cell stack 322 to decrease the first temperature of the fuel cell stack 322 and consequently the at least one fuel cell to the second temperature in contrast to the higher mass flow rate of liquid coolant that is required to be channeled through the cooling chamber 310 that is defined in the fuel cell stack 322 to decrease the first temperature of the fuel cell stack 322 and consequently the at least one fuel cell that is positioned within the fuel cell stack 322 to the second temperature. The low specific heat absorption capacity/unit mass of the liquid refrigerant and its high heat absorption rate implies that a low mass flow rate of liquid refrigerant that is channeled through the cooling chamber 310 is sufficient to absorb a substantially same amount of heat from the fuel cell stack 322 and therefore the at least one fuel cell that is positioned within the fuel cell stack 322 as that of a high mass flow rate of liquid coolant that has a comparatively high specific heat absorption capacity/unit mass of the liquid coolant as well as its low heat absorption rate to decrease the first temperature of the fuel cell stack 322 and consequently the at least one fuel cell to the second temperature. In addition, owing to the lower specific heat absorption capacity/unit mass of the refrigerant in contrast to the higher specific heat absorption capacity/unit mass of the liquid coolant, the heat absorption rate/unit mass of the refrigerant is greater than the heat absorption rate/unit mass of the liquid coolant. Therefore, direct refrigerant-based cooling methodology for the at least one fuel cell that is positioned within the fuel cell stack 322 and that requires to be cooled is a much better alternative than liquid coolant based cooling methodology for the at least one fuel cell that is positioned within the fuel cell stack 322. Therefore, direct refrigerant-based cooling by means of the refrigerant for cooling the fuel cell stack 222 and consequently the at least one fuel cell that is positioned within the fuel cell stack 222 is a much better alternative than the liquid coolant-based cooling methodology.

In another exemplary embodiment, the electronic control unit 312 is adapted to control the cooling fan 390 that delivers the stream of high-speed cooling air to the outer surface of the condenser 330 to cool the refrigerant that is received in the condenser 330 from the outlet port 332 of the bypass valve 350 via the control flow path 301 that is in electronic communication between the cooling fan 390 and the electronic control unit 312. More specifically, the electronic control unit 312 is adapted to control an operating speed of the cooling fan 390 to control a mass flow rate of high-speed cooling air that is delivered from the cooling fan 390 to the condenser 330 to cool the refrigerant that is received in the condenser 330 to its acceptable operating design temperature limits. In a further exemplary embodiment, the electronic control unit 312 is adapted to control the flow of refrigerant from the expansion valve 340 to the inlet port 360 of the cooling chamber 310 that is defined in the fuel cell stack 322 via the control flow path 371 that is in electronic communication between the expansion valve 340 and the electronic control unit 312. More specifically, the electronic control unit 312 controls a mass flow rate of refrigerant that is channeled through the outlet port 365 of the expansion valve 340 to the inlet port 360 of the cooling chamber 310 that is defined in the fuel cell stack 322. In yet another exemplary embodiment, the electronic control unit 312 is adapted to control a delivery pressure of the compressor 320 for delivering pressurized refrigerant at high temperature to the bypass valve 350 via the control flow path 373 that is in electronic communication between the pressure regulator (not shown) of the compressor 320 and the electronic control unit 312. More specifically, the electronic control unit 312 controls a delivery pressure of the refrigerant that is channeled from the outlet port 382 of the pressure regulator that is in flow communication with the compressor 320 to the bypass valve 350 based on a pressure requirement of refrigerant in the fuel cell stack 322 during each cycle of operation of the fuel cell stack 322 by controlling an opening percentage of the pressure regulator. The pressure requirement of refrigerant during each cycle of operation of the thermal management system 300 is determined by the electronic control unit 312 from at least one pressure sensor (not shown) that is in electronic communication between the electronic control unit 312 and the fuel cell stack 322 via a control flow path.

In another exemplary embodiment, the electronic control unit 312 is adapted to receive a temperature signal that comprises an operating temperature of the at least one fuel cell that is positioned within the fuel cell stack 322 from the temperature sensor 306 that is in thermal communication with the at least one fuel cell that is positioned within the fuel cell stack 322 via the control flow path 305 that is in electronic communication between the temperature sensor 306 and the electronic control unit 312. More specifically, the electronic control unit 312 controls the quantity of refrigerant that is channeled through the outlet port 365 of the expansion valve 340 to the inlet port 360 of the cooling chamber 310 that is defined in the fuel cell stack 322 by controlling an opening percentage/opening of the outlet port 365 of the expansion valve 340 based on the temperature signal that is received by the electronic control unit 312 from the temperature sensor 306 via the control flow path 305. If the temperature of the at least one fuel cell that is positioned within the fuel cell stack 322 is greater than the threshold temperature that is pre-defined by the user, the electronic control unit 312 controls the opening percentage by the required value/opening of the outlet port 365 of the expansion valve 340 to channel low temperature refrigerant from the outlet port 365 of the expansion valve 340 to the inlet port 360 of the cooling chamber 310 that is defined in the fuel cell stack 322.

The refrigerant that flows past the at least one fuel cell that is positioned against the cooling chamber 310 defined in the fuel cell stack 322 cools the fuel cell stack 322 as well as the at least one fuel cell that is positioned against the cooling chamber 310 defined in the fuel cell stack 322. The cooling of the fuel cell stack 322 and consequently the at least one fuel cell that is positioned against the cooling chamber 310 defined in the fuel cell stack 322 decreases the temperature of the fuel cell stack 322 as well as the at least one fuel cell that is positioned against the cooling chamber 310 defined in the fuel cell stack 322 respectively. Therefore, the fuel cell stack 322 and the at least one fuel cell that is positioned against the cooling chamber 310 defined in the fuel cell stack 322 are maintained within their respective acceptable operating design temperature limits, thereby enhancing a longevity and useful life of the at least one fuel cell that is positioned within the cooling chamber 310 defined in the fuel cell stack 322. After liquid refrigerant is channeled through the cooling chamber 310, the fuel cell stack 322 and the at least one fuel cell that is positioned within the cooling chamber 310 defined in the fuel cell stack 322 may be cooled to different operating temperatures, but still be within the acceptable operating design temperature limits of the fuel cell stack 322, as well as the acceptable operating design temperature limits of the at least one fuel cell that is positioned within the cooling chamber 310 defined in the fuel cell stack 322 respectively.

A working of the thermal management system 300 for the fuel cell stack 322 is described as an example. In an exemplary embodiment, the refrigerant in the liquid state at low temperature is received at the inlet port 360 of the cooling chamber 310 that is defined in the fuel cell stack 322 that contains at least one fuel cell that is positioned against the cooling chamber 310 defined in the fuel cell stack 322. In an exemplary embodiment, once the refrigerant is received at the inlet port 360 of the cooling chamber 310 that is defined in the fuel cell stack 322, the refrigerant flows through the cooling chamber 310 and submerges and is in direct contact with the at least one fuel cell that is positioned against the cooling chamber 310 of the fuel cell stack 322. Within the cooling chamber 310, at least one fuel cell is positioned therein and discharges heat to the refrigerant that is channeled through the cooling chamber 310 that is defined in the fuel cell stack 322 via its inlet port 360. The cooling chamber 310 is in flow communication with the outlet port 366 that channels refrigerant that flows through the cooling chamber 310. In an exemplary embodiment, liquid refrigerant at low temperature is channeled to the cooling chamber 310 of the fuel cell stack 322 that contains at least one fuel cell at high temperature that is positioned within the cooling chamber 310 defined in the fuel cell stack 322 to cool the at least one fuel cell that is positioned within the cooling chamber 310 defined in the fuel cell stack 322 by submerging and being in direct physical contact with the at least one fuel cell. Therein, the heat is discharged by the at least one fuel cell to the liquid refrigerant by convection as refrigerant flows from the inlet port 360 of the cooling chamber 310 to the outlet port 366 of the cooling chamber 310 that are each defined in the fuel cell stack 322 via the cooling chamber 310.

Once the liquid refrigerant at low temperature is channeled within the cooling chamber 310 via the inlet port 360 of the cooling chamber 310 that is defined in the fuel cell stack 322, the liquid refrigerant at low temperature is allowed to flow through the cooling chamber 310 that is defined in the fuel cell stack 322 to facilitate cooling the at least one fuel cell at high temperature that is positioned within the cooling chamber 310 defined in the fuel cell stack 322 and is submerged and in direct contact with the refrigerant. More specifically, once the liquid refrigerant at low temperature flows through the inlet port 360 of the cooling chamber 310 defined in the fuel cell stack 322 to cool the at least one fuel cell at high temperature that is positioned within the cooling chamber 310 defined in the fuel cell stack 322 and is submerged and in direct contact with the refrigerant, the refrigerant is channeled through the cooling chamber 310 and is subsequently channeled through the outlet port 366 of the cooling chamber 310 that is in flow communication with the cooling chamber 310. The flow of refrigerant through the cooling chamber 310, and subsequently through the outlet port 366 of the cooling chamber 310 that is defined in the fuel cell stack 322 that includes at least one fuel cell at high temperature that is positioned within the cooling chamber 310 and is submerged and in direct contact with the refrigerant facilitates cooling the fuel cell stack 322 that contains at least one fuel cell at high temperature that is positioned within the cooling chamber 310 defined in the fuel cell stack 322. In addition, the at least one fuel cell at high temperature that is positioned within the cooling chamber 310 that is defined in the fuel cell stack 322 and is submerged and in direct contact with the refrigerant that flows through the cooling chamber 310 that is defined in the fuel cell stack 322 is also cooled from high temperature to the temperature that is within its acceptable operating design temperature limits. Therefore, an overall longevity of the fuel cell stack 322, useful life of the fuel cell stack 322, as well as mileage (overall efficiency)/unit quantity of hydrogen gas obtained from the fuel cell stack 322 may be substantially increased. In addition, an operational efficiency of the fuel cell stack 322 may be substantially increased due to the direct cooling of the at least one fuel cell by the refrigerant that submerges and is in direct contact with the at least one fuel cell.

More specifically, as the liquid refrigerant at low temperature flows through the cooling chamber 310 via its inlet port 360, and subsequently through the outlet port 366 of the cooling chamber 310 via the cooling chamber 310, the liquid refrigerant at low temperature absorbs heat from the at least one fuel cell at high temperature that is positioned within the cooling chamber 310 that is defined in the fuel cell stack 322 and is submerged and in direct contact with the refrigerant. The refrigerant gets heated due to transfer of heat from the at least one fuel cell at high temperature that is positioned within the cooling chamber 310 that is defined in the fuel cell stack 322 to the refrigerant by convection. More specifically, the liquid refrigerant at low temperature gets heated due to the transfer of heat from the at least one fuel cell at high temperature that is positioned within the cooling chamber 310 defined in the fuel cell stack 322 and is submerged and in direct contact with the refrigerant to the liquid refrigerant at low temperature that flows through the inlet port 360 of the cooling chamber 310 that is defined in the fuel cell stack 322 by convection. The absorption of heat by the liquid refrigerant at low temperature from the at least one fuel cell at high temperature that is positioned within the cooling chamber 310 defined in the fuel cell stack 322 and is submerged and in direct contact with the refrigerant changes the phase of the refrigerant from the liquid phase to the gaseous phase as refrigerant flows through the cooling chamber 310 via its inlet port 360 to the outlet port 366 of the cooling chamber 310 respectively. Therefore, when the liquid refrigerant at low temperature flows through the inlet port 360 of the cooling chamber 310 that is defined in the fuel cell stack 322, the liquid refrigerant is at low temperature and at low pressure. However, as the liquid refrigerant absorbs heat from the at least one fuel cell at high temperature that is positioned within the cooling chamber 310 defined in the fuel cell stack 322, the gaseous refrigerant that flows from the outlet port 366 of the cooling chamber 310 that is defined in the fuel cell stack 322 is at higher temperature and at low pressure than the lower temperature refrigerant at the inlet port 360 of the cooling chamber 310 that is defined in the fuel cell stack 322. As heat flows from the at least one fuel cell at high temperature that is positioned within the cooling chamber 310 defined in the fuel cell stack 322 and is submerged and in direct contact with the refrigerant to the refrigerant that flows through the inlet port 360 of the cooling chamber 310, via the cooling chamber 310, and through the outlet port 366 of the cooling chamber 310, the at least one fuel cell is substantially cooled from the higher temperature to the lower temperature and attains a temperature that is within its acceptable operating design temperature limits. The refrigerant that flows from the outlet port 366 of the cooling chamber 310 that is defined in the fuel cell stack 322 is subsequently channeled to the inlet port 381 of the compressor 320 for compression.

The refrigerant that flows from the outlet port 366 of the cooling chamber 310 that is defined in the fuel cell stack 322 that is in the gaseous state at high temperature and at low pressure is channeled to the inlet port 381 of the compressor 320. Once the gaseous refrigerant is received in the compressor 320 via its inlet port 381, the gaseous refrigerant is compressed in the compressor 320 from a pressure at the outlet port 366 of the cooling chamber 310 that is defined in the fuel cell stack 322 to a higher pressure that is required for the refrigerant to be circulated through the thermal management system 300 for the fuel cell stack 322. Therefore, as the gaseous refrigerant at high temperature and at low pressure flows through the compressor 320 via its inlet port 381, the compressor 320 increases the pressure of the refrigerant from the lower pressure to the higher pressure with a corresponding large increase in temperature of the refrigerant. Therefore, at the outlet port 382 of the compressor 320, the gaseous refrigerant is at a higher temperature than the gaseous refrigerant that is channeled to the inlet port 381 of the compressor 320 from the outlet port 366 of the cooling chamber 310 that is defined in the fuel cell stack 322, and at a higher pressure than the gaseous refrigerant that is channeled to the inlet port 381 of the compressor 320 from the outlet port 366 of the cooling chamber 310 that is defined in the fuel cell stack 322.

The refrigerant at the outlet port 382 of the compressor 320 that is in the gaseous state at high temperature and at high pressure is channeled through the pressure regulator of the compressor 320 to the inlet port 331 of the condenser 330 via the bypass valve 350. Once the gaseous refrigerant is received in the condenser 330 via its inlet port 331, heat that is present within the gaseous refrigerant that was absorbed by the refrigerant that was channeled through the cooling chamber 310 that is defined in the fuel cell stack 322 from the at least one fuel cell that is positioned within the cooling chamber 310 that is defined in the fuel cell stack 322, and the heat that was absorbed by the refrigerant in the compressor 320 while the gaseous refrigerant was compressed in the compressor 320 is substantially discharged in the condenser 330. More specifically, the cooling fan 390 that is positioned proximate to the condenser 330 receives electric power from the fuel cell stack 322 that in turn receives electrical energy from the external power source such as but not limited to the electric battery and the wall mounted electric socket. Alternatively, the cooling fan 390 that is positioned proximate to the condenser 330 receives electrical energy from the electric power source such as but not limited to the electric battery and the wall mounted electric socket. Therein, the cooling fan 390 that is positioned proximate to the condenser 330 rotates, thereby channeling high-speed cooling air to the outer surface of the condenser 330. The high-speed cooling air from the cooling fan 390 that impinges on the outer surface of the condenser 330 withdraws heat away from the gaseous refrigerant that flows through the plurality of coiled channels 304 that are each defined in the condenser 330. More specifically, the plurality of coiled channels 304 are in flow communication with the inlet port 331 of the condenser 330 at its one end and in flow communication with the outlet port 384 of the condenser 330 at its opposite second end and channels gaseous refrigerant through the condenser 330 in order to discharge heat from the gaseous refrigerant that flows through the condenser 330. The coiled nature of the plurality of coiled channels 304 increases a length of travel of the gaseous refrigerant as refrigerant flows along a longitudinal length of the condenser 330, thereby facilitating discharging heat from the gaseous refrigerant in the condenser 330 effectively. Due to heat from the gaseous refrigerant that is channeled away from the condenser 330 by the high-speed cooling air that is discharged by the cooling fan 390 and that impinges on the outer surface of the condenser 330, the temperature of the refrigerant that flows through the plurality of coiled channels 304 defined in the condenser 330 from the inlet port 331 of the condenser 330 to the outlet port 384 of the condenser 330 is decreased substantially from the higher temperature of the refrigerant at the inlet port 331 of the condenser 330 to a lower temperature of the refrigerant that flows through the outlet port 384 of the condenser 330. While the temperature of the refrigerant decreases substantially from the higher temperature at the outlet port 382 of the compressor 320 to the lower temperature as the refrigerant flows through the plurality of coiled channels 304 that are defined in the condenser 330, the pressure of the refrigerant as refrigerant flows through the plurality of coiled channels 304 that are defined in the condenser 330 remains steady or decreases to a slightly lower pressure from the high pressure gaseous refrigerant that is channeled from the outlet port 382 of the compressor 320 to the inlet port 331 of the condenser 330 via the bypass valve 350. Therefore, at the outlet port 384 of the condenser 330, the gaseous refrigerant is at a relatively much lower temperature than the temperature of the gaseous refrigerant that is channeled to the inlet port 331 of the condenser 330 from the outlet port 382 of the compressor 320, and at a substantially same pressure or slightly lower pressure than the pressure of the gaseous refrigerant that is channeled to the inlet port 331 of the condenser 330 from the outlet port 382 of the compressor 320 via the outlet port 332 of the bypass valve 350.

The refrigerant at the outlet port 384 of the condenser 330 that is in the gaseous state at low temperature and at high pressure is channeled to the inlet port 383 of the expansion valve 340. The expansion valve 340 is in flow communication with the outlet port 384 of the condenser 330 at its inlet port 383 and receives refrigerant that flows from the condenser 330 via the outlet port 384 of the condenser 330. Once the refrigerant is received at the inlet port 383 of the expansion valve 340 in the substantially gaseous state, the expansion valve 340 throttles the gaseous refrigerant, thereby decreasing the pressure of the refrigerant that flows from the outlet port 384 of the condenser 330 to a much lower pressure that flows from the outlet port 365 of the expansion valve 340. Due to the substantial decrease in the pressure of the refrigerant due to the throttling action of the expansion valve 340, the temperature of the refrigerant is decreased from the low temperature at the inlet port 383 of the expansion valve 340 to a relatively much lower temperature that flows from the outlet port 365 of the expansion valve 340. The expansion valve 340 is in flow communication with the inlet port 360 of the cooling chamber 310 that is defined in the fuel cell stack 322 at its outlet port 365. The expansion valve 340 controls a flow of refrigerant that flows through the outlet port 384 of the condenser 330 to the inlet port 360 of the cooling chamber 310 that is defined in the fuel cell stack 322, wherein the expansion valve 340 is electronically controlled by means of the electronic control unit 312 that is in electronic communication with the expansion valve 340 via the control flow path 371. More specifically, the electronic control unit 312 controls the opening percentage/opening of the expansion valve 340 to facilitate regulating a required mass flow rate of the refrigerant that is to flow from the outlet port 384 of the condenser 330 to the inlet port 360 of the cooling chamber 310 that is defined in the fuel cell stack 322 for the refrigerant to be circulated through the thermal management system 300 for the fuel cell stack 322 via the outlet port 365 of the expansion valve 340.

As the pressure and the temperature of the refrigerant decreases from higher pressure and lower temperature at the outlet port 384 of the condenser 330 to lower pressure and much lower temperature that is required for the refrigerant to be circulated through the thermal management system 300 for the fuel cell stack 322, the refrigerant changes its phase to the substantially liquid phase due to the decrease in the temperature of the refrigerant below its phase transition temperature as refrigerant flows through the outlet port 365 of the expansion valve 340 to the inlet port 360 of the cooling chamber 310 defined in the fuel cell stack 322. Moreover, the throttling of the refrigerant that flows through the outlet port 384 of the condenser 330 to the inlet port 360 of the cooling chamber 310 that is defined in the fuel cell stack 322 via the outlet port 365 of the expansion valve 340 that is controlled by the electronic control unit 312 via the control flow path 371 permits only the required mass flow rate of refrigerant to be channeled at high-speed through the inlet port 360 of the cooling chamber 310 that is defined in the fuel cell stack 322. Therefore, at the outlet port 365 of the expansion valve 340, substantially liquid refrigerant is at lower pressure than the pressure of the refrigerant that is channeled to the inlet port 383 of the expansion valve 340 from the outlet port 384 of the condenser 330 and is at lower temperature than the temperature of the refrigerant that is channeled to the inlet port 383 of the expansion valve 340 from the outlet port 384 of the condenser 330.

In an exemplary embodiment, the inlet port 360 of the cooling chamber 310 defined in the fuel cell stack 322 is in flow communication with the outlet port 365 of the expansion valve 340 and receives high-speed liquid refrigerant at low pressure and at low temperature therein. The outlet port 365 of the expansion valve 340 may be opened by varying opening percentages by the electronic control unit 312 to channel liquid refrigerant at different operating temperatures and at different operating pressures through the cooling chamber 310 defined in the fuel cell stack 322 respectively. After the refrigerant in the substantially liquid state at low pressure and at low temperature is channeled to the inlet port 360 of the cooling chamber 310 that is defined in the fuel cell stack 322, the cycle is repeated with the flow of liquid refrigerant through the cooling chamber 310 defined in the fuel cell stack 322 to cool the at least one fuel cell that is positioned within the cooling chamber 310 that is defined in the fuel cell stack 322.

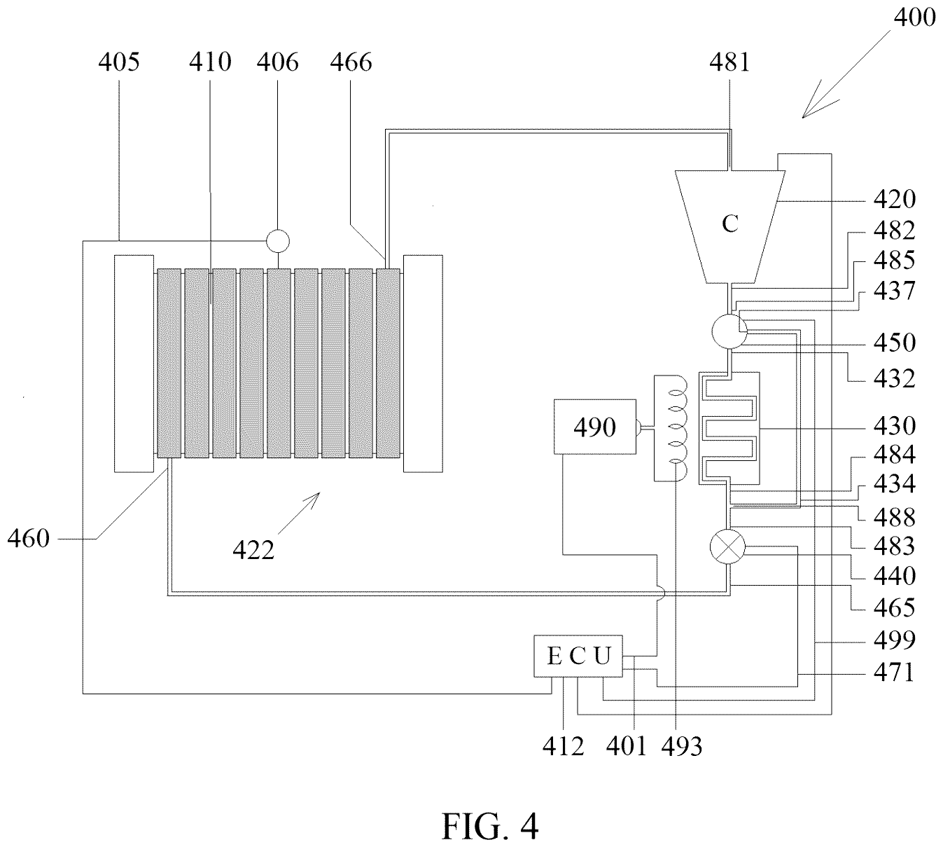

FIG. 4 is a schematic representation of the thermal management system 400 for increasing a temperature of the fuel cell stack 422 comprising the at least one heating channel 410 defined in the fuel cell stack 422 that is in flow communication with the compressor 420, the condenser 430, and the expansion valve 440 in another embodiment of the invention. While the at least one heating channel 410 is not explicitly shown in the FIG. 4, it must be construed by the reader that the at least one heating channel 410 defined in the fuel cell stack 422 is contained in the housing of the fuel cell stack 422 and receives the refrigerant therein. The thermal management system 400 for increasing the temperature of the fuel cell stack 422 comprising the at least one heating channel 410 defined in the fuel cell stack 422 that is in flow communication with the compressor 420, the condenser 430, and the expansion valve 440 that is depicted in FIG. 4 is similar to the thermal management system 200 for decreasing the temperature of the fuel cell stack 222 comprising the at least one cooling channel 210 defined in the fuel cell stack 222 that is in flow communication with the compressor 220, the condenser 230, and the expansion valve 240 that is depicted in FIG. 2. The differences between the thermal management system 400 that is depicted in FIG. 4 and the thermal management system 200 that is depicted in FIG. 2 are described below.

In the embodiment of the invention that is depicted in FIG. 4, it is required to heat the at least one fuel cell that is positioned against the at least one heating channel 410 that is defined in the fuel cell stack 422 during cold operating conditions of the fuel cell stack 422. The electronic control unit 412 is in electronic communication with the bypass valve 450 via the control flow path 499. When the at least one fuel cell positioned within the fuel cell stack 222 that is depicted in FIG. 2 is required to be cooled, the refrigerant that flows through the outlet port 282 of the compressor 220 is channeled through the condenser 230 via the bypass valve 250 to cool the refrigerant. The cooled refrigerant from the outlet port 284 of the condenser 230 is subsequently channeled through the inlet port 260 of the at least one cooling channel 210 that is defined in the fuel cell stack 222 via the outlet port 265 of the expansion valve 240. However, when it is required to heat the at least one fuel cell that is positioned within the fuel cell stack 422 as is required in the present embodiment of the invention that is shown in FIG. 4, the electronic control unit 412 opens the outlet port 437 of the bypass valve 450 that is in flow communication with the bypass flow path 434 and closes the outlet port 432 of the bypass valve 450 that is in flow communication with the condenser 430. Therein, refrigerant at high temperature from the outlet port 482 of the compressor 420 is channeled through the bypass flow path 434 via the outlet port 437 of the bypass valve 450 and delivered to the inlet port 483 of the expansion valve 440 by bypassing the condenser 430. Therefore, the gaseous refrigerant at high temperature and at high pressure from the outlet port 482 of the compressor 420 is not cooled within the condenser 430. Rather, the gaseous refrigerant at high temperature and at high pressure that flows through the bypass flow path 434 to the inlet port 483 of the expansion valve 440 heats the at least one fuel cell that is positioned against the at least one heating channel 410 defined in the fuel cell stack 422 during cold operating conditions of the fuel cell stack 422. In an exemplary embodiment, the at least one fuel cell may be positioned directly against the at least one heating channel 410 and receives heat by conduction. In an alternate exemplary embodiment, the at least one fuel cell may be positioned indirectly against the at least one heating channel 410 by positioning the at least one heating channel 410 against the housing of the fuel cell stack 422. The housing of the fuel cell stack 422 that receives heat from the refrigerant flowing through the at least one heating channel 410 that is positioned against the housing of the fuel cell stack 422 transmits this heat to the at least one fuel cell that is in mechanical contact with the housing of the fuel cell stack 422 by conduction.

In an alternate exemplary embodiment, when it is required to heat the at least one fuel cell that is positioned within the heating chamber 410 of the fuel cell stack 422 as is required in the present embodiment of the invention, the electronic control unit 412 opens the outlet port 432 of the bypass valve 450 that is in flow communication with the condenser 430 and closes the outlet port 437 of the bypass valve 450 that is in flow communication with the bypass flow path 434. Therein, refrigerant at high temperature from the outlet port 482 of the compressor 420 is channeled through the condenser 430 via the outlet port 432 of the bypass valve 450 and subsequently delivered to the inlet port 483 of the expansion valve 440 by bypassing the bypass flow path 434. When it is required to heat the refrigerant that flows through the condenser 430 from the outlet port 432 of the bypass valve 450, the electronic control unit 412 transmits an electronic signal to the heater 490 that is in thermal communication with the condenser 430 via the control flow path 401. More specifically, when the electronic control unit 412 transmits the electronic signal to the heater 490 via the control flow path 401, a plurality of heating coils 493 of the heater 490 that are in thermal communication with the condenser 430 are activated which consequently raises its temperature. Once the temperature of the plurality of heating coils 493 of the heater 490 that are in thermal communication with the condenser 430 are increased, heat is transferred from the plurality of heating coils 493 of the heater 490 to the condenser 430 via the outer surface of the condenser 430. More specifically, the heat is transferred from the plurality of heating coils 493 of the heater 490 to the high temperature refrigerant that flows through the condenser 430 from the outlet port 432 of the bypass valve 450 by convection. Therefore, the temperature of the gaseous refrigerant that flows from the outlet port 482 of the compressor 420 and is channeled to the condenser 430 via the outlet port 432 of the bypass valve 450 is further increased substantially in the condenser 430 due to the transfer of heat from the plurality of heating coils 493 of the heater 490 to the high temperature refrigerant that flows through the condenser 430 by convection. Consequently, the refrigerant that flows through the outlet port 484 of the condenser 430 is at a much higher temperature than the refrigerant that flows through the outlet port 432 of the bypass valve 450 and at a substantially same or slightly higher pressure. This higher temperature refrigerant that flows through the outlet port 484 of the condenser 430 than the lower temperature refrigerant that flows through the outlet port 432 of the bypass valve 450 by bypassing the bypass flow path 434 is channeled to the inlet port 483 of the expansion valve 440. The gaseous refrigerant at high temperature and at high pressure that flows through the condenser 430 and is heated to the high temperature in the condenser 430 by means of the plurality of heating coils 493 and that flows to the inlet port 483 of the expansion valve 440 subsequently heats the at least one fuel cell that is positioned against the at least one heating channel 410 defined in the fuel cell stack 422 during cold operating conditions of the fuel cell stack 422.

When it is required to heat the at least one fuel cell that is positioned against the at least one heating channel 410 defined in the fuel cell stack 422 during cold operating conditions of the fuel cell stack 422, the gaseous refrigerant at high temperature that flows from the outlet port 465 of the expansion valve 440 is channeled to the inlet port 460 of the at least one heating channel 410 that is defined in the fuel cell stack 422. More specifically, when the temperature sensor 406 that is in thermal communication with the at least one fuel cell that is positioned within the fuel cell stack 422 senses that the temperature of the at least one fuel cell positioned within the fuel cell stack 422 is below the threshold temperature that is pre-defined by the user and requires to be heated to the temperature that is within its acceptable operating design temperature limits in order to increase the operating efficiency of the fuel cell stack 422, the temperature sensor 406 transmits an electronic signal to the electronic control unit 412 via the control flow path 405 indicating that the temperature of the at least one fuel cell positioned within the fuel cell stack 422 is below the threshold temperature that is pre-determined by the user. Thereby, gaseous refrigerant at high temperature from the outlet port 465 of the expansion valve 440 after being substantially heated in the condenser 430/flowing through the bypass flow path 434 is channeled to the inlet port 460 of the at least one heating channel 410 that is defined in the fuel cell stack 422.

A working of the thermal management system 400 for the fuel cell stack 422 is described as an example. The gaseous refrigerant at high temperature that flows from the outlet port 465 of the expansion valve 440 is channeled to the inlet port 460 of the at least one heating channel 410 that is defined in the fuel cell stack 422. When it is required to heat the at least one fuel cell that is positioned against the at least one heating channel 410 that is defined in the fuel cell stack 422 during cold operating temperature conditions of the fuel cell stack 422, the gaseous refrigerant at high temperature that flows from the outlet port 465 of the expansion valve 440 is channeled to the inlet port 460 of the at least one heating channel 410 that is defined in the fuel cell stack 422. More specifically, when the temperature sensor 406 that is in thermal communication with the at least one fuel cell that is positioned against the at least one heating channel 410 that is defined in the fuel cell stack 422 senses that the temperature of the at least one fuel cell positioned within the fuel cell stack 422 is below the user defined temperature and requires to be heated in order to increase the operating efficiency of the fuel cell stack 422, the temperature sensor 406 transmits the electronic signal to the electronic control unit 412 via the control flow path 405 indicating that the temperature of the at least one fuel cell that is positioned against the at least one heating channel 410 defined in the fuel cell stack 422 is below the user defined temperature. Thereby, gaseous refrigerant at high temperature from the outlet port 465 of the expansion valve 440 is channeled to the inlet port 460 of the at least one heating channel 410 that is defined in the fuel cell stack 422.

Gaseous refrigerant at high temperature that is channeled from the outlet port 465 of the expansion valve 440 to the inlet port 460 of the at least one heating channel 410 that is defined in the fuel cell stack 422 heats the at least one fuel cell that is positioned against the at least one heating channel 410 defined in the fuel cell stack 422. Therefore, in the thermal management system 400 for increasing the temperature of the fuel cell stack 422 and consequently the at least one fuel cell that is in flow communication with the compressor 420, the condenser 430, and the expansion valve 440 that is depicted in FIG. 4, the refrigerant from the outlet port 465 of the expansion valve 440 heats the at least one fuel cell that is positioned against the at least one heating channel 410 defined in the fuel cell stack 422.

In an exemplary embodiment, the refrigerant in the gaseous state at high temperature is received at the inlet port 460 of the at least one heating channel 410 that is defined in the fuel cell stack 422 that contains at least one fuel cell at low temperature that is positioned against the at least one heating channel 410 defined in the fuel cell stack 422. In an exemplary embodiment, once the refrigerant is received at the inlet port 460 of the at least one heating channel 410 that is defined in the fuel cell stack 422, the inlet port 460 of the at least one heating channel 410 that is defined in the fuel cell stack 422 channels the refrigerant into the at least one heating channel 410 defined in the fuel cell stack 422 such that the gaseous refrigerant at high temperature is channeled through the at least one heating channel 410. At least one fuel cell is positioned against the at least one heating channel 410 that is defined in the fuel cell stack 422 and absorbs heat from the refrigerant at high temperature that is channeled through the at least one heating channel 410. The at least one heating channel 410 is in flow communication with the outlet port 466 of the at least one heating channel 410 that channels refrigerant that flows through the at least one heating channel 410 therethrough. In an exemplary embodiment, gaseous refrigerant at high temperature is channeled to the fuel cell stack 422 that contains at least one fuel cell at low temperature that is positioned against the at least one heating channel 410 defined in the fuel cell stack 422 and heats the at least one fuel cell that is positioned against the at least one heating channel 410 defined in the fuel cell stack 422.

Once the gaseous refrigerant at high temperature is channeled through the at least one heating channel 410 via the inlet port 460 of the at least one heating channel 410 that is defined in the fuel cell stack 422, the gaseous refrigerant at high temperature is allowed to flow through the at least one heating channel 410 that is defined in the fuel cell stack 422 to heat the at least one fuel cell at low temperature that is positioned against the at least one heating channel 410 defined in the fuel cell stack 422. More specifically, once the gaseous refrigerant at high temperature flows through the inlet port 460 of the at least one heating channel 410 that is defined in the fuel cell stack 422 to heat the at least one fuel cell at low temperature that is positioned against the at least one heating channel 410 defined in the fuel cell stack 422, the refrigerant is channeled through the at least one heating channel 410 until the refrigerant is channeled through the outlet port 466 of the at least one heating channel 410. The flow of refrigerant through the at least one heating channel 410, and through the outlet port 466 of the at least one heating channel 410 that is defined in the fuel cell stack 422 that contains at least one fuel cell at low temperature that is positioned against the at least one heating channel 410 defined in the fuel cell stack 422 heats the fuel cell stack 422 and consequently the at least one fuel cell at low temperature that is positioned against the at least one heating channel 410 defined in the fuel cell stack 422.

More specifically, as the gaseous refrigerant at high temperature flows through the at least one heating channel 410, and through the outlet port 466 of the at least one heating channel 410, the gaseous refrigerant at high temperature discharges heat to the at least one fuel cell at low temperature that is positioned against the at least one heating channel 410 defined in the fuel cell stack 422, and consequently cools down due to transfer of heat from the refrigerant at high temperature to the at least one fuel cell at low temperature that is positioned against the at least one heating channel 410 defined in the fuel cell stack 422. More specifically, the gaseous refrigerant at high temperature cools down due to the transfer of heat from the gaseous refrigerant at high temperature that flows from the inlet port 460 of the at least one heating channel 410 that is defined in the fuel cell stack 422 to the at least one fuel cell at low temperature that is positioned against the at least one heating channel 410 defined in the fuel cell stack 422 by convection. The discharge of heat by the gaseous refrigerant at high temperature to the at least one fuel cell at low temperature that is positioned against the at least one heating channel 410 defined in the fuel cell stack 422 decreases the temperature of the refrigerant from high temperature to the refrigerant at low temperature as refrigerant flows through the at least one heating channel 410 until the outlet port 466 of the at least one heating channel 410. Therefore, when the gaseous refrigerant enters through the inlet port 460 of the at least one heating channel 410, the gaseous refrigerant is at high temperature and at low pressure. However, as the gaseous refrigerant discharges heat to the at least one fuel cell at low temperature that is positioned against the at least one heating channel 410 defined in the fuel cell stack 422 as refrigerant flows through the at least one heating channel 410 until the outlet port 466 of the at least one heating channel 410, the gaseous refrigerant that flows from the outlet port 466 of the at least one heating channel 410 is at a lower temperature than the temperature of the gaseous refrigerant at the inlet port 460 of the at least one heating channel 410 defined in the fuel cell stack 422 and at low pressure. As heat flows from the refrigerant at high temperature that flows through the inlet port 460 of the at least one heating channel 410 defined in the fuel cell stack 422 to the at least one fuel cell at low temperature that is positioned against the at least one heating channel 410 defined in the fuel cell stack 422 until the outlet port 466 of the at least one heating channel 410, and through the outlet port 466 of the at least one heating channel 410 defined in the fuel cell stack 422, the at least one fuel cell at low temperature that is positioned against the at least one heating channel 410 defined in the fuel cell stack 422 is substantially heated from the lower temperature to the higher temperature that is within its acceptable operating design temperature limits. The refrigerant that flows from the outlet port 466 of the at least one heating channel 410 that is defined in the fuel cell stack 422 that contains at least one fuel cell at low temperature that is positioned against the at least one heating channel 410 defined in the fuel cell stack 422 is subsequently channeled to the inlet port 481 of the compressor 420 for compression.

The refrigerant that flows from the outlet port 466 of the at least one heating channel 410 that is defined in the fuel cell stack 422 in the gaseous state at lower temperature than at its inlet port 460 and at low pressure is channeled to the inlet port 481 of the compressor 420. Once the gaseous refrigerant is received in the compressor 420, the gaseous refrigerant is compressed in the compressor 420 from the pressure that is equal to the pressure of the refrigerant at the outlet port 466 of the at least one heating channel 410 that is defined in the fuel cell stack 422 to the higher pressure that is required for the refrigerant to be circulated through the thermal management system 400 for the fuel cell stack 422. Therefore, as the gaseous refrigerant at low temperature and at low pressure flows through the compressor 420 via its inlet port 481, the compressor 420 increases the pressure of the refrigerant from the low pressure to the high pressure with a corresponding large increase in temperature of the refrigerant. Therefore, at the outlet port 482 of the compressor 420, the gaseous refrigerant is at a higher temperature than the gaseous refrigerant that is channeled to the inlet port 481 of the compressor 420 from the outlet port 466 of the at least one heating channel 410 that is defined in the fuel cell stack 422, and at a higher pressure than the gaseous refrigerant that is channeled to the inlet port 481 of the compressor 420 from the outlet port 466 of the at least one heating channel 410 that is defined in the fuel cell stack 422.

The refrigerant at the outlet port 482 of the compressor 420 that is in the gaseous state at high temperature and at high pressure is channeled to the inlet port 485 of the bypass valve 450. Once the gaseous refrigerant is received in the bypass valve 450, the gaseous refrigerant at high temperature and at high pressure is channeled from the outlet port 482 of the compressor 420 through the bypass flow path 434 via the outlet port 437 of the bypass valve 450 by bypassing the condenser 430. More specifically, the outlet port 432 of the bypass valve 450 that is in flow communication with the condenser 430 is closed by the electronic control unit 412 via the control flow path 499. The refrigerant at the outlet port 488 of the bypass flow path 434 that is in the gaseous state at high temperature and at high pressure is channeled to the inlet port 483 of the expansion valve 440. The expansion valve 440 is in flow communication with the outlet port 488 of the bypass flow path 434 at its inlet port 483 and receives refrigerant that flows from the bypass flow path 434 through the outlet port 488 of the bypass flow path 434.

In an alternate exemplary embodiment, once the gaseous refrigerant is received in the bypass valve 450 from the outlet port 482 of the compressor 420, the gaseous refrigerant at high temperature and at high pressure is channeled from the outlet port 482 of the compressor 420 through the condenser 430 via the outlet port 432 of the bypass valve 450 by bypassing the bypass flow path 434. More specifically, the outlet port 437 of the bypass valve 450 that is in flow communication with the bypass flow path 434 is closed by the electronic control unit 412 via the control flow path 499. Therein, the electronic control unit 412 transmits the electronic signal to the heater 490 via the control flow path 401 that is in electronic communication between the electronic control unit 412 and the heater 490. The activation of the heater 490 heats a plurality of heating coils 493 of the heater 490. Therein, the heat from the plurality of heating coils 493 of the heater 490 is transferred via conduction/convection to the condenser 430 that is in thermal communication with the plurality of heating coils 493 of the heater 490. More specifically, the high temperature refrigerant that flows through the outlet port 432 of the bypass valve 450 from the outlet port 482 of the compressor 420 absorbs heat from the plurality of heating coils 493 of the heater 490 via conduction/convection. Due to the absorption of heat by the high temperature refrigerant flowing through the condenser 430 from the plurality of heating coils 493 of the heater 490 by conduction/convection, the temperature of the gaseous refrigerant further increases from a high temperature at the outlet port 432 of the bypass valve 450 to a higher temperature at the outlet port 484 of the condenser 430. This gaseous refrigerant at the outlet port 484 of the condenser 430 that is in the gaseous state at the higher temperature than at the outlet port 432 of the bypass valve 450 and at high pressure is channeled to the inlet port 483 of the expansion valve 440. The expansion valve 440 is in flow communication with the outlet port 484 of the condenser 430 at its inlet port 483 and receives refrigerant that flows from the condenser 430 through the outlet port 484 of the condenser 430 at high temperature.

Once the refrigerant is received at the inlet port 483 of the expansion valve 440 in the substantially gaseous state at high temperature and at high pressure via one of the bypass flow path 434 and the condenser 430 after receiving heat in the condenser 430 from the plurality of heating coils 493 of the heater 490, the expansion valve 440 throttles the gaseous refrigerant, thereby decreasing the pressure of the refrigerant that flows from one of the outlet port 488 of the bypass flow path 434 and the outlet port 484 of the condenser 430 to the lower pressure that flows from the outlet port 465 of the expansion valve 440. Due to the decrease in the pressure of the refrigerant due to the throttling action of the expansion valve 440, the temperature of the refrigerant is decreased from the temperature at the inlet port 483 of the expansion valve 440 to a relatively lower temperature that flows from the outlet port 465 of the expansion valve 440. The expansion valve 440 is electronically controlled by means of the electronic control unit 412 that is in electronic communication with the expansion valve 440 via the control flow path 471. More specifically, the electronic control unit 412 controls the opening percentage/opening of the outlet port 465 of the expansion valve 440 to regulate the required mass flow rate of the refrigerant at high temperature and at low pressure that is to flow from one of the outlet port 488 of the bypass flow path 434 and the outlet port 484 of the condenser 430 to the inlet port 460 of the at least one heating channel 410 that is defined in the fuel cell stack 422 via the outlet port 465 of the expansion valve 440 for the refrigerant to be circulated through the thermal management system 400 for the fuel cell stack 422.

As the pressure and the temperature of the refrigerant decreases from the high pressure and high temperature at one of the outlet port 488 of the bypass flow path 434 and the outlet port 484 of the condenser 430 to low pressure and lower temperature that is required for the refrigerant to be circulated through the thermal management system 400 for the fuel cell stack 422, the refrigerant retains its phase in the gaseous phase because the temperature of the refrigerant does not decrease below its phase transition temperature while flowing through the outlet port 465 of the expansion valve 440. Rather, the refrigerant retains its phase in the gaseous phase even through the temperature of the refrigerant decreases as the refrigerant flows through the outlet port 465 of the expansion valve 440 due to the throttling action of the expansion valve 440 to the inlet port 460 of the at least one heating channel 410 that is defined in the fuel cell stack 422. Moreover, the throttling of the refrigerant that flows from one of the outlet port 488 of the bypass flow path 434 and the outlet port 484 of the condenser 430 to the inlet port 460 of the at least one heating channel 410 that is defined in the fuel cell stack 422 via the outlet port 465 of the expansion valve 440 that is controlled by the electronic control unit 412 via the control flow path 471 permits only the required mass flow rate of refrigerant to be channeled at high-speed through the inlet port 460 of the at least one heating channel 410 that is defined in the fuel cell stack 422.

Therefore, at the outlet port 465 of the expansion valve 440, substantially gaseous refrigerant is at lower pressure than the refrigerant that is channeled to the inlet port 483 of the expansion valve 440 from one of the outlet port 488 of the bypass flow path 434 and the outlet port 484 of the condenser 430, and is at lower temperature than the refrigerant that is channeled to the inlet port 483 of the expansion valve 440 from one of the outlet port 488 of the bypass flow path 434 and the outlet port 484 of the condenser 430. In an exemplary embodiment, the inlet port 460 of the at least one heating channel 410 that is defined in the fuel cell stack 422 is in flow communication with the outlet port 465 of the expansion valve 440 and receives high-speed gaseous refrigerant at high temperature and at low pressure for heating the fuel cell stack 422 and consequently heating the at least one fuel cell that is positioned within the fuel cell stack 422. After the refrigerant at high temperature and at low pressure is channeled to the inlet port 460 of the at least one heating channel 410 that is defined in the fuel cell stack 422, the cycle is repeated with the flow of gaseous refrigerant at high temperature and at low pressure through the at least one heating channel 410 defined in the fuel cell stack 422 to heat the at least one fuel cell that is positioned against the at least one heating channel 410 defined in the fuel cell stack 422.

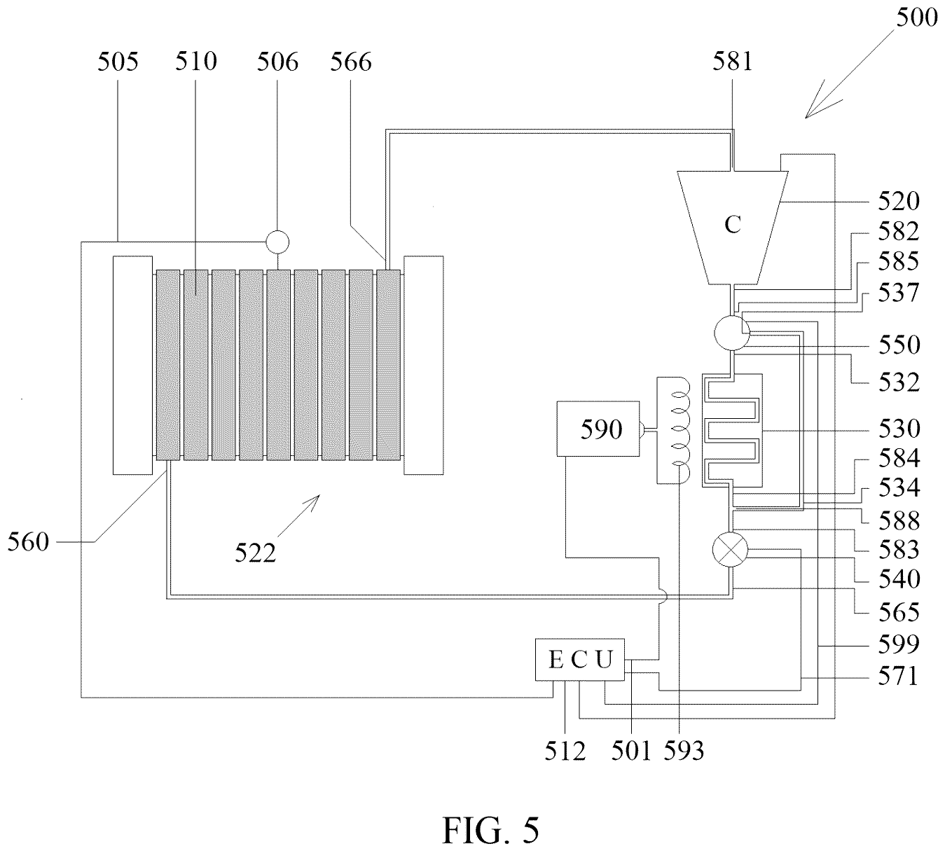

FIG. 5 is a schematic representation of the thermal management system 500 for increasing a temperature of the fuel cell stack 522 comprising the heating chamber 510 defined in the fuel cell stack 522 that is in flow communication with the compressor 520, the condenser 530, and the expansion valve 540 in another embodiment of the invention. The thermal management system 500 for increasing the temperature of the fuel cell stack 522 comprising the heating chamber 510 defined in the fuel cell stack 522 that is in flow communication with the compressor 520, the condenser 530, and the expansion valve 540 that is depicted in FIG. 5 is similar to the thermal management system 300 for decreasing the temperature of the fuel cell stack 322 comprising the cooling chamber 310 defined in the fuel cell stack 322 that is in flow communication with the compressor 320, the condenser 330, and the expansion valve 340 that is depicted in FIG. 3. The differences between the thermal management system 500 that is depicted in FIG. 5 and the thermal management system 300 that is depicted in FIG. 3 are described below.

In the embodiment of the invention that is depicted in FIG. 5, it is required to heat the at least one fuel cell that is positioned within the heating chamber 510 that is defined in the fuel cell stack 522 during cold operating conditions of the fuel cell stack 522. The electronic control unit 512 is in electronic communication with the bypass valve 550 via the control flow path 599. When the fuel cell stack 322 is required to be cooled, the refrigerant that flows through the outlet port 382 of the compressor 320 is channeled through the condenser 330 via the bypass valve 350 to cool the refrigerant therein. The cooled refrigerant from the outlet port 384 of the condenser 330 is subsequently channeled through the inlet port 360 of the cooling chamber 310 that is defined in the fuel cell stack 322. However, when it is required to heat the at least one fuel cell that is positioned within the heating chamber 510 of the fuel cell stack 522 and is submerged and in direct contact with the refrigerant as is required in the present embodiment of the invention, the electronic control unit 512 opens the outlet port 537 of the bypass valve 550 that is in flow communication with the bypass flow path 534 and closes the outlet port 532 of the bypass valve 550 that is in flow communication with the condenser 530. Therein, refrigerant at high temperature from the outlet port 582 of the compressor 520 is channeled through the bypass flow path 534 via the outlet port 537 of the bypass valve 550 and delivered to the inlet port 583 of the expansion valve 540 by bypassing the condenser 530. Therefore, the gaseous refrigerant at high temperature and at high pressure from the outlet port 582 of the compressor 520 is not cooled in the condenser 530. Rather, the gaseous refrigerant at high temperature and at high pressure that flows through the bypass flow path 534 to the inlet port 583 of the expansion valve 540 from the bypass valve 550 heats the at least one fuel cell that is positioned within the heating chamber 510 defined in the fuel cell stack 522 and is submerged and in direct contact with the refrigerant during cold operating conditions of the fuel cell stack 522.

In an alternate exemplary embodiment, when it is required to heat the at least one fuel cell that is positioned within the fuel cell stack 522 as is required in the present embodiment of the invention, the electronic control unit 512 opens the outlet port 532 of the bypass valve 550 that is in flow communication with the condenser 530 and closes the outlet port 537 of the bypass valve 550 that is in flow communication with the bypass flow path 534. Therein, refrigerant at high temperature from the outlet port 582 of the compressor 520 is channeled through the condenser 530 via the outlet port 532 of the bypass valve 550 and delivered to the inlet port 583 of the expansion valve 540 by bypassing the bypass flow path 534. When it is required to heat the refrigerant that flows through the condenser 530 from the outlet port 532 of the bypass valve 550, the electronic control unit 512 transmits an electronic signal to the heater 590 that is in thermal communication with the condenser 530 via the control flow path 501. More specifically, when the electronic control unit 512 transmits the electronic signal to the heater 590 via the control flow path 501, the plurality of heating coils 593 of the heater 590 that are in thermal communication with the condenser 530 are activated which consequently increases its temperature. Once the temperature of the plurality of heating coils 593 of the heater 590 that are in thermal communication with the condenser 530 are increased, heat is transferred from the plurality of heating coils 593 of the heater 590 to the condenser 530. More specifically, the heat is transferred from the plurality of heating coils 593 of the heater 590 to the high temperature refrigerant that flows through the condenser 530 from the compressor 520 via the outlet port 532 of the bypass valve 550 by conduction/convection. Therefore, the temperature of the gaseous refrigerant from the outlet port 582 of the compressor 520 that is channeled to the condenser 530 via the outlet port 532 of the bypass valve 550 is further increased substantially in the condenser 530 due to the transfer of heat from the plurality of heating coils 593 of the heater 590 to the high temperature refrigerant that flows through the condenser 530. Consequently, the refrigerant that flows through from the outlet port 584 of the condenser 530 is at a higher temperature than the refrigerant that flows through the outlet port 532 of the bypass valve 550 and is channeled to the condenser 530. This higher temperature refrigerant that flows through the outlet port 584 of the condenser 530 than at the outlet port 532 of the bypass valve 550 by bypassing the bypass flow path 534 is channeled to the inlet port 583 of the expansion valve 540. The gaseous refrigerant at high temperature and at high pressure that flows through the condenser 530 and is heated in the condenser 530 and that subsequently flows to the inlet port 583 of the expansion valve 540 heats the at least one fuel cell that is positioned within the heating chamber 510 defined in the fuel cell stack 522 and is submerged and in direct contact with the refrigerant during cold operating conditions of the fuel cell stack 522.

When it is required to heat the at least one fuel cell that is positioned within the heating chamber 510 defined in the fuel cell stack 522 during cold operating conditions of the fuel cell stack 522, the gaseous refrigerant at high temperature that flows via one of the outlet port 584 of the condenser 530 and the outlet port 588 of the bypass flow path 534 is channeled to the inlet port 560 of the heating chamber 510 that is defined in the fuel cell stack 522 via the outlet port 565 of the expansion valve 540. More specifically, when the temperature sensor 506 that is in thermal communication with the at least one fuel cell positioned within the heating chamber 510 defined in the fuel cell stack 522 senses that the temperature of the at least one fuel cell positioned within the heating chamber 510 defined in the fuel cell stack 522 is below the threshold temperature that is pre-defined by the user and requires to be heated to the temperature that is within its acceptable operating design temperature limits in order to increase the operating efficiency of the fuel cell stack 522, the temperature sensor 506 transmits an electronic signal to the electronic control unit 512 via the control flow path 505 indicating that the temperature of the at least one fuel cell positioned within the heating chamber 510 defined in the fuel cell stack 522 is below this threshold temperature. Thereby, gaseous refrigerant at high temperature from the outlet port 565 of the expansion valve 540 is channeled to the inlet port 560 of the heating chamber 510 that is defined in the fuel cell stack 522 to heat the fuel cell stack 522 and consequently the at least one fuel cell that is positioned within the heating chamber 510 of the fuel cell stack 522.

A working of the thermal management system 500 for the fuel cell stack 522 is described as an example. The gaseous refrigerant at high temperature that flows from the outlet port 565 of the expansion valve 540 is channeled to the inlet port 560 of the heating chamber 510 that is defined in the fuel cell stack 522. When it is required to heat the at least one fuel cell that is positioned within the heating chamber 510 defined in the fuel cell stack 522 during cold operating temperature conditions of the fuel cell stack 522, the gaseous refrigerant at high temperature that flows from the outlet port 565 of the expansion valve 540 is channeled to the inlet port 560 of the heating chamber 510 that is defined in the fuel cell stack 522. More specifically, when the temperature sensor 506 that is in thermal communication with the fuel cell stack 522/at least one fuel cell that is positioned within the heating chamber 510 that is defined in the fuel cell stack 522 and is submerged and in direct contact with the refrigerant senses that the temperature of the fuel cell stack 522/at least one fuel cell positioned within the heating chamber 510 defined in the fuel cell stack 522 is below the threshold temperature that is pre-defined by the user and requires to be heated in order to increase the operating efficiency of the fuel cell stack 522, the temperature sensor 506 transmits the electronic signal to the electronic control unit 512 indicating that the temperature of the at least one fuel cell that is positioned within the heating chamber 510 defined in the fuel cell stack 522 and is submerged and in direct contact with the refrigerant is below the threshold temperature via the control flow path 505. Thereby, gaseous refrigerant at high temperature from the outlet port 565 of the expansion valve 540 is channeled to the inlet port 560 of the heating chamber 510 that is defined in the fuel cell stack 522.

Gaseous refrigerant at high temperature that is channeled from the outlet port 565 of the expansion valve 540 to the inlet port 560 of the heating chamber 510 that is defined in the fuel cell stack 522 heats the at least one fuel cell that is positioned within the heating chamber 510 defined in the fuel cell stack 522 and is submerged and in direct contact with the refrigerant. Therefore, in the thermal management system 500 for increasing the temperature of the fuel cell stack 522 that is in flow communication with the compressor 520, the condenser 530, and the expansion valve 540 that is depicted in FIG. 5, the refrigerant from the outlet port 565 of the expansion valve 540 heats the at least one fuel cell that is positioned within the heating chamber 510 defined in the fuel cell stack 522 and is submerged and in direct contact with the refrigerant flowing through the heating chamber 510 defined in the fuel cell stack 522.

In an exemplary embodiment, the refrigerant in the gaseous state at high temperature is received within the inlet port 560 of the heating chamber 510 that is defined in the fuel cell stack 522 that contains at least one fuel cell at low temperature that is positioned within the heating chamber 510 defined in the fuel cell stack 522. In an exemplary embodiment, once the refrigerant is received within the inlet port 560 of the heating chamber 510 that is defined in the fuel cell stack 522, the inlet port 560 of the heating chamber 510 defined in the fuel cell stack 522 channels the refrigerant into the heating chamber 510 defined in the fuel cell stack 522 such that the gaseous refrigerant at high temperature is channeled through the heating chamber 510. At least one fuel cell is positioned within the heating chamber 510 that is defined in the fuel cell stack 522 and absorbs heat by convection from the refrigerant at high temperature that is channeled through the heating chamber 510 and that submerges and is in direct contact with the at least one fuel cell that is positioned within the heating chamber 510. The heating chamber 510 is in flow communication with the outlet port 566 of the heating chamber 510 that channels refrigerant that flows through the heating chamber 510. In an exemplary embodiment, gaseous refrigerant at high temperature is channeled to the fuel cell stack 522 that contains at least one fuel cell at low temperature that is positioned within the heating chamber 510 defined in the fuel cell stack 522 to heat the at least one fuel cell that is positioned within the heating chamber 510 defined in the fuel cell stack 522 and is submerged and in direct contact with the gaseous refrigerant.

Once the gaseous refrigerant at high temperature is channeled within the heating chamber 510 via the inlet port 560 of the heating chamber 510 that is defined in the fuel cell stack 522, the gaseous refrigerant at high temperature is allowed to flow through the heating chamber 510 that is defined in the fuel cell stack 522 to facilitate heating the at least one fuel cell at low temperature that is positioned within the heating chamber 510 defined in the fuel cell stack 522 and is submerged and in direct contact with the refrigerant. More specifically, once the gaseous refrigerant at high temperature flows through the inlet port 560 of the heating chamber 510 that is defined in the fuel cell stack 522 to heat the at least one fuel cell at low temperature that is positioned within the heating chamber 510 defined in the fuel cell stack 522, the refrigerant is channeled through the heating chamber 510 to heat the at least one fuel cell, following which the refrigerant is channeled through the outlet port 566 of the heating chamber 510. The flow of refrigerant through the heating chamber 510, and finally through the outlet port 566 that is in flow communication with the heating chamber 510 that is defined in the fuel cell stack 522 that contains at least one fuel cell at low temperature that is positioned within the heating chamber 510 defined in the fuel cell stack 522 and is submerged and in direct contact with the refrigerant heats the fuel cell stack 522, and consequently heats the at least one fuel cell at low temperature that is positioned within the heating chamber 510 defined in the fuel cell stack 522 and is submerged and in direct contact with the refrigerant respectively.

More specifically, as the gaseous refrigerant at high temperature flows through the heating chamber 510, and subsequently through the outlet port 566 of the heating chamber 510, the gaseous refrigerant at high temperature discharges heat to the at least one fuel cell at low temperature that is positioned within the heating chamber 510 defined in the fuel cell stack 522 and is submerged and in direct contact with the refrigerant, and consequently cools down due to transfer of heat to the at least one fuel cell at low temperature that is positioned within the heating chamber 510 defined in the fuel cell stack 522. More specifically, the gaseous refrigerant at high temperature cools down due to the transfer of heat from the gaseous refrigerant at high temperature that flows from the inlet port 560 of the heating chamber 510 that is defined in the fuel cell stack 522 to the at least one fuel cell at low temperature that is positioned within the heating chamber 510 defined in the fuel cell stack 522 and is submerged and in direct contact with the refrigerant by convection. The discharge of heat by the gaseous refrigerant at high temperature to the at least one fuel cell at low temperature that is positioned within the heating chamber 510 defined in the fuel cell stack 522 and is submerged and in direct contact with the refrigerant decreases the temperature of the refrigerant from high temperature to low temperature as refrigerant flows through the heating chamber 510 until the refrigerant flows through the outlet port 566 of the heating chamber 510. Therefore, when the gaseous refrigerant flows through the inlet port 560, the gaseous refrigerant is at high temperature and at low pressure. However, as the gaseous refrigerant discharges heat to the at least one fuel cell at low temperature that is positioned within the heating chamber 510 defined in the fuel cell stack 522 and is submerged and in direct contact with the refrigerant as refrigerant flows through the heating chamber 510 and subsequently flows through the outlet port 566 of the heating chamber 510, the gaseous refrigerant that flows through the outlet port 566 of the heating chamber 510 defined in the fuel cell stack 522 is at lower temperature than at the inlet port 560 of the heating chamber 510 defined in the fuel cell stack 522 and at low pressure. As heat flows from the high temperature refrigerant that flows through the inlet port 560 of the heating chamber 510 defined in the fuel cell stack 522 to the at least one fuel cell at low temperature that is positioned within the heating chamber 510 defined in the fuel cell stack 522 and is submerged and in direct contact with the refrigerant and subsequently flows through the outlet port 566 of the heating chamber 510, and through the outlet port 566 of the heating chamber 510 defined in the fuel cell stack 522, the at least one fuel cell at low temperature that is positioned within the heating chamber 510 defined in the fuel cell stack 522 and is submerged and in direct contact with the refrigerant is substantially heated from lower temperature to higher temperature that is within its acceptable operating design temperature limits. The refrigerant that flows from the outlet port 566 of the heating chamber 510 defined in the fuel cell stack 522 that contains at least one fuel cell at low temperature that is positioned within the heating chamber 510 defined in the fuel cell stack 522 and is submerged and in direct contact with the refrigerant is subsequently channeled to the inlet port 581 of the compressor 520.

The refrigerant that flows from the outlet port 566 of the heating chamber 510 that is defined in the fuel cell stack 522 in the gaseous state at low temperature and at low pressure after discharging heat to the at least one fuel cell is channeled to the inlet port 581 of the compressor 520. Once the gaseous refrigerant is received in the compressor 520, the gaseous refrigerant is compressed in the compressor 520 from the pressure that is equal to the pressure of the refrigerant at the outlet port 566 of the heating chamber 510 that is defined in the fuel cell stack 522 to the higher pressure that is required for the refrigerant to be circulated through the thermal management system 500 for the fuel cell stack 522. Therefore, as the gaseous refrigerant at low temperature and at low pressure flows through the compressor 520 via its inlet port 581, the compressor 520 increases the pressure of the refrigerant from the low pressure to the high pressure with a corresponding large increase in temperature of the refrigerant. Therefore, at the outlet port 582 of the compressor 520, the gaseous refrigerant is at a higher temperature than the gaseous refrigerant that is channeled to the inlet port 581 of the compressor 520 from the outlet port 566 of the heating chamber 510 that is defined in the fuel cell stack 522, and at a higher pressure than the gaseous refrigerant that is channeled to the inlet port 581 of the compressor 520 from the outlet port 566 of the heating chamber 510 that is defined in the fuel cell stack 522.

The refrigerant at the outlet port 582 of the compressor 520 that is in the gaseous state at high temperature and at high pressure is channeled to the inlet port 585 of the bypass valve 550. Once the gaseous refrigerant is received in the bypass valve 550, the gaseous refrigerant at high temperature and at high pressure is channeled from the outlet port 582 of the compressor 520 through the bypass flow path 534 via the outlet port 537 of the bypass valve 550 by bypassing the condenser 530. More specifically, the outlet port 532 of the bypass valve 550 is closed by the electronic control unit 512 via the control flow path 599. The refrigerant at the outlet port 588 of the bypass flow path 534 that is in the gaseous state at high temperature and at high pressure is channeled to the inlet port 583 of the expansion valve 540. The expansion valve 540 is in flow communication with the outlet port 588 of the bypass flow path 534 at its inlet port 583 and receives refrigerant that flows from the bypass flow path 534 through the outlet port 588 of the bypass flow path 534.

In an alternate exemplary embodiment, once the gaseous refrigerant is received in the bypass valve 550 from the outlet port 582 of the compressor 520, the gaseous refrigerant at high temperature and at high pressure is channeled from the outlet port 582 of the compressor 520 through the condenser 530 via the outlet port 532 of the bypass valve 550 by bypassing the bypass flow path 534. More specifically, the outlet port 537 of the bypass valve 550 that is in flow communication with the bypass flow path 534 is closed by the electronic control unit 512 via the control flow path 599. Therein, the electronic control unit 512 transmits the electronic signal to the heater 590 via the control flow path 501 that is in electronic communication between the electronic control unit 512 and the heater 590. The activation of the heater 590 heats the plurality of heating coils 593 of the heater 590. Therein, the heat from the plurality of heating coils 593 of the heater 590 is transferred via conduction/convection to the condenser 530 that is in thermal communication with the plurality of heating coils 593 of the heater 590. More specifically, the high temperature refrigerant that flows through the outlet port 532 of the bypass valve 550 from the outlet port 582 of the compressor 520 absorbs heat from the plurality of heating coils 593 of the heater 590 via conduction/convection. Due to the absorption of heat by the high temperature refrigerant flowing through the condenser 530 from the plurality of heating coils 593 of the heater 590, the temperature of the gaseous refrigerant further increases to a higher temperature. This gaseous refrigerant at the outlet port 534 of the condenser 530 that is in the gaseous state at the higher temperature than the refrigerant at the outlet port 532 of the bypass valve 550 and at high pressure is channeled to the inlet port 583 of the expansion valve 540. The expansion valve 540 is in flow communication with the outlet port 584 of the condenser 530 at its inlet port 583 and receives refrigerant at high temperature that flows from the condenser 530 through the outlet port 584 of the condenser 530.

Once the refrigerant is received at the inlet port 583 of the expansion valve 540 in the substantially gaseous state at high temperature and at high pressure via one of the outlet port 584 of the condenser 530 and the outlet port 588 of the bypass flow path 534, the expansion valve 540 throttles the gaseous refrigerant, thereby decreasing the pressure of the refrigerant that flows from one of the outlet port 584 of the condenser 530 and the outlet port 588 of the bypass flow path 534 to the lower pressure that flows from the outlet port 565 of the expansion valve 540. Due to the decrease in the pressure of the refrigerant due to the throttling action of the expansion valve 540, the temperature of the refrigerant is decreased from the temperature at the inlet port 583 of the expansion valve 540 to a relatively lower temperature that flows from the outlet port 565 of the expansion valve 540. The expansion valve 540 is electronically controlled by means of the electronic control unit 512 that is in electronic communication with the expansion valve 540 via the control flow path 571. More specifically, the electronic control unit 512 controls the opening percentage/opening of the outlet port 565 of the expansion valve 540 to facilitate regulating the required mass flow rate of the refrigerant at high temperature and at low pressure that is to flow from one of the outlet port 584 of the condenser 530 and the outlet port 588 of the bypass flow path 534 to the inlet port 560 of the heating chamber 510 that is defined in the fuel cell stack 522 via the outlet port 565 of the expansion valve 540 for the refrigerant to be circulated through the thermal management system 500 for the fuel cell stack 522.

As the pressure and the temperature of the refrigerant decreases from the high pressure and high temperature at one of the outlet port 584 of the condenser 530 and the outlet port 588 of the bypass flow path 534 to low pressure and lower temperature that is required for the refrigerant to be circulated through the thermal management system 500 for the fuel cell stack 522, the refrigerant retains its phase in the gaseous phase after flowing through the outlet port 565 of the expansion valve 540. The refrigerant retains its phase in the gaseous phase even through the temperature of the refrigerant decreases as the refrigerant flows through the outlet port 565 of the expansion valve 540 due to the throttling effect of the expansion valve 540 to the inlet port 560 of the heating chamber 510 that is defined in the fuel cell stack 522. Moreover, the throttling of the refrigerant that flows from one of the outlet port 584 of the condenser 530 and the outlet port 588 of the bypass flow path 534 to the inlet port 560 of the heating chamber 510 that is defined in the fuel cell stack 522 via the outlet port 565 of the expansion valve 540 that is controlled by the electronic control unit 512 via the control flow path 571 permits only the required mass flow rate of refrigerant to be channeled at high-speed through the inlet port 560 of the heating chamber 510 that is defined in the fuel cell stack 522.

Therefore, at the outlet port 565 of the expansion valve 540, substantially gaseous refrigerant is at lower pressure than the refrigerant that is channeled to the inlet port 583 of the expansion valve 540 from one of the outlet port 584 of the condenser 530 and the outlet port 588 of the bypass flow path 534, and is at lower temperature than the refrigerant that is channeled to the inlet port 583 of the expansion valve 540 from one of the outlet port 584 of the condenser 530 and the outlet port 588 of the bypass flow path 534. In an exemplary embodiment, the inlet port 560 of the heating chamber 510 that is defined in the fuel cell stack 522 is in flow communication with the outlet port 565 of the expansion valve 540 and receives high-speed gaseous refrigerant at high temperature and at low pressure therein. After the refrigerant at high temperature and at low pressure is channeled to the inlet port 560 of the heating chamber 510 that is defined in the fuel cell stack 522, the cycle is repeated with the flow of gaseous refrigerant at high temperature and at low pressure through the heating chamber 510 defined in the fuel cell stack 522 to heat the at least one fuel cell that is positioned within the heating chamber 510 defined in the fuel cell stack 522 and that is submerged and in direct contact with the refrigerant.

In another exemplary embodiment, the fuel cell stack 222 is described. The fuel cell stack 222 comprises a housing, and at least one temperature regulating channel 210 that is defined in the housing of the fuel cell stack 222. The fuel cell stack 222 receives the refrigerant therein that flows through the at least one temperature regulating channel 210. The refrigerant that is received within the at least one temperature regulating channel 210 flows through the at least one temperature regulating channel 210 that is defined in the housing of the fuel cell stack 222 to regulate a temperature of the fuel cell stack 222. The fuel cell stack 222 contains at least one fuel cell that is positioned within its housing. The at least one temperature regulating channel 210 defined in the housing of the fuel cell stack 222 receives the refrigerant therein. The refrigerant that is received within the at least one temperature regulating channel 210 flows through the at least one temperature regulating channel 210 that is defined in the housing of the fuel cell stack 222 to regulate the temperature of the at least one fuel cell that is positioned within the housing of the fuel cell stack 222.

The advantages of the thermal management system 200 for the fuel cell stack 222 are described below for the understanding of a reader. Since a low mass flow rate of refrigerant is required to be channeled through the at least one cooling channel/cooling chamber 210 that is defined in the fuel cell stack 222 to regulate the temperature of the at least one fuel cell that is positioned within the fuel cell stack 222 in contrast to the high mass flow rate of liquid coolant that is required to be channeled through the at least one cooling channel/cooling chamber 210 that is defined in the fuel cell stack 222 to regulate the temperature of the fuel cell stack 222, the total amount of electrical energy that is required to be expended for operating the compressor 220 to compress refrigerant flowing from the outlet port 266 of the at least one cooling channel/cooling chamber 210 that is defined in the fuel cell stack 222 and delivering the compressed refrigerant from the outlet port 282 of the compressor 220 to the inlet port 231 of the condenser 230, for channeling refrigerant through the condenser 230, for channeling refrigerant through the expansion valve 240, and finally for channeling the refrigerant through the at least one cooling channel/cooling chamber 210 that is defined in the fuel cell stack 222 is much lower in contrast to the total amount of electrical energy that is required to be expended for operating the electric pump for channeling liquid coolant from the electric pump through the radiator, for channeling liquid coolant flowing from the radiator through the at least one cooling channel/cooling chamber 210 that is defined in the fuel cell stack 222, for channeling the liquid coolant flowing from the at least one cooling channel/cooling chamber 210 that is defined in the fuel cell stack 222 through the coolant tank, and channeling liquid coolant flowing from the coolant tank through the electric pump in a closed loop cooling circuit. Therefore, since the low mass flow rate of refrigerant is required to be channeled through the at least one cooling channel/cooling chamber 210 that is defined in the fuel cell stack 222 to indirectly/directly cool the fuel cell stack 222 by decreasing the first temperature of the fuel cell stack 222 and consequently the at least one fuel cell to the second temperature that is within its acceptable operating design temperature limits in contrast to the high mass flow rate of liquid coolant that is required to be channeled through the at least one cooling channel/cooling chamber 210 that is defined in the fuel cell stack 222 to cool the fuel cell stack 222 by decreasing the first temperature of the fuel cell stack 222 and consequently the at least one fuel cell to the second temperature, the total amount of energy that is required to be supplied to the compressor 220 for compressing and discharging the refrigerant through the cooling system 200 for the fuel cell stack 222 is much lesser than the total amount of energy that is required for channeling the liquid coolant through the cooling system 200 for the fuel cell stack 222. Moreover, as refrigerant is a non-electrolyte in contrast to the liquid coolant, which is a good electrolyte, the refrigerant as a medium that submerges the at least one fuel cell within the cooling chamber 210 and is in direct contact with the at least one fuel cell does not allow for passage of negatively charged electrons between negative and positive terminals of the at least one fuel cell via the refrigerant medium. Therefore, a power conversion efficiency of the fuel cell stack 222 that contains at least one fuel cell that is submerged and in direct contact with the refrigerant may be substantially increased in contrast to the fuel cell stack 222 that contains at least one fuel cell that is submerged and in direct contact with the liquid coolant.

In addition, since the low viscosity gaseous refrigerant at a corresponding low inertia is required to be channeled through the at least one cooling channel/cooling chamber 210 that is defined in the fuel cell stack 222 to cool the fuel cell stack 222 and consequently the at least one fuel cell positioned within the fuel cell stack 222 in contrast to the high viscosity liquid coolant at a corresponding high inertia that is required to be channeled through the at least one cooling channel/cooling chamber 210 that is defined in the fuel cell stack 222 to cool the fuel cell stack 222 and consequently the at least one fuel cell positioned within the fuel cell stack 222, a total amount of energy that is required to be expended for channeling the refrigerant having low inertia through the cooling system 200 for the fuel cell stack 222 is much lesser than the total amount of energy that is required to be expended for channeling the liquid coolant having high inertia through the cooling system 200 for the fuel cell stack 222. Therefore, since the viscosity of the refrigerant that is required to be channeled through the at least one cooling channel/cooling chamber 210 that is defined in the fuel cell stack 222 to regulate the temperature of the fuel cell stack 222 is low, the total amount of energy that is required to be supplied to the compressor 220 for operating the compressor 220 and circulating the refrigerant having low inertia through the cooling system 200 for the fuel cell stack 222 is much lesser than the total amount of energy that is required for operating the electric pump and circulating the liquid coolant having high inertia through the cooling system 200 for the fuel cell stack 222 to decrease the temperature of the fuel cell stack 222 from the high temperature to the temperature that is within its acceptable operating design temperature limits.

Further, material cost savings associated with utilizing the liquid refrigerant for cooling the fuel cell stack 222 and consequently the at least one fuel cell that does not require to be replaced over an entire lifespan of the fuel cell stack 222 is much higher than utilizing the liquid coolant that is currently being deployed for cooling the fuel cell stack 222, and that requires to be replaced several times over the entire lifespan of the fuel cell stack 222. In addition, a maintenance cost associated with maintaining the proposed thermal management system 200 for the fuel cell stack 222 utilizing the liquid refrigerant that requires minimal service and mechanical maintenance is much lower than the maintenance cost associated with maintaining the current thermal management system 200 for the fuel cell stack 222 utilizing the liquid coolant that requires frequent maintenance and service. Therefore, the overall benefits associated with deploying the proposed liquid refrigerant that is to be circulated through the thermal management system 200 for the fuel cell stack 222 to cool the fuel cell stack 222 and the at least one fuel cell that is positioned within the fuel cell stack 522 is much better than the overall benefits associated with deploying the liquid coolant that is currently being circulated through the thermal management system 200 for the fuel cell stack 222 to cool the fuel cell stack 222.

Furthermore, the at least one cooling channel/cooling chamber 210 that is defined in the fuel cell stack 222 extends around the entire surface area of the fuel cell stack 222, thereby enabling the most efficient absorption of heat by the refrigerant flowing through the at least one cooling channel/cooling chamber 210 from the entire surface area of the fuel cell stack 222 as well as from the at least one fuel cell that is positioned against the at least one cooling channel and is in indirect contact with the at least one cooling channel/cooling chamber 210 and is in direct contact with the cooling chamber 210 that is defined in the fuel cell stack 222 and is submerged and in direct contact with the refrigerant. Therefore, the at least one cooling channel/cooling chamber 210 that is defined in the fuel cell stack 222 that extends around the entire surface area of the fuel cell stack 222 facilitates absorbing maximum amount of heat from the entire surface area of the fuel cell stack 222 as well as from the at least one fuel cell that is positioned against the at least one cooling channel 210 and is in indirect contact with the at least one cooling channel 210/cooling chamber 210 defined in the fuel cell stack 222 and is submerged and in direct contact with the refrigerant effectively. Thereby, the respective temperatures of the at least one fuel cell and the fuel cell stack 222 are regulated to attain temperatures that are within their acceptable operating design temperature limits.

It is assumed throughout this manuscript that heat losses that occur during the flow of refrigerant between each of the plurality of modules of the thermal management system 200 for the fuel cell stack 222 is negligible and is therefore not considered. In addition, the term ‘submerged’ should be construed by the reader as complete submersion or partial submersion of the at least one fuel cell within the refrigerant that flows through the fuel cell stack 222. Further the terms ‘substantially liquid refrigerant’ and ‘liquid refrigerant’ as well as ‘substantially gaseous refrigerant’ and ‘gaseous refrigerant’ may be used interchangeably in this manuscript.

Exemplary embodiments of a thermal management system 200 for the fuel cell stack 222 for regulating the temperature of the fuel cell stack 222 is described above in detail. The systems are not limited to the specific embodiments described herein, but rather, components of each sub-system may be utilized separately and independently from other components described herein.

While the invention has been described in terms of various specific embodiments, those skilled in the art will recognize that the invention can be practiced with modifications within the spirit and scope of the claims.

What is claimed is:

1. A thermal management system for a fuel cell stack, said thermal management system comprising:
at least one cooling channel defined in said fuel cell stack and receives a refrigerant therein, wherein the refrigerant that is received within the at least one cooling channel flows through the at least one cooling channel that is defined in said fuel cell stack to cool said fuel cell stack;
a compressor in flow communication with an outlet of the at least one cooling channel defined in said fuel cell stack at its inlet, said compressor receives the refrigerant that flows through the outlet of the at least one cooling channel that is defined in said fuel cell stack, said compressor compresses the refrigerant that is received in said compressor;
a condenser in flow communication with an outlet of said compressor at its inlet and receives the refrigerant that flows through the outlet of said compressor, said condenser discharges heat from the refrigerant that is received in said condenser; and
an expansion valve in flow communication with an outlet of said condenser at its inlet and receives the refrigerant that flows through the outlet of said condenser, said expansion valve in flow communication with an inlet of the at least one cooling channel defined in said fuel cell stack at its outlet, said expansion valve controls a flow of refrigerant that flows through the outlet of said condenser to the inlet of the at least one cooling channel that is defined in said fuel cell stack to cool said fuel cell stack.

2. A thermal management system for a fuel cell stack in accordance with claim 1, wherein said expansion valve controls the flow of refrigerant that flows through the outlet of said condenser to the inlet of the at least one cooling channel that is defined in said fuel cell stack containing at least one fuel cell at high temperature, the outlet of the at least one cooling channel defined in said fuel cell stack in flow communication with the inlet of said compressor, via the outlet of said expansion valve for cooling said at least one fuel cell that is positioned within said fuel cell stack.

3. A thermal management system for a fuel cell stack in accordance with claim 2, further comprising a cooling fan positioned proximate to said condenser and receives electric power from one of said fuel cell stack and an electric battery, said cooling fan delivers a stream of high-speed cooling air to said condenser to cool the refrigerant that is received in said condenser from the outlet of said compressor.

4. A thermal management system for a fuel cell stack in accordance with claim 3, further comprising an electronic control unit in electronic communication with said thermal management system for said fuel cell stack, wherein said electronic control unit is adapted to:
control said cooling fan that delivers the stream of high-speed cooling air to said condenser to cool the refrigerant that is received in said condenser from the outlet of said compressor via a first control flow path that is in electronic communication between said cooling fan and said electronic control unit;
control the flow of refrigerant from said expansion valve to the inlet of the at least one cooling channel that is defined in said fuel cell stack via a second control flow path that is in electronic communication between said expansion valve and said electronic control unit;
control a pressure regulator of said compressor that delivers pressurized refrigerant at high temperature to said condenser via a third control flow path that is in electronic communication between said pressure regulator of said compressor and said electronic control unit; and
receive a temperature signal that is indicative of an operating temperature of at least one fuel cell that is positioned within said fuel cell stack from a temperature sensor that is in thermal communication with said at least one fuel cell that is positioned within said fuel cell stack via a fourth control flow path that is in electronic communication between said temperature sensor and said electronic control unit.

5. A thermal management system for a fuel cell stack in accordance with claim 1, further comprising at least one fuel cell positioned against the at least one cooling channel defined in said fuel cell stack, the refrigerant that flows through the at least one cooling channel that is defined in said fuel cell stack cools said at least one fuel cell by withdrawing heat away from said at least one fuel cell at high temperature that is positioned against the at least one cooling channel defined in said fuel cell stack.

6. A thermal management system for a fuel cell stack in accordance with claim 5, wherein said at least one fuel cell positioned against the at least one cooling channel is at least one high temperature fuel cell comprising at least one bipolar plate, at least one gas diffusion membrane, and at least one proton-exchange membrane.

7. A thermal management system for a fuel cell stack in accordance with claim 1, wherein an inner wall of the at least one cooling channel defined in said fuel cell stack is of a material that can withstand pressurized refrigerant at one of high temperature and low temperature, and wherein the inner wall of the at least one cooling channel defined in said fuel cell stack is of a leak resistant material to ensure containment of substantially gaseous refrigerant within the at least one cooling channel that is defined in said fuel cell stack.

8. A thermal management system for a fuel cell stack in accordance with claim 1, wherein the refrigerant that flows through the at least one cooling channel that is defined in said fuel cell stack to cool said fuel cell stack is of a specific heat absorption capacity/unit mass of refrigerant that is substantially lesser than a specific heat absorption capacity/unit mass of liquid coolant, thereby allowing for a low mass flow rate of refrigerant to be channeled through the at least one cooling channel that is defined in said fuel cell stack to decrease a first temperature of at least one fuel cell positioned within said fuel cell stack to a second temperature in contrast to a high mass flow rate of liquid coolant to be channeled through the at least one cooling channel that is defined in said fuel cell stack to decrease the first temperature of the at least one fuel cell positioned within said fuel cell stack to the second temperature.

9. A thermal management system for a fuel cell stack in accordance with claim 1, wherein a total amount of energy that is required to operate said compressor for compressing the refrigerant, for channeling the refrigerant through said condenser, for channeling the refrigerant through said expansion valve, and for channeling the refrigerant through the at least one cooling channel that is defined in said fuel cell stack is lesser than a total amount of energy that is required to operate an electric coolant pump for circulating liquid coolant, for channeling liquid coolant through a radiator, for channeling liquid coolant through the at least one cooling channel that is defined in said fuel cell stack, and for channeling liquid coolant through a coolant tank because at least one of:
a low mass flow rate of the refrigerant is required to be channeled through the at least one cooling channel that is defined in said fuel cell stack to decrease a first temperature of at least one fuel cell positioned within said fuel cell stack to a second temperature in contrast to a high mass flow rate of liquid coolant that is required to be channeled through the at least one cooling channel that is defined in said fuel cell stack to decrease the first temperature of the at least one fuel cell positioned within said fuel cell stack to the second temperature; and
a low viscosity gaseous refrigerant is required to be channeled through the at least one cooling channel that is defined in said fuel cell stack to decrease the first temperature of the at least one fuel cell positioned within said fuel cell stack to the second temperature in contrast to a high viscosity liquid coolant that is required to be channeled through the at least one cooling channel that is defined in said fuel cell stack to decrease the first temperature of the at least one fuel cell positioned within said fuel cell stack to the second temperature.

10. A thermal management system for a fuel cell stack, said thermal management system comprising:
a cooling chamber defined in said fuel cell stack and receives a refrigerant therein, the refrigerant substantially fills the cooling chamber and is in direct contact with at least one inner wall of the cooling chamber, wherein the refrigerant that is received within the cooling chamber and that substantially fills the cooling chamber and in direct contact with at least one inner wall of the cooling chamber flows through the cooling chamber that is defined in said fuel cell stack to directly cool the at least one inner wall of the cooling chamber defined in said fuel cell stack;
a compressor in flow communication with an outlet of the cooling chamber defined in said fuel cell stack at its inlet, said compressor receives the refrigerant that flows through the outlet of the cooling chamber that is defined in said fuel cell stack, said compressor compresses the refrigerant that is received in said compressor;
a condenser in flow communication with an outlet of said compressor at its inlet and receives the refrigerant that flows through the outlet of said compressor, said condenser discharges heat from the refrigerant that is received in said condenser; and
an expansion valve in flow communication with an outlet of said condenser at its inlet and receives the refrigerant that flows through the outlet of said condenser, said expansion valve in flow communication with an inlet of the cooling chamber defined in said fuel cell stack at its outlet, said expansion valve controls a flow of refrigerant that flows through the outlet of said condenser to the inlet of the cooling chamber that is defined in said fuel cell stack to directly cool the at least one inner wall of the cooling chamber that is defined in said fuel cell stack.

11. A thermal management system for a fuel cell stack in accordance with claim 10, wherein said expansion valve controls the flow of refrigerant that flows through the outlet of said condenser to the inlet of the cooling chamber that is defined in said fuel cell stack containing at least one fuel cell at high temperature, the outlet of the cooling chamber defined in said fuel cell stack in flow communication with the inlet of said compressor, via the outlet of said expansion valve for cooling said at least one fuel cell that is positioned within the cooling chamber defined in said fuel cell stack.

12. A thermal management system for a fuel cell stack in accordance with claim 10, further comprising at least one fuel cell positioned within the cooling chamber defined in said fuel cell stack and is one of partially and completely submerged and in direct contact with the refrigerant that substantially fills the cooling chamber, wherein the refrigerant that flows through the cooling chamber that is defined in said fuel cell stack and that substantially fills the cooling chamber and one of partially and completely submerges said at least one fuel cell and being in direct contact with said at least one fuel cell directly cools said at least one fuel cell by withdrawing heat away from said at least one fuel cell that is positioned within the cooling chamber defined in said fuel cell stack.

13. A thermal management system for a fuel cell stack, said thermal management system comprising:
at least one heating channel defined in said fuel cell stack and receives a refrigerant therein, wherein the refrigerant that is received within the at least one heating channel flows through the at least one heating channel that is defined in said fuel cell stack to heat said fuel cell stack;
a compressor in flow communication with an outlet of the at least one heating channel defined in said fuel cell stack at its inlet, said compressor receives the refrigerant that flows through the outlet of the at least one heating channel that is defined in said fuel cell stack, said compressor compresses the refrigerant that is received in said compressor; and
an expansion valve in flow communication with an outlet of said compressor at its inlet and receives the refrigerant that flows through the outlet of said compressor, said expansion valve in flow communication with an inlet of the at least one heating channel defined in said fuel cell stack at its outlet, said expansion valve controls a flow of refrigerant that flows through the outlet of said compressor to the inlet of the at least one heating channel that is defined in said fuel cell stack to heat said fuel cell stack.

14. A thermal management system for a fuel cell stack in accordance with claim 13, further comprising a bypass valve in flow communication with the outlet of said compressor and receives the refrigerant that flows through the outlet of said compressor, said bypass valve controls the flow of refrigerant to one of:
a condenser in flow communication with a first outlet of said bypass valve at its inlet and receives the refrigerant that flows through the first outlet of said bypass valve, said condenser in flow communication with the inlet of said expansion valve at its outlet and channels the refrigerant to said expansion valve, and wherein heat is transferred to the refrigerant that is received in said condenser thereby increasing a temperature of the refrigerant; and
a bypass flow path in flow communication with a second outlet of said bypass valve at its inlet and receives the refrigerant that flows through the second outlet of said bypass valve, said bypass flow path in flow communication with the inlet of said expansion valve at its outlet and channels the refrigerant to said expansion valve by bypassing said condenser.

15. A thermal management system for a fuel cell stack in accordance with claim 14, wherein said expansion valve controls the flow of refrigerant that flows through one of the outlet of said condenser and the outlet of said bypass flow path to the inlet of at least one heating channel that is defined in said fuel cell stack containing at least one fuel cell at low temperature, the outlet of the at least one heating channel defined in said fuel cell stack in flow communication with the inlet of said compressor, via the outlet of said expansion valve for heating said at least one fuel cell that is positioned within said fuel cell stack.

16. A thermal management system for a fuel cell stack in accordance with claim 15, further comprising a heater positioned proximate to said condenser and receives electric power from one of said fuel cell stack and an electric battery, said heater supplies heat to said condenser thereby increasing a temperature of the refrigerant that is received in said condenser from the outlet of said compressor.

17. A thermal management system for a fuel cell stack in accordance with claim 16, further comprising an electronic control unit, wherein said electronic control unit is adapted to:
control said heater that supplies heat to said condenser, thereby increasing a temperature of the refrigerant that is received in said condenser from the outlet of said compressor via a first control flow path that is in electronic communication between said heater and said electronic control unit;
control the flow of refrigerant from said expansion valve to the inlet of the at least one heating channel that is defined in said fuel cell stack via a second control flow path that is in electronic communication between said expansion valve and said electronic control unit;
control the flow of refrigerant from said bypass valve to one of said condenser and said bypass flow path via a third control flow path that is in electronic communication between said bypass valve and said electronic control unit;
control a pressure regulator of said compressor that delivers pressurized refrigerant at high temperature to said expansion valve via a fourth control flow path that is in electronic communication between said pressure regulator of said compressor and said electronic control unit; and
receive a temperature signal that is indicative of an operating temperature of at least one fuel cell that is positioned within said fuel cell stack from a temperature sensor that is in thermal communication with said at least one fuel cell that is positioned within said fuel cell stack via a fifth control flow path that is in electronic communication between said temperature sensor and said electronic control unit.

18. A thermal management system for a fuel cell stack in accordance with claim 13, further comprising at least one fuel cell positioned against the at least one heating channel defined in said fuel cell stack, the refrigerant that flows through the at least one heating channel that is defined in said fuel cell stack heats said at least one fuel cell by supplying heat to said at least one fuel cell at low temperature that is positioned against the at least one heating channel defined in said fuel cell stack, wherein said at least one fuel cell positioned against the at least one heating channel is at least one low temperature fuel cell comprising at least one bipolar plate, at least one gas diffusion membrane, and at least one proton-exchange membrane.

19. A thermal management system for a fuel cell stack, said thermal management system comprising:
a heating chamber defined in said fuel cell stack and receives a refrigerant therein, the refrigerant substantially fills the heating chamber and is in direct contact with at least one inner wall of the heating chamber, wherein the refrigerant that is received within the heating chamber and that substantially fills the heating chamber and in direct contact with at least one inner wall of the heating chamber flows through the heating chamber that is defined in said fuel cell stack to directly heat the at least one inner wall of the heating chamber defined in said fuel cell stack;
a compressor in flow communication with an outlet of the heating chamber defined in said fuel cell stack at its inlet, said compressor receives the refrigerant that flows through the outlet of the heating chamber that is defined in said fuel cell stack, said compressor compresses the refrigerant that is received in said compressor; and
an expansion valve in flow communication with an outlet of said compressor at its inlet and receives the refrigerant that flows through the outlet of said compressor, said expansion valve in flow communication with an inlet of the heating chamber defined in said fuel cell stack at its outlet, said expansion valve controls a flow of refrigerant that flows through the outlet of said compressor to the inlet of the heating chamber that is defined in said fuel cell stack to directly heat the at least one inner wall of the heating chamber defined in said fuel cell stack.

20. A fuel cell stack, said fuel cell stack comprising:
a housing;
at least one fuel cell positioned within said housing; and
at least one temperature regulating channel defined in said housing of said fuel cell stack and receives a refrigerant therein, wherein the refrigerant that is received within the at least one temperature regulating channel flows through the at least one temperature regulating channel that is defined in said housing of said fuel cell stack to regulate a temperature of said at least one fuel cell that is positioned within said housing of said fuel cell stack.
